(19) United States
(12) Patent Application Publication
(10) Pub. No.: US 2024/0288538 A1
(43) Pub. Date: Aug. 29, 2024

(54) RADAR DEVICE

(71) Applicant: Panasonic Automotive Systems Co., Ltd., Kanagawa (JP)

(72) Inventors: Takaaki KISHIGAMI, Tokyo (JP); Kenta IWASA, Tokyo (JP)

(21) Appl. No.: 18/646,273

(22) Filed: Apr. 25, 2024

Related U.S. Application Data
(63) Continuation of application No. PCT/JP2022/037060, filed on Oct. 4, 2022.

(30) Foreign Application Priority Data
Oct. 29, 2021 (JP) 2021-177893

(51) Int. Cl. G01S 7/35; G01S 7/02; G01S 13/00

(52) U.S. Cl. CPC G01S 7/354; G01S 7/0232; G01S 7/0234; G01S 7/024; G01S 13/003

(57) ABSTRACT

A radar apparatus includes: first radar circuitry, which, in operation, transmits a first transmission signal from a plurality of first transmission antennas; and second radar circuitry, which, in operation, transmits a second transmission signal from a plurality of second transmission antennas, in which a first interval of each Doppler shift amount applied to the first transmission signal transmitted from each of the plurality of first transmission antennas is different from a second interval of each Doppler shift amount applied to the second transmission signal transmitted from each of the plurality of second transmission antennas.

### TECHNICAL FIELD

The present disclosure relates to a radar apparatus.

### BACKGROUND ART

Recently, a study of radar apparatuses using a radar transmission signal of a short wavelength including a microwave or a millimeter wave that allows high resolution has been carried out. Further, it has been demanded to develop a radar apparatus which senses small objects such as pedestrians or falling objects in addition to vehicles in a wide-angle range (wide-angle radar apparatus) in order to improve the outdoor safety.

Examples of the configuration of the radar apparatus having a wide-angle sensing range include a configuration using a technique of receiving a reflected wave by an array antenna composed of a plurality of antennas (antenna elements), and estimating the direction of arrival (the angle of arrival) of the reflected wave using a signal processing algorithm based on received phase differences with respect to element spacings (antenna spacings) (Direction of Arrival (DOA) estimation). Examples of the DOA estimation include a Fourier method, and, a Capon method, Multiple Signal Classification (MUSIC), and Estimation of Signal Parameters via Rotational Invariance Techniques (ESPRIT) that are methods achieving higher resolution.

Further, there has been a proposed radar apparatus, for example, in which a transmitter in addition to a receiver is provided with a plurality of antennas (array antenna), and which is configured to perform beam scanning through signal processing using the transmission and reception array antennas (which may also be referred to as a Multiple Input Multiple Output (MIMO) radar) (e.g., see Non-Patent Literature (hereinafter referred to as “NPL”) 1).

### CITATION LIST

### Patent Literature

### PTL 1

Japanese Patent Application Laid-Open No. 2020-148754

### Non-Patent Literature

### NPL 1

J. Li, and P. Stoica, “MIMO Radar with Colocated Antennas,” Signal Processing Magazine, IEEE Vol. 24, Issue: 5, pp. 106-114, 2007

### NPL 2

E. Fishler, A. Haimovich, R. Blum, D. Chizhik, L. Cimini and R. Valenzuela, “MIMO radar: an idea whose time has come,” Proceedings of the 2004 IEEE Radar Conference, 2004, pp. 71-78

### NPL 3

M. Kronauge, H. Rohling,“Fast two-dimensional CFAR procedure,” IEEE Trans. Aerosp. Electron. Syst., 2013, 49, (3), pp. 1817-1823

### NPL 4

Direction-of-arrival estimation using signal subspace modeling Cadzow, J. A.; Aerospace and Electronic Systems, IEEE Transactions on Volume: 28, Issue: 1 Publication Year: 1992, Page(s): 64-79

### NPL 5

H. Yan, J. Li and G. Liao, “Multitarget Identification and Localization Using Bistatic MIMO Radar Systems,” EURASIP Journal on Advances In Signal Processing, vol. 2008, Article ID 283483, 8 pages, 2008.

However, methods for a radar apparatus (e.g., MIMO radar) to sense a target object (or a target) have not been comprehensively studied.

One non-limiting and exemplary embodiment of the present disclosure facilitates providing a radar apparatus capable of accurately detecting a target object.

A radar apparatus according to one exemplary embodiment of the present disclosure includes: first radar circuitry, which, in operation, transmits a first transmission signal from a plurality of first transmission antennas; and second radar circuitry, which, in operation, transmits a second transmission signal from a plurality of second transmission antennas, in which a first interval of each Doppler shift amount applied to the first transmission signal transmitted from each of the plurality of first transmission antennas is different from a second interval of each Doppler shift amount applied to the second transmission signal transmitted from each of the plurality of second transmission antennas.

Note that these generic or specific exemplary embodiments may be achieved by a system, an apparatus, a method, an integrated circuit, a computer program, or a recoding medium, and also by any combination of the system, the apparatus, the method, the integrated circuit, the computer program, and the recoding medium.

According to one exemplary embodiment of the present disclosure, a radar apparatus is capable of accurately detecting a target object.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

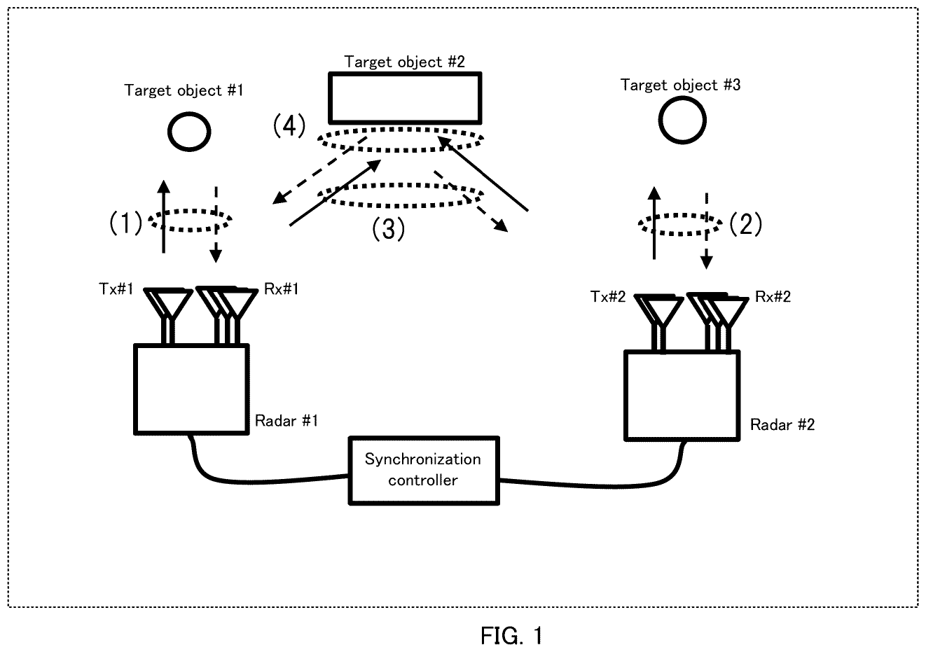

FIG. 1 illustrates an example of a radar apparatus having a mono- & multi-static configuration;

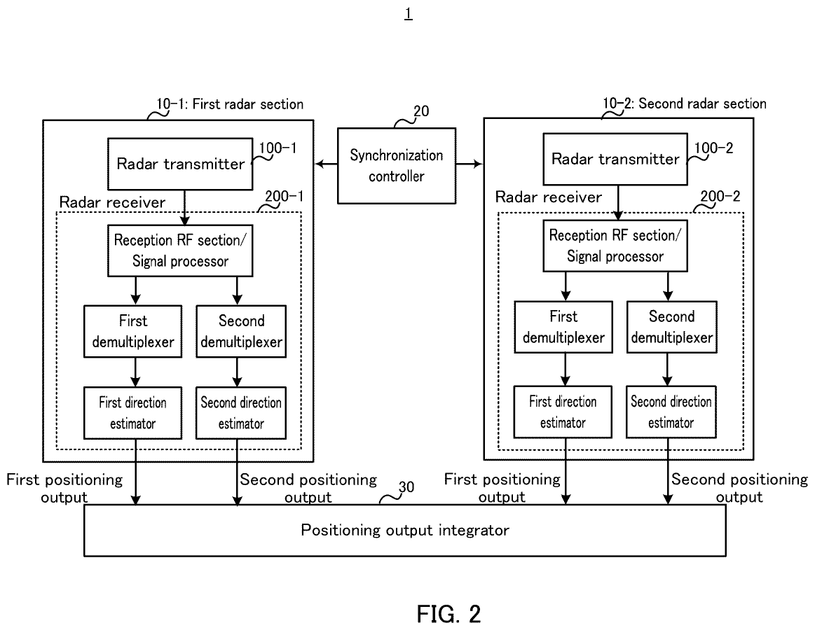

FIG. 2 is a block diagram illustrating an exemplary configuration of a radar apparatus according to Embodiment 1;

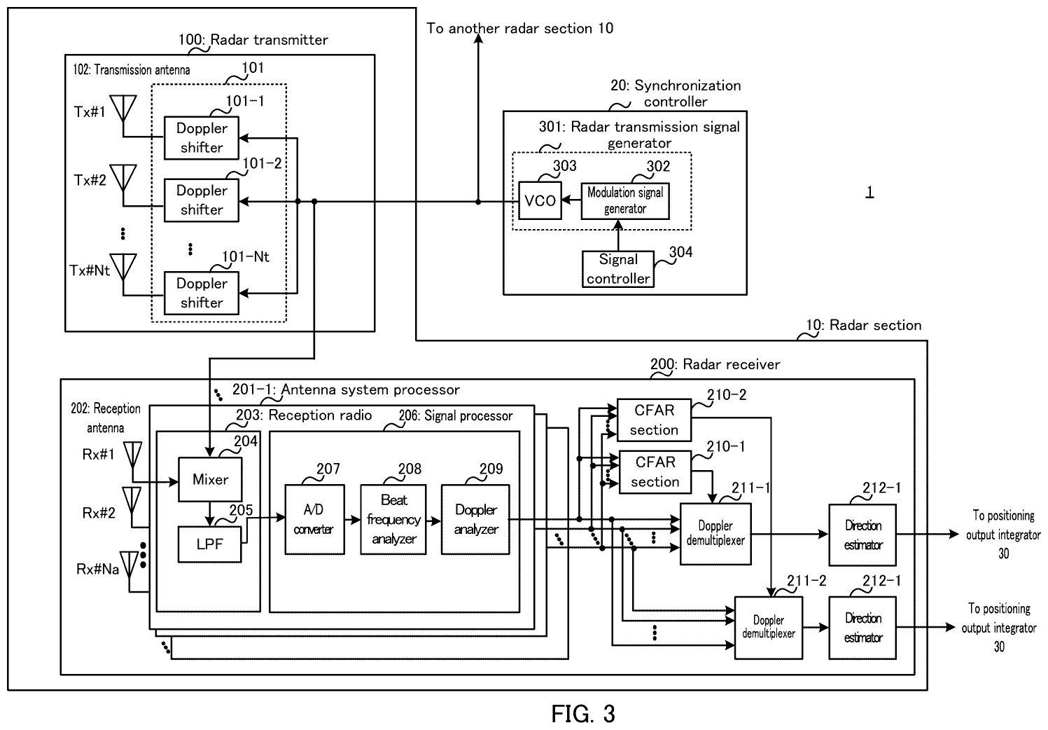

FIG. 3 is a block diagram illustrating an exemplary configuration of a radar apparatus according to Embodiment 1;

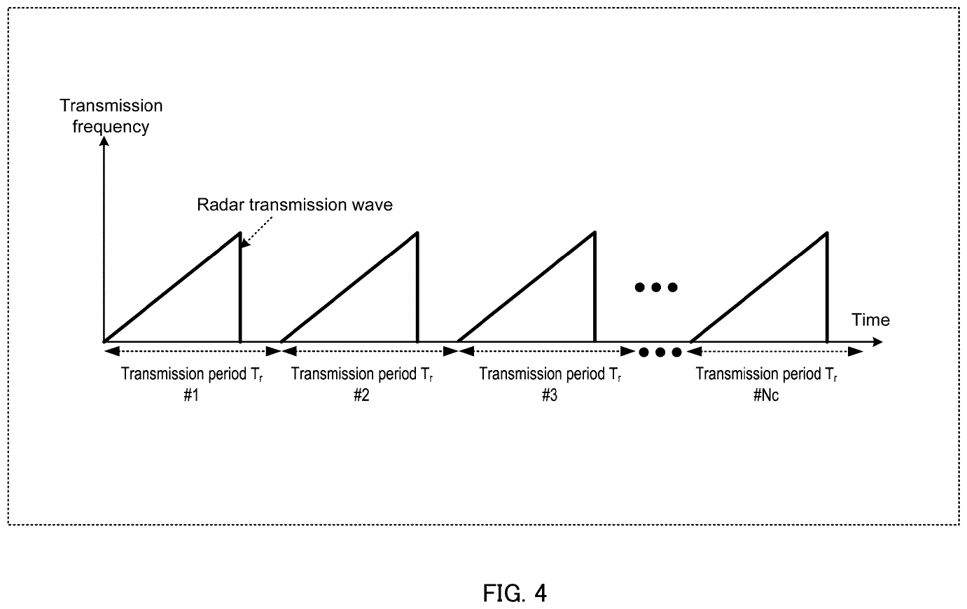

FIG. 4 illustrates an example of a chirp signal;

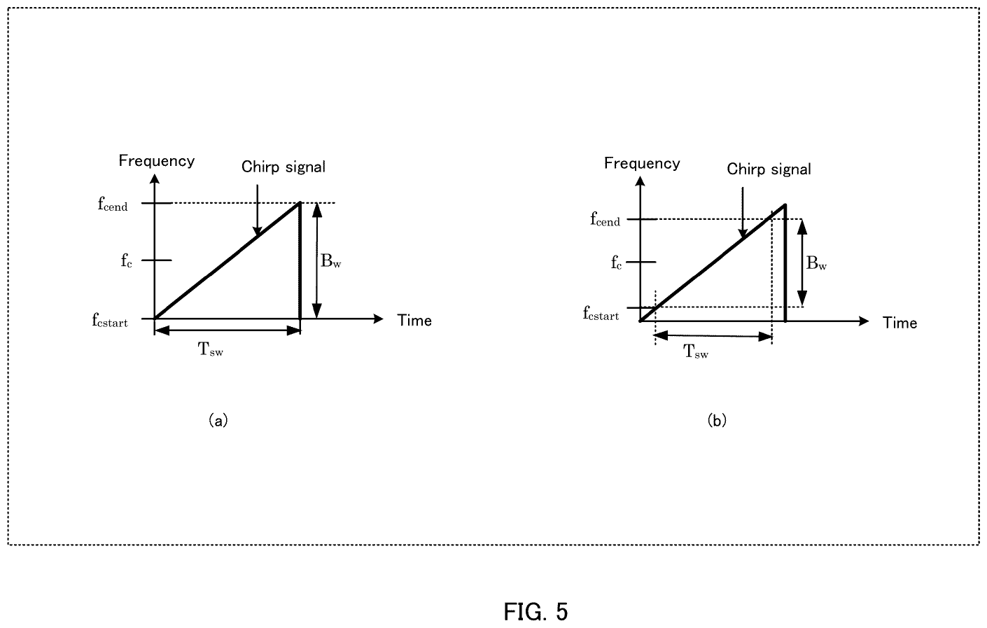

FIG. 5 illustrates an example of the chirp signal

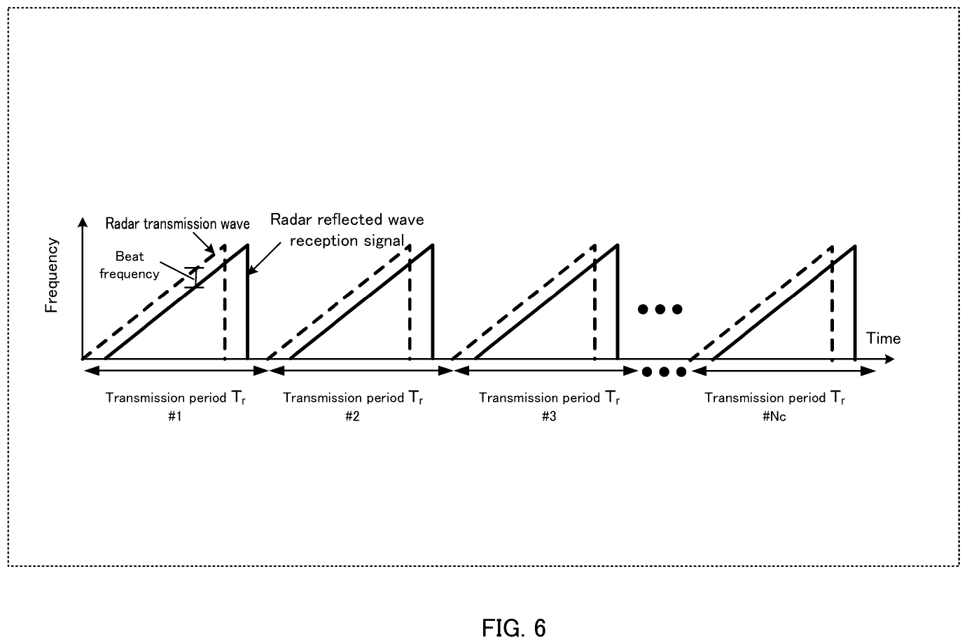

FIG. 6 illustrates an example of the chirp signal;

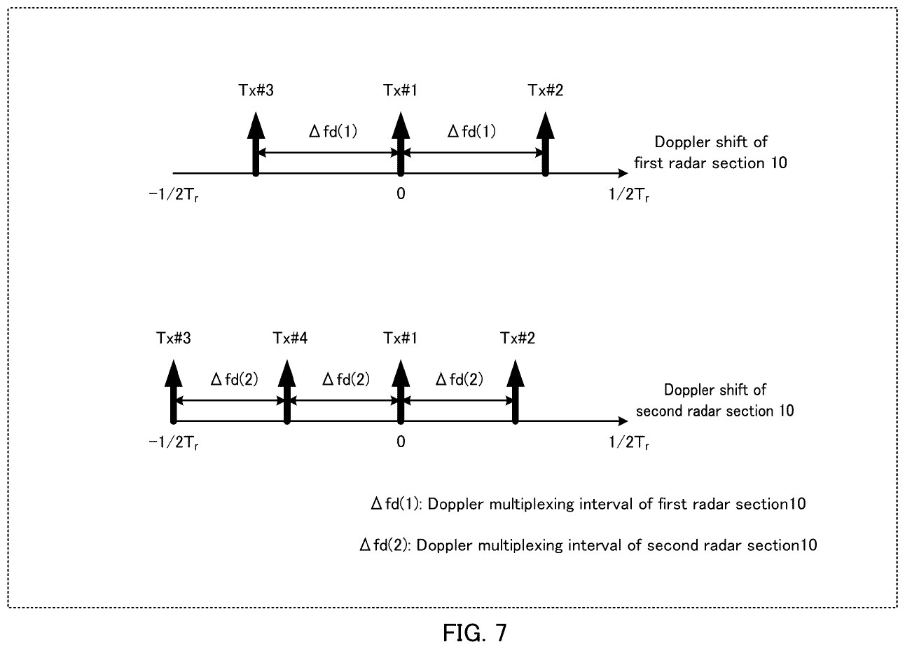

FIG. 7 illustrates an example of setting Doppler multiplexing intervals;

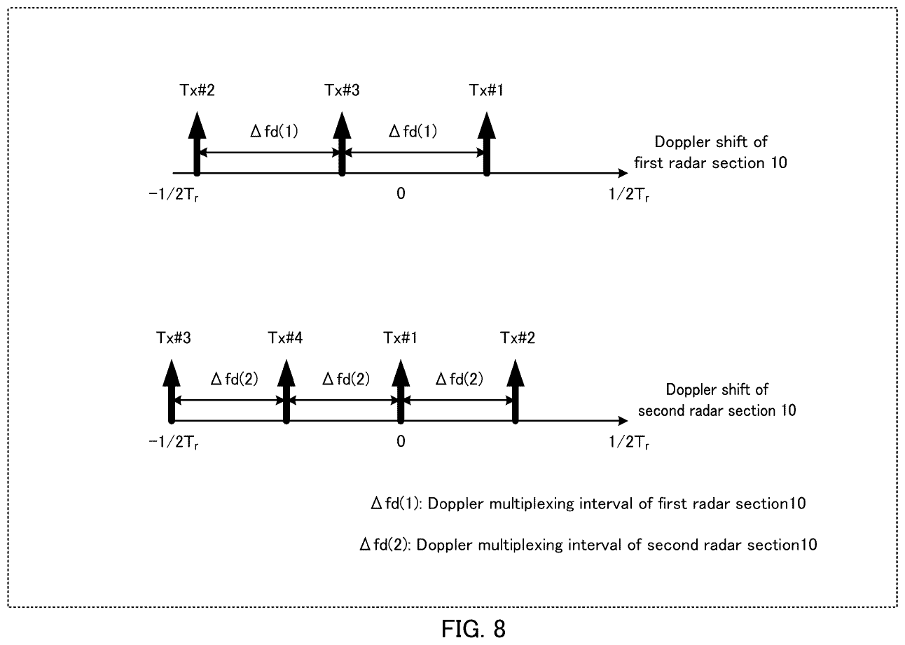

FIG. 8 illustrates an example of setting Doppler multiplexing intervals;

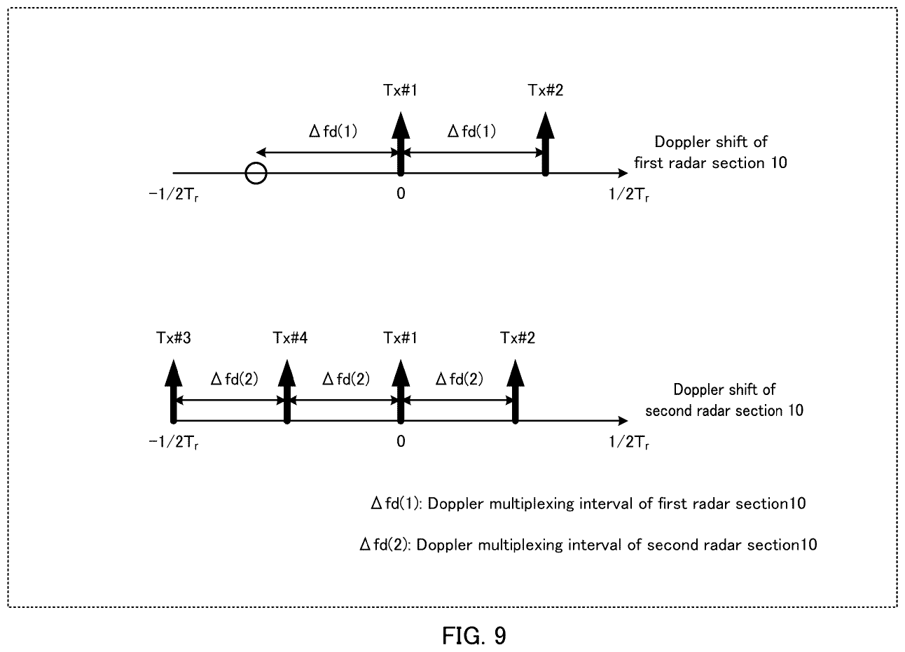

FIG. 9 illustrates an example of setting Doppler multiplexing intervals;

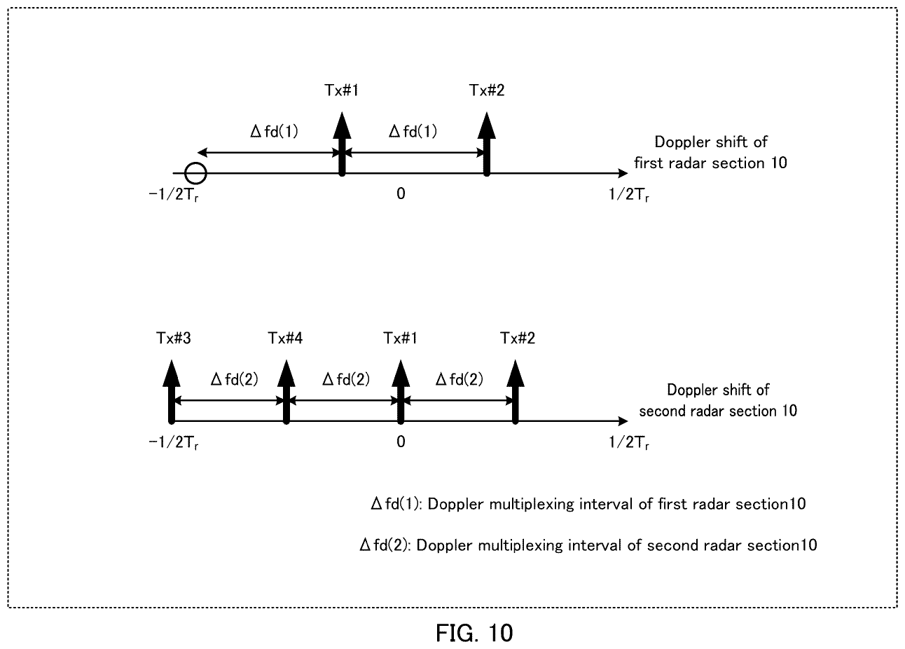

FIG. 10 illustrates an example of setting Doppler multiplexing intervals;

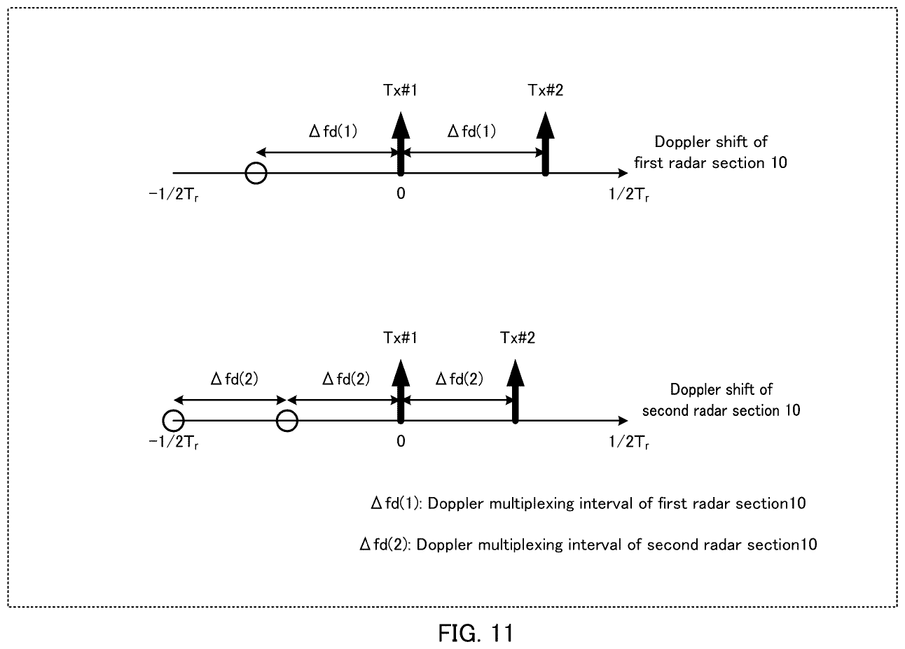

FIG. 11 illustrates an example of setting Doppler multiplexing intervals;

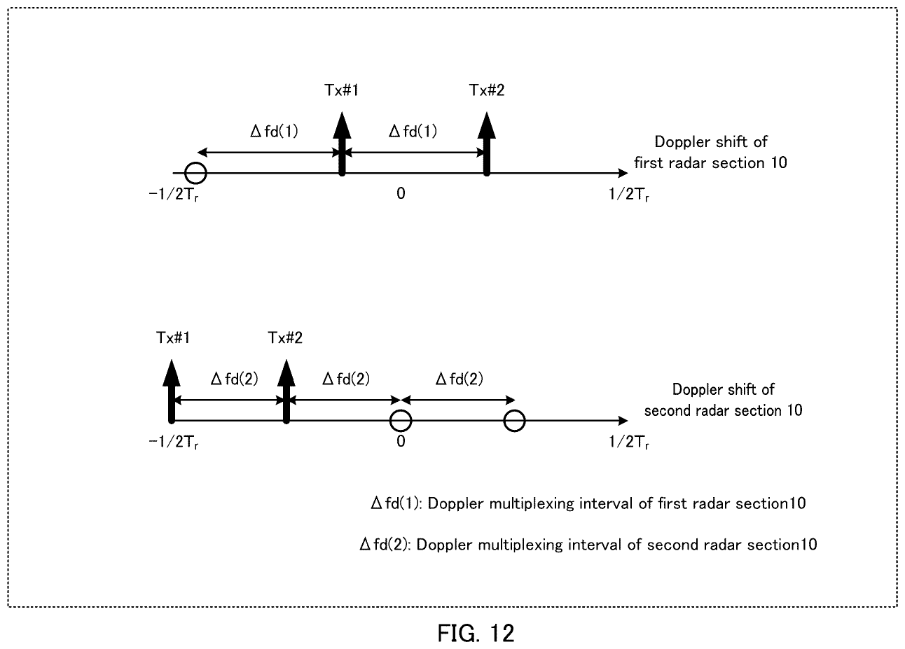

FIG. 12 illustrates an example of setting Doppler multiplexing intervals;

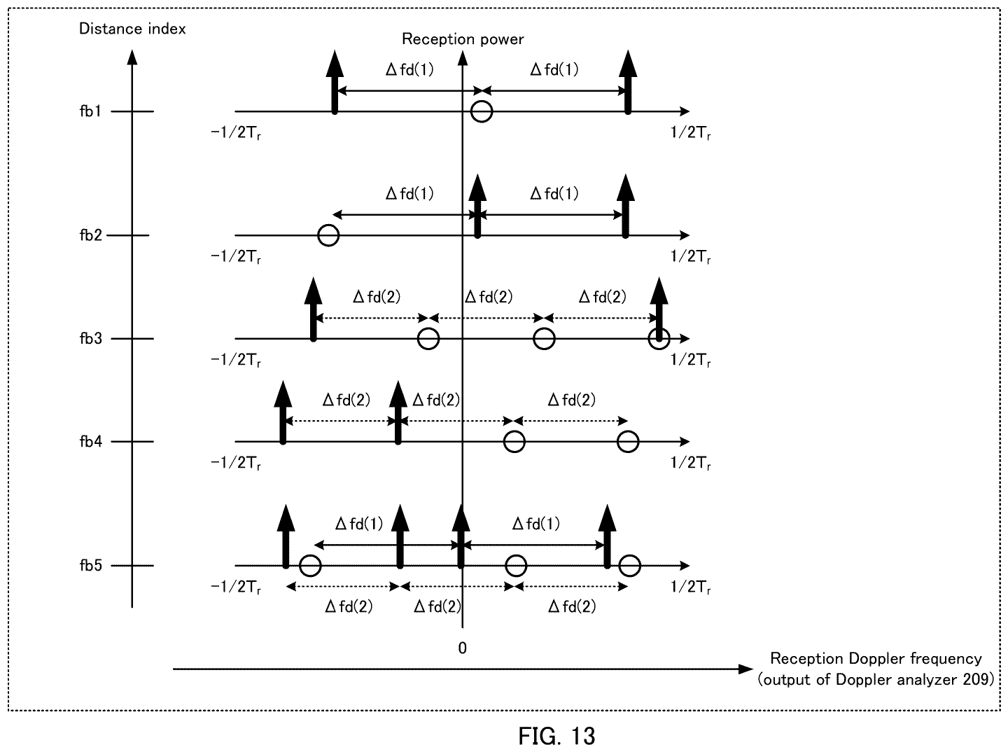

FIG. 13 illustrates an example of a reception signal;

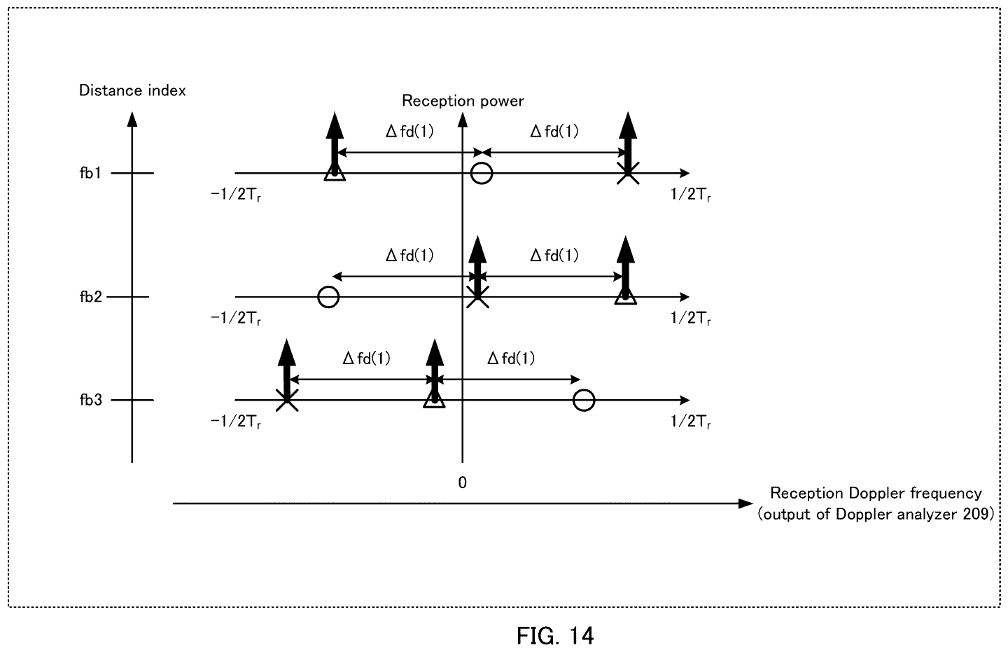

FIG. 14 illustrates an example of the reception signal

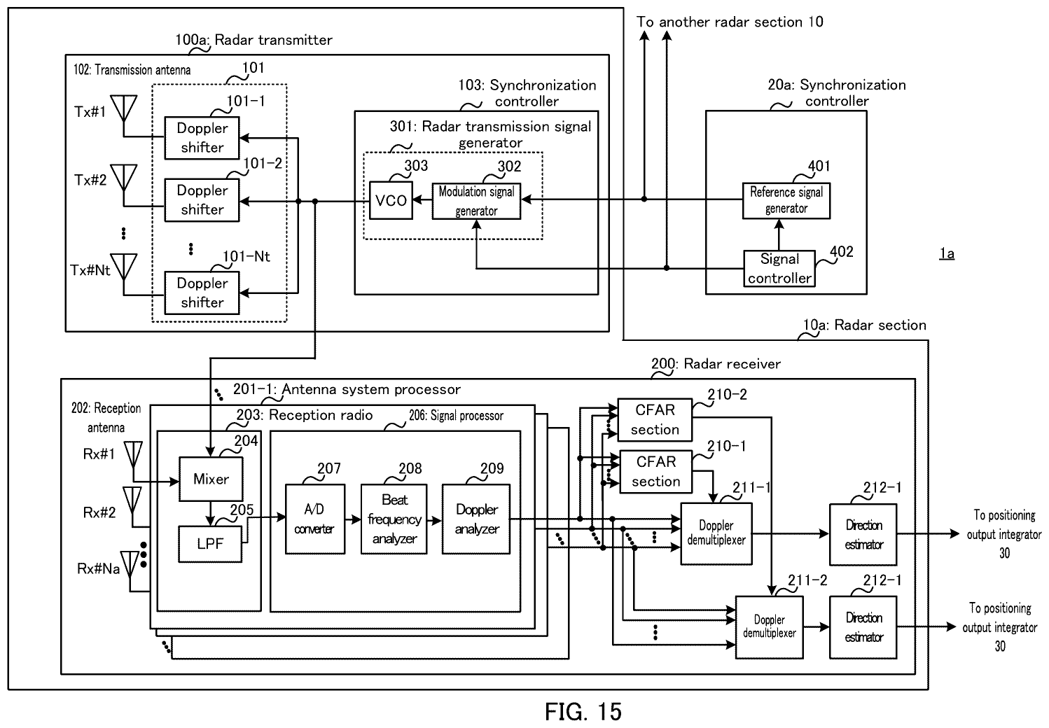

FIG. 15 is a block diagram illustrating an exemplary configuration of a radar apparatus according to Variation 1;

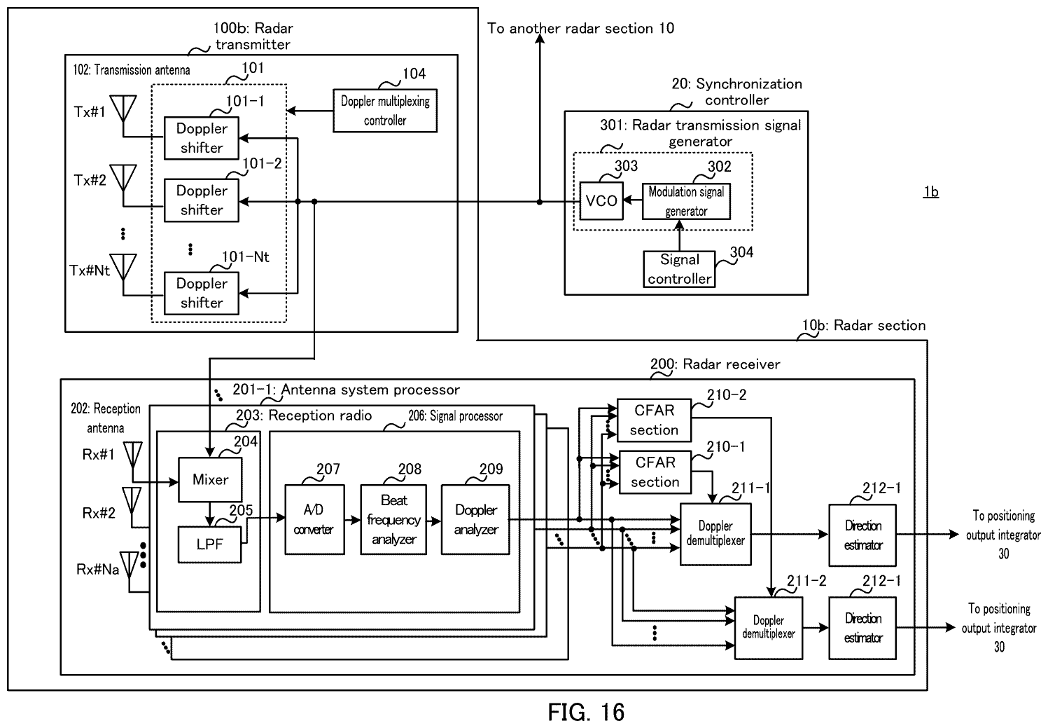

FIG. 16 is a block diagram illustrating an exemplary configuration of a radar apparatus according to Variation 2;

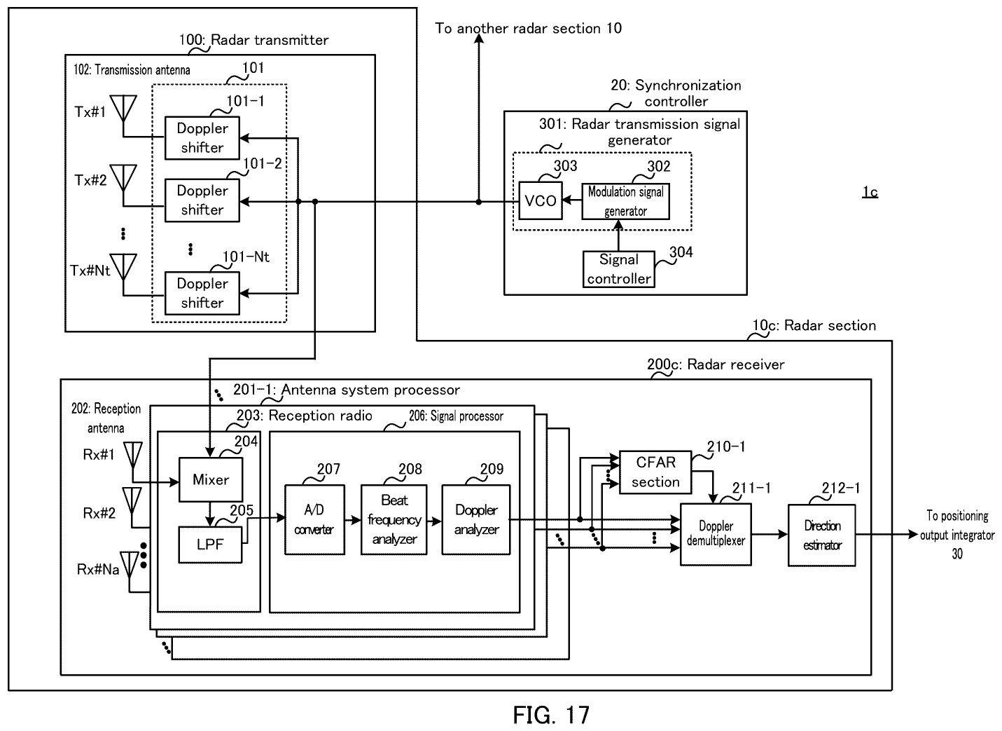

FIG. 17 is a block diagram illustrating an exemplary configuration of a radar apparatus according to Variation 3;

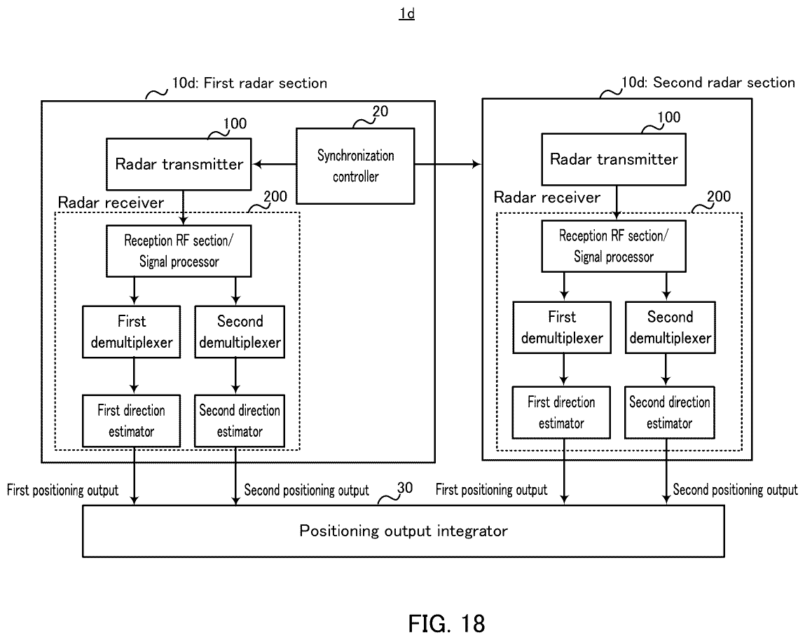

FIG. 18 is a block diagram illustrating an exemplary configuration of a radar apparatus according to Variation 5;

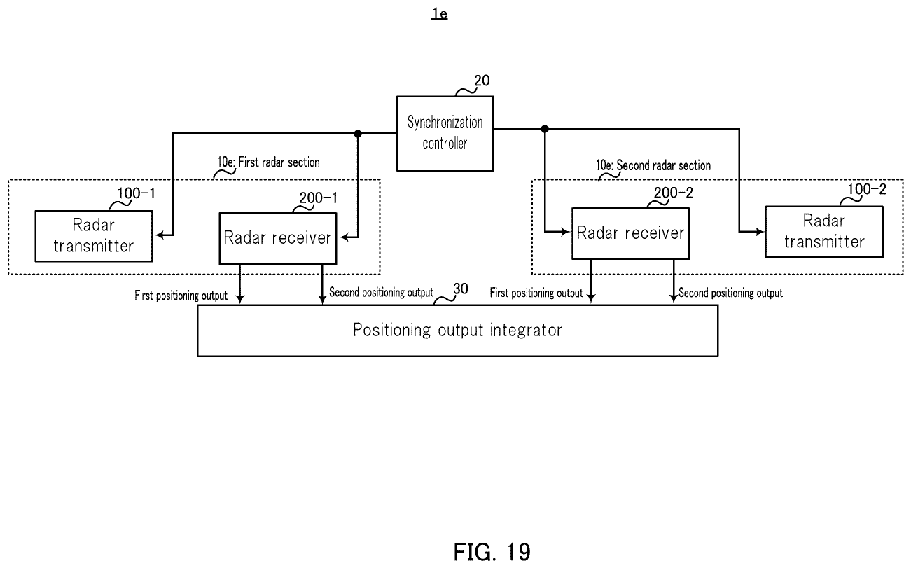

FIG. 19 is a block diagram illustrating an exemplary configuration of a radar apparatus according to Variation 6;

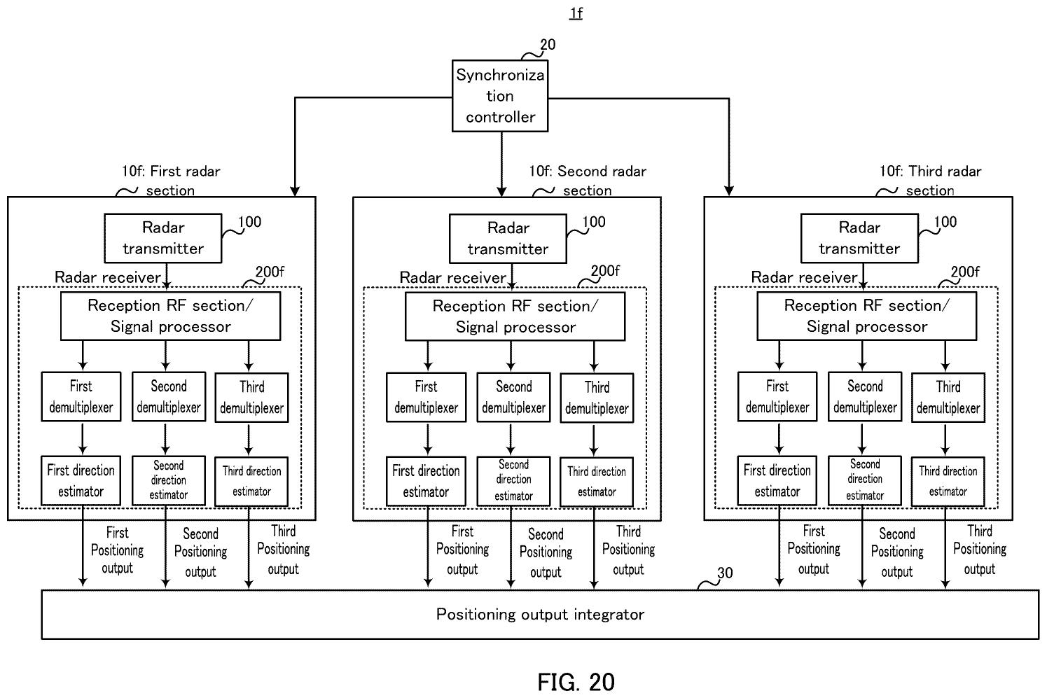

FIG. 20 is a block diagram illustrating an exemplary configuration of a radar apparatus according to Variation 7;

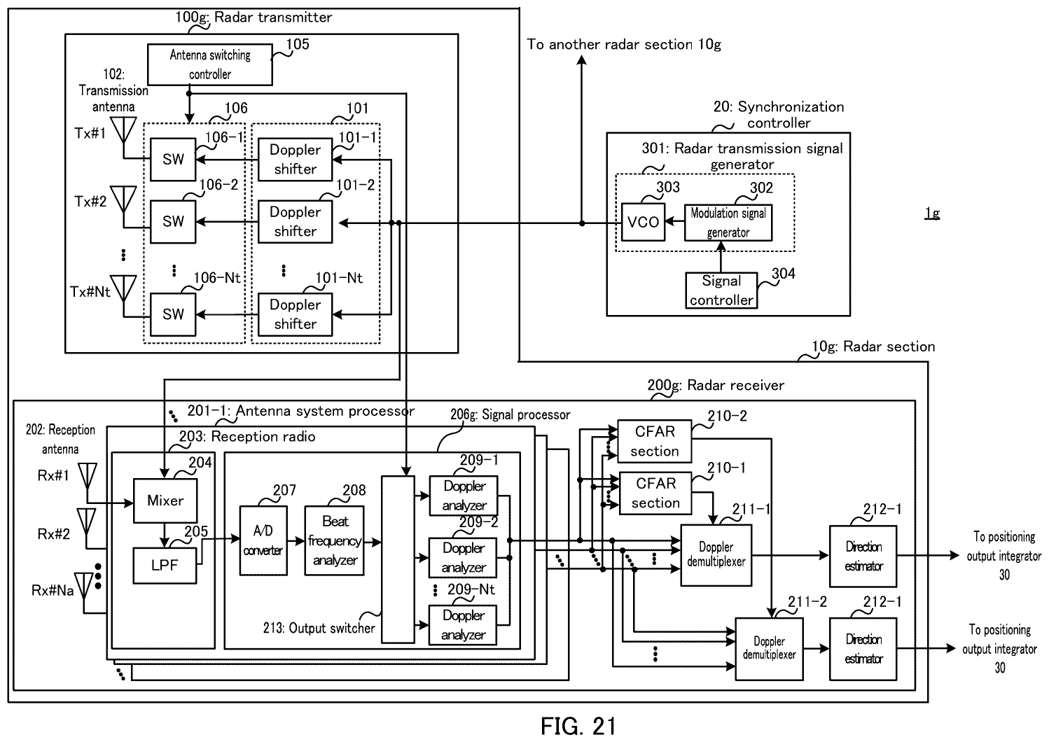

FIG. 21 is a block diagram illustrating an exemplary configuration of a radar apparatus according to Embodiment 2;

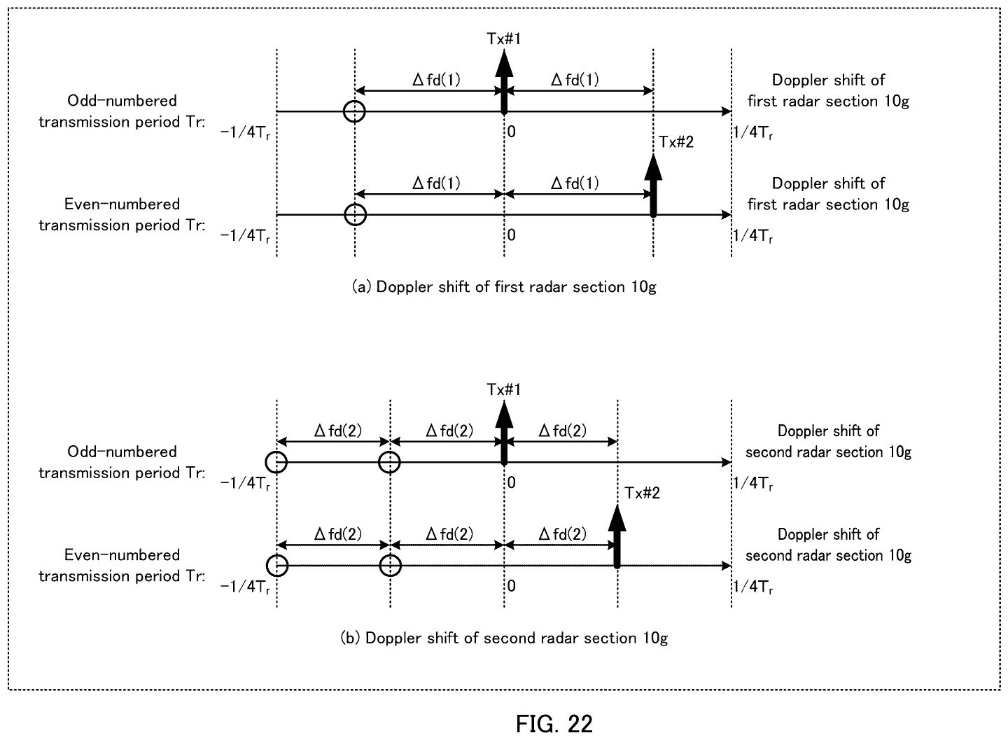

FIG. 22 illustrates an example of setting Doppler multiplexing intervals;

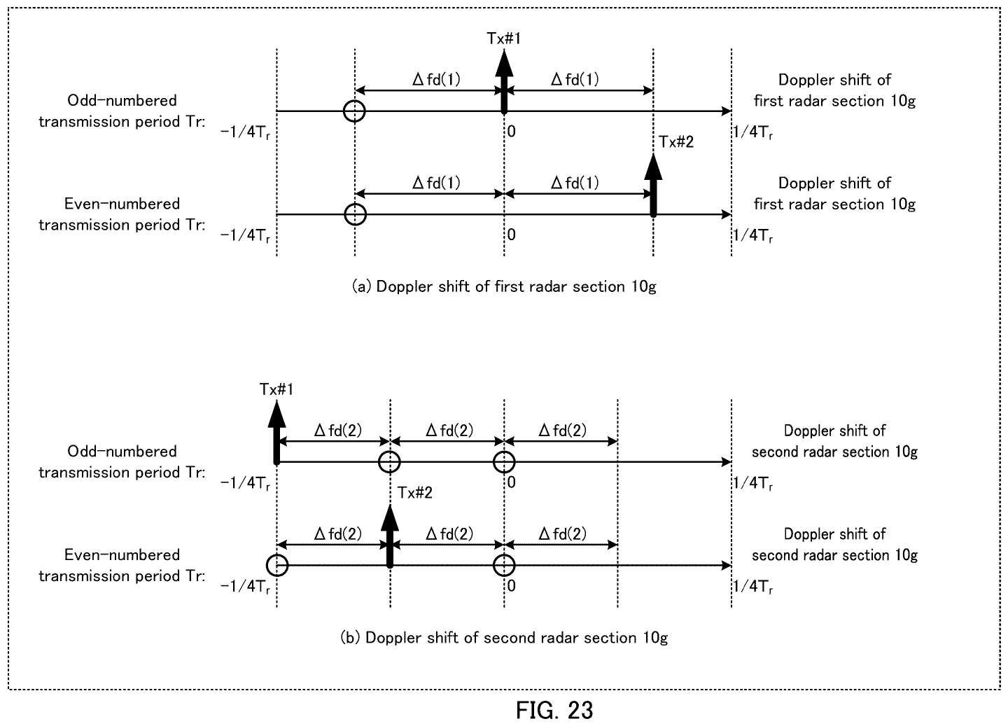

FIG. 23 illustrates an example of setting Doppler multiplexing intervals;

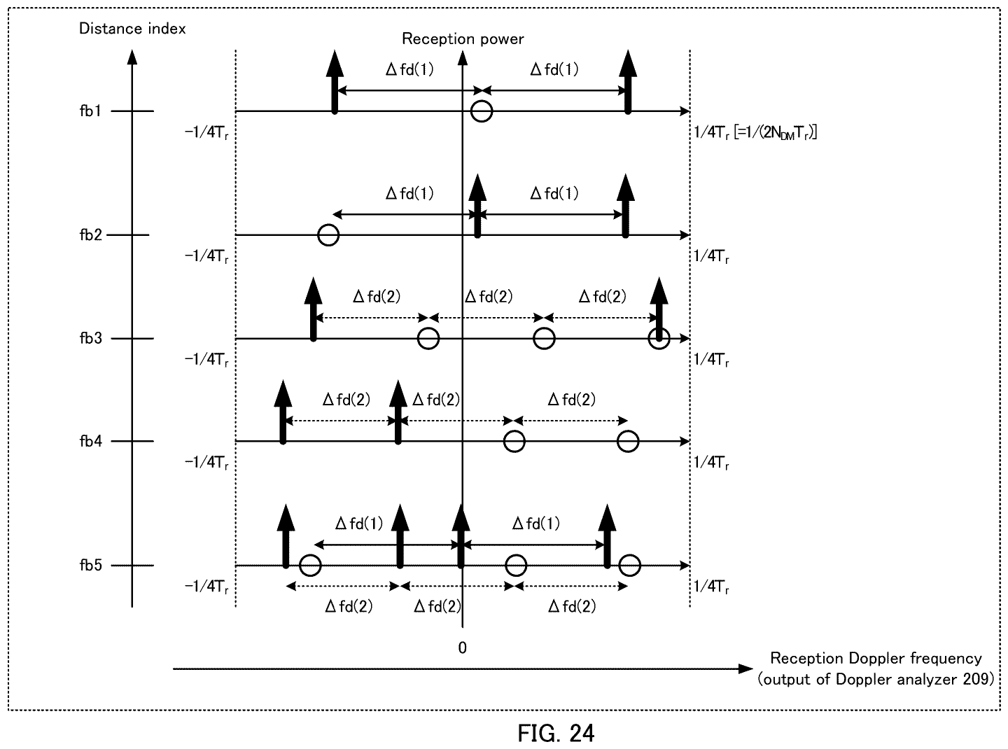

FIG. 24 illustrates an example of a reception signal;

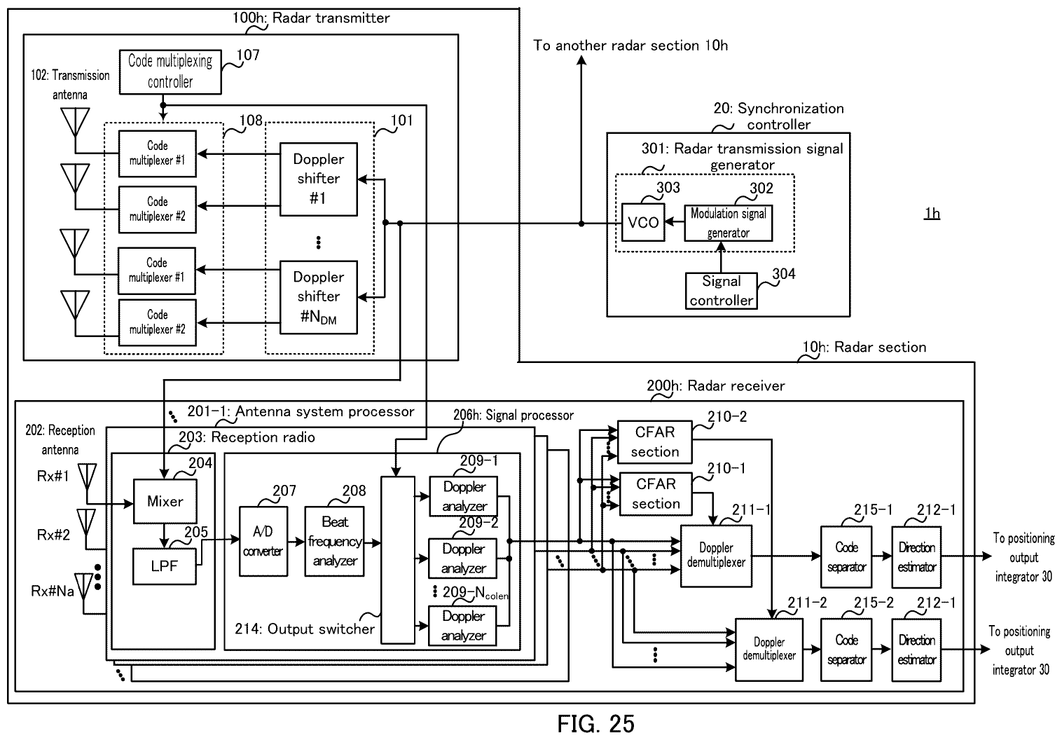

FIG. 25 is a block diagram illustrating an exemplary configuration of a radar apparatus according to Embodiment 3;

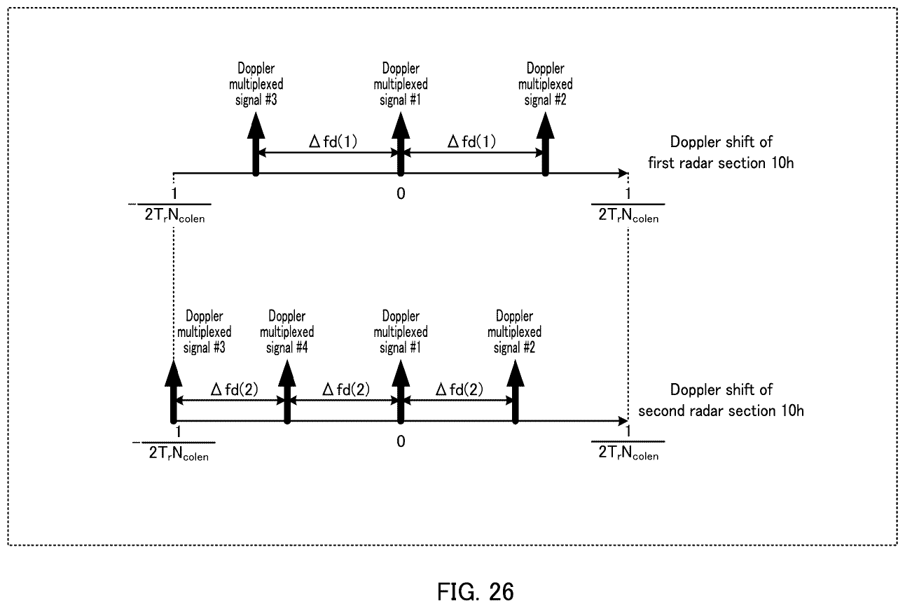

FIG. 26 illustrates an example of setting Doppler multiplexing intervals;

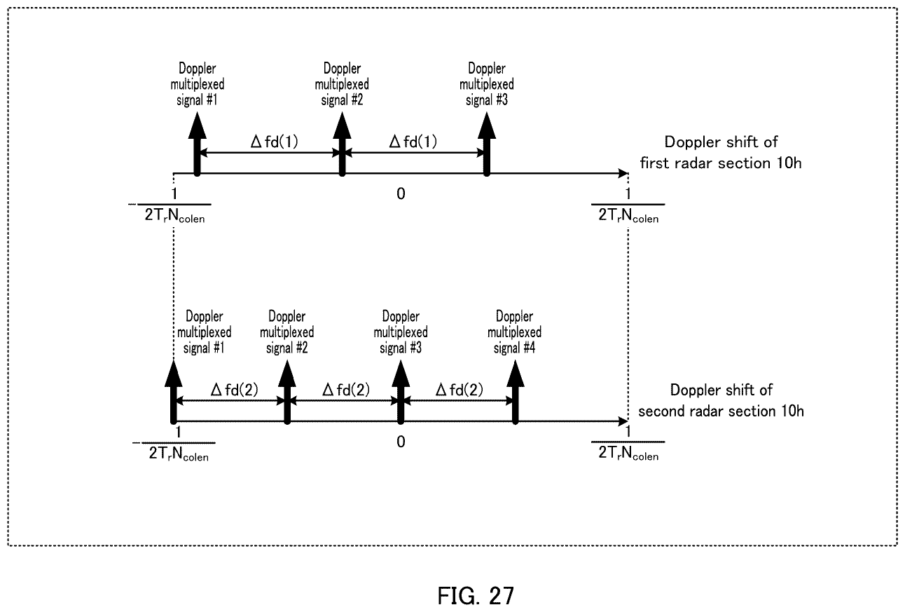

FIG. 27 illustrates an example of setting Doppler multiplexing intervals;

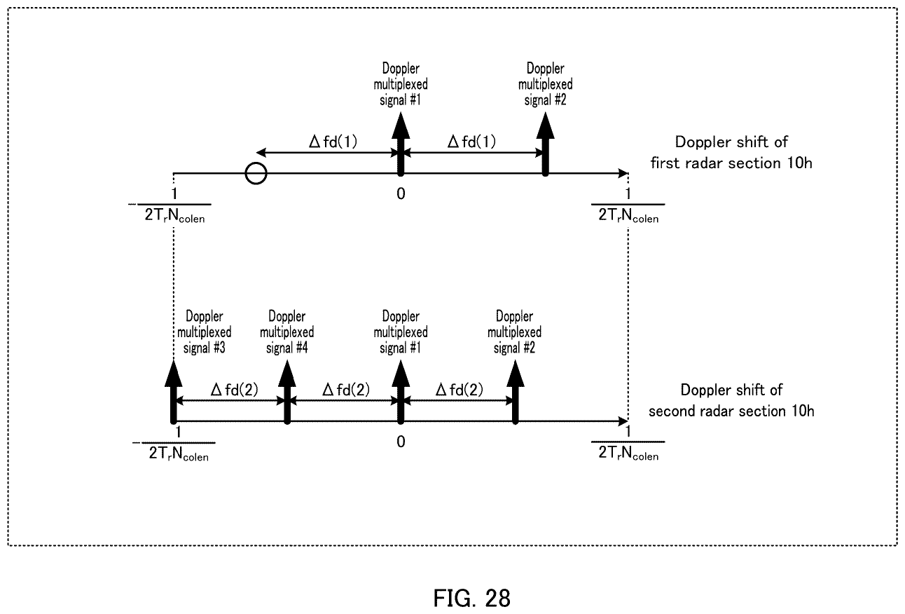

FIG. 28 illustrates an example of setting Doppler multiplexing intervals;

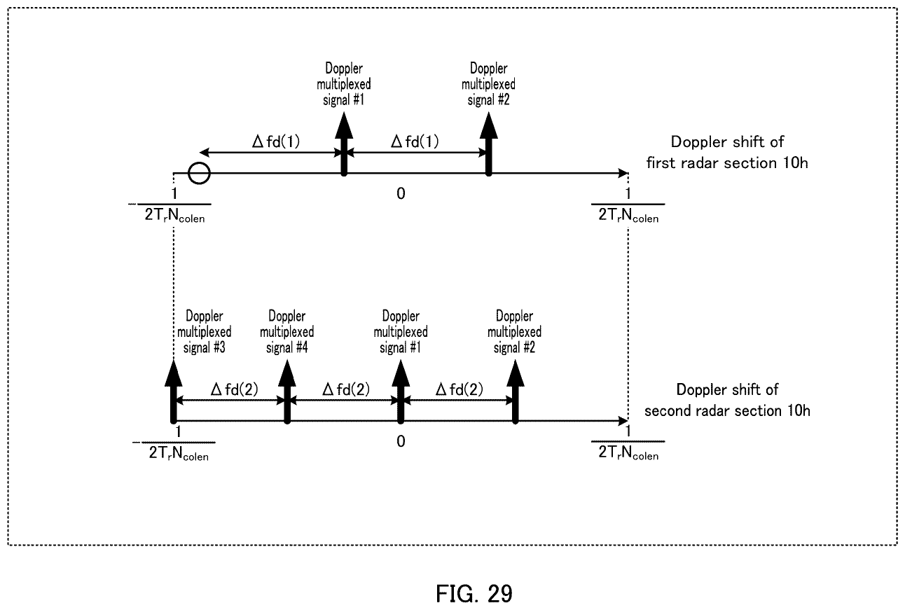

FIG. 29 illustrates an example of setting Doppler multiplexing intervals;

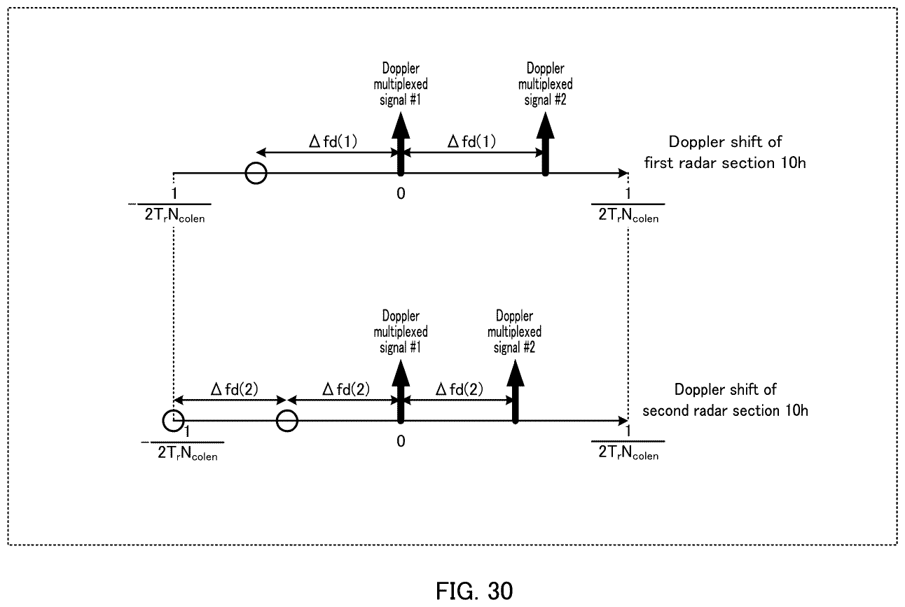

FIG. 30 illustrates an example of setting Doppler multiplexing intervals;

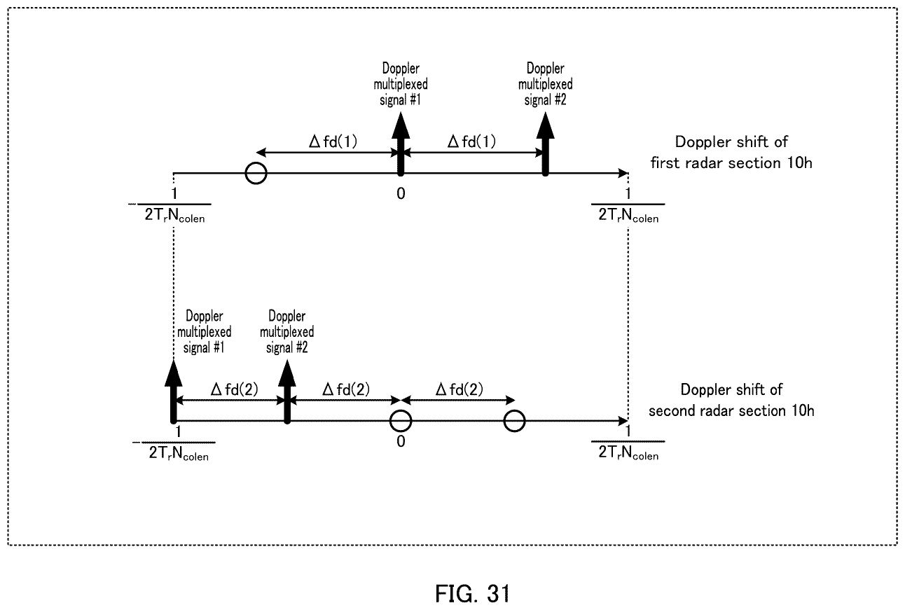

FIG. 31 illustrates an example of setting Doppler multiplexing intervals;

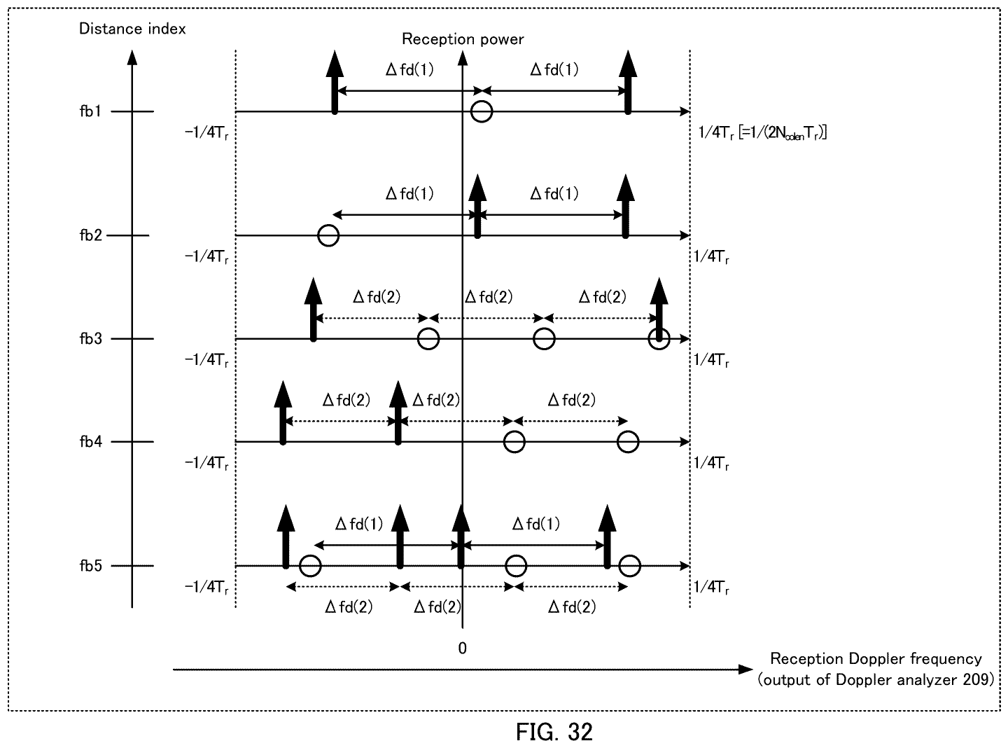

FIG. 32 illustrates an example of a reception signal; and

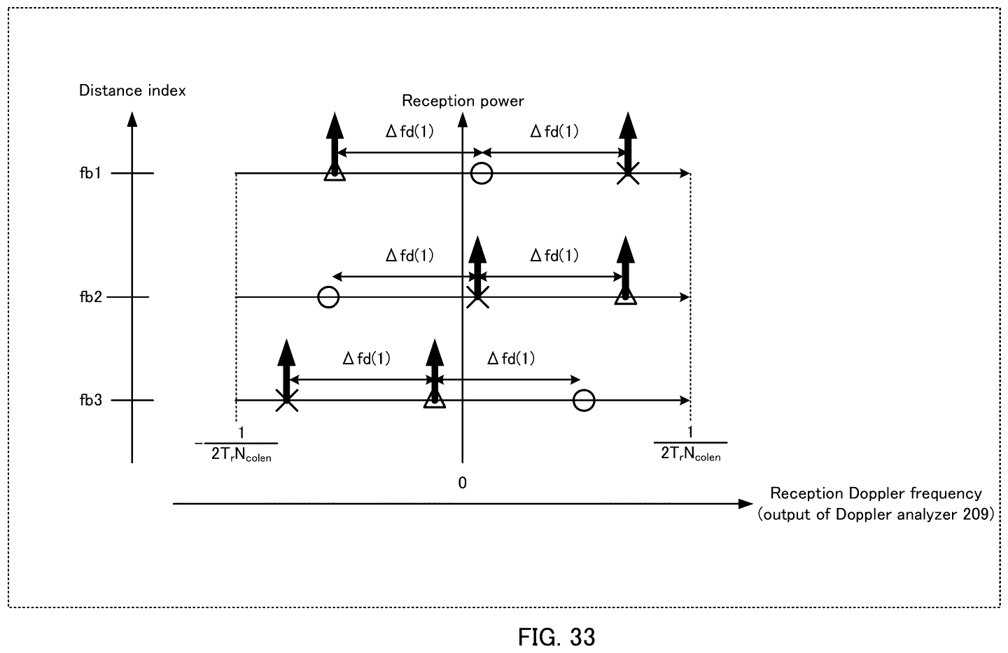

FIG. 33 illustrates an example of the reception signal.

### DESCRIPTION OF EMBODIMENTS

A MIMO radar transmits, from a plurality of transmission antennas (also referred to as “transmission array antenna”), signals (also referred to as “radar transmission waves” or “radar transmission signals”) that are multiplexed using Time Division Multiplexing (TDM), Frequency Division Multiplexing (FDM), or Code Division Multiplexing (CDM), for example. In addition, the MIMO radar receives signals (also referred to as “radar reflected waves” or “reflected wave signals”) reflected, for example, by an object around the radar using a plurality of reception antennas (also referred to as “reception array antenna”) to separate and receive the multiplexed transmission signals from reception signals. With this processing, the MIMO radar can extract propagation path responses indicated by the product of the number of transmission antennas and the number of reception antennas, and perform array signal processing using these reception signals as a virtual reception array.

Further, in the MIMO radar, it is possible to virtually enlarge the antenna aperture so as to enhance the angular resolution by appropriately arranging element spacings in the transmission and reception array antennas (see, for example, NPL 1).

The MIMO radar is roughly divided into a “monostatic configuration” and a “bistatic/multistatic configuration,” for example.

The monostatic configuration may, for example, be a configuration in which a radar transmitter (for example, including a plurality of transmission antennas and a high-frequency radio) and a radar receiver (for example, including a plurality of reception antennas and a high-frequency radio) are included in the same housing.

In the bistatic/multistatic configuration, for example, the radar transmitter and the radar receiver may be included respectively in different housings. For example, the bistatic/multistatic configuration is a configuration in which the respective housings are installed at distances apart from each other, and the radar transmitter and the radar receiver are connected to a controller that performs synchronization control. In the bistatic configuration, for example, a pair of the radar transmitter and the radar receiver are provided, and the radar transmitter and the radar receiver are disposed at distances apart from each other. The multistatic configuration is, for example, a configuration in which at least one or both of the radar transmitter and the radar receiver are plural. The multistatic configuration is disclosed in, for example, NPL 2.

For example, a radar apparatus having the monostatic configuration is capable of capturing radio waves (reflected waves) that are emitted to a target object and reflected in a backward direction (for example, in a radar transmission wave direction). Meanwhile, it is difficult for the radar apparatus having the monostatic configuration, for example, to capture a reflected wave when the radio wave is reflected in a direction different from the backward direction. In contrast to the above, the radar apparatus having the bistatic or multistatic configuration is capable of capturing a reflected wave depending on an installation position, for example, even when the radio wave is reflected in a direction different from the backward direction. For example, even in a case where a backward reflected wave is unlikely to be captured, such as a case where a target object such as a wall is inclined in an oblique direction with respect to the radar transmission wave direction, the radar apparatus having the multistatic configuration has a degree of freedom in the installation position of the radar receiver, and therefore, the reflected wave can be easily captured and the detection performance of the target object can be improved by devising the installation position of the radar receiver.

In the following, a non-limiting exemplary embodiment of the present disclosure focuses on a multistatic configuration. For example, in the non-limiting exemplary embodiment, the multistatic configuration using a plurality of MIMO radars having the monostatic configuration will be described. The multistatic configuration using a plurality of MIMO radars having the monostatic configuration may be referred to as a “mono- & multi-static configuration,” for example.

FIG. 1 illustrates an exemplary radar apparatus having the mono- & multi-static configuration in which radar #1 and radar #2 being MIMO radars having the monostatic configuration are used.

Radar #1 illustrated in FIG. 1 is, for example, a “first MIMO radar having the monostatic configuration” that outputs a radar transmission wave from radar transmission antenna group Tx #1 and receives a reflected wave from target object #1 by radar reception antenna group Rx #1 in the same housing (for example, path (1) illustrated in FIG. 1).

Similarly, radar #2 illustrated in FIG. 1 is, for example, a “second MIMO radar having the monostatic configuration” that outputs a radar transmission wave from radar transmission antenna group Tx #2 and receives a reflected wave from target object #3 by radar reception antenna group Rx #2 in the same housing (for example, path (2) illustrated in FIG. 1).

Further, the radar apparatus illustrated in FIG. 1 may perform an operation of transmitting a radar transmission wave from transmission antenna group Tx #1 of radar #1 and receiving a reflected wave from target object #2 by reception antenna group Rx #2 of radar #2 in addition to the operation as the MIMO radar with the first monostatic configuration described above. The radar apparatus performing this operation may be regarded as, for example, a “MIMO radar having a first multistatic configuration” (for example, path (3) illustrated in FIG. 1).

Similarly, in addition to the operation as MIMO radar of the second monostatic configuration described above, the radar apparatus illustrated in FIG. 1 may perform an operation of transmitting a radar transmission wave from transmission antenna group Tx #2 of radar #2 and receiving a reflected wave from target object #2 at the reception antenna group Rx #1 of radar #1. The radar apparatus performing this operation may be regarded as, for example, a “MIMO radar having a second multistatic configuration” (for example, path (4) illustrated in FIG. 1).

In FIG. 1, path (3) and path (4) are assumed as similar paths. For example, the radar apparatus detects target object #2 in both directions of path (3) and path (4), thereby reducing erroneous detection due to multipath or the like and achieving enhancement in detection accuracy of the target object.

Further, for example, when target object #2 moves in the cross-range direction of radar #1 and radar #2 (for example, in a direction orthogonal to the direction corresponding to path (1) or path (2)), it is difficult for radar #1 and radar #2 to detect the Doppler velocity of target object #2. On the other hand, the cross-range direction of radar #1 and radar #2 in which target object #2 moves is different from the cross-range direction of the paths (for example, path (3) or path (4)) of the first or second multistatic configurations. Thus, the radar apparatus can detect the Doppler velocity of target object #2 by radar positioning with the multistatic configuration, and can also obtain an effect of facilitating detection of the target object as a mobile object.

For using a radar not only as the radar having the monostatic configuration, but also as the radar having the multistatic configuration, a synchronization controller that performs synchronization control between a plurality of radars having the monostatic configuration installed at distant positions may, for example, be used. For example, in FIG. 1, when a Frequency modulated continuous wave (FMCW) signal (for example, a “chirp signal”) is used as the radar transmission wave, the synchronization controller may generate the chirp signal and supply a common chirp signal to radar #1 and radar #2. Thus, radar #1 and radar #2 can transmit the chirp signal common between radar #1 and radar #2, and can perform reception processing using the common chirp signal. Thus, radar #1 and radar #2 can be used as the radar of the monostatic configuration, and can also be used as the radar of the multistatic configuration composed of the transmission antenna of radar #1 and the reception antenna of radar #2 or of the transmission antenna of radar #2 and the reception antenna of radar #1.

As described above, the radar apparatus illustrated in FIG. 1 may generate the radar transmission signal in the synchronization controller and supply the radar transmission signal, which is the output of the synchronization controller, to radar #1 and radar #2 in common. For example, the radar apparatus can transmit the transmission signal from the first radar having the monostatic configuration and perform reception processing of the first radar having the monostatic configuration and reception processing of the second radar having the multistatic configuration. In addition, the radar apparatus can transmit the transmission signal from the second radar having the monostatic configuration, for example, and can perform reception processing of the second radar having the monostatic configuration and reception processing of the second radar having the multistatic configuration.

For example, when the first and second radars having the monostatic configurations operate simultaneously using the same radar transmission wave, interference may occur with each other. Accordingly, the interference may increase likeliness of erroneous detection or non-detection, thus deteriorating the positioning accuracy or the detection performance of the radars. To avoid this, for example, multiplexing transmission with application of time division (TDM), frequency division (FDM), or code division (CDM) is conceivable for the transmission of the radars with the multistatic configuration using the first and second radars of the monostatic configurations.

### <Time Division Multiplexing Transmission>

Examples of the radar having the multistatic configuration may include a configuration in which, in FIG. 1, transmission from the transmission antenna (Tx #1) of radar #1 and reception by the reception antenna (Rx #2) of radar #2 (the multistatic configuration from radar #1 to radar #2) and transmission from the transmission antenna (Tx #1) of radar #2 and reception by the reception antenna (Rx #1) of radar #1 (the multistatic configuration from radar #2 to radar #1) are alternately switched in time division (hereinafter, referred to as “inter-multistatic time-division transmission”).

In the case of performing the inter-multistatic time-division transmission, for example, switching to transmission in the multistatic configuration from radar #2 to radar #1 takes place after completion of the transmission in the multistatic configuration from radar #1 to radar #2. Thus, the time required for the transmission processing is likely to increase.

### <Frequency Multiplexing Transmission>

For example, in FIG. 1, a configuration is conceivable in which transmission in the multistatic configuration from radar #1 to radar #2 and transmission in the multistatic configuration from radar #2 to radar #1 are simultaneously performed (multiplexing transmission) at different frequencies (hereinafter referred to as “inter-multistatic frequency multiplexing transmission”).

When the inter-multistatic frequency multiplexing transmission is performed, for example, two chirp signals #1 and #2 having different center frequencies may be used as common signals. For the transmission processing, for example, chirp signal #1 may be transmitted from radar #1, and chirp signal #2 may be transmitted from radar #2.

Further, for the reception processing, for example, radar #1 may perform the reception processing of the monostatic configuration based on chirp signal #1 by a part of the reception antennas of radar #1, and perform the reception processing of the multistatic configuration based on chirp signal #2 by the remainder of the reception antennas of radar #1 since the frequencies of chirp signal #1 and chirp signal #2 are different from each other.

Similarly, for the reception processing, for example, radar #2 may perform the reception processing of the monostatic configuration based on chirp signal #2 by a part of the reception antennas of radar #2, and perform the reception processing of the multistatic configuration based on chirp signal #1 by the remainder of the reception antennas of radar #2.

Thus, simultaneous multiplexing transmissions can be performed between the multistatic configurations. Accordingly, the measurement time can be shorter than in the case of the inter-multistatic time-division transmission. On the other hand, for example, the reception processing of the multistatic configuration is performed by a part of the reception antennas of radar #1 or radar #2 in the inter-multistatic frequency multiplexing transmission, and therefore, the reception signal level is likely to be lowered or the angle measurement accuracy is likely to be deteriorated.

In the inter-multistatic frequency multiplexing transmission, a plurality of chirp signals that are common signals are used. In general, an expensive cable which focuses on a low loss property is used for a transmission line of the high-frequency signal, and thus, the system cost is likely to increase.

### <Code Multiplexing Transmission>

For example, in FIG. 1, a configuration is conceivable in which transmission in the multistatic configuration from radar #1 to radar #2 and transmission in the multistatic configuration from radar #2 to radar #1 are simultaneously performed (multiplexing transmission) at the same frequency and with different codes (hereinafter referred to as “inter-multistatic code multiplexing transmission”).

When inter-multistatic code multiplexing transmission is performed, for example, a chirp signal having the same center frequency may be used as a common signal. For example, for the transmission processing, the radar apparatus may multiply each chirp signal by an orthogonal code (or a code having a correlation value of zero or almost zero with respect to another code) between transmission in the multistatic configuration from radar #1 to radar #2 and transmission in the multistatic configuration from radar #2 to radar #1, and transmit the chirp signal.

Further, with respect to the reception processing, the radar apparatus may perform demultiplexing processing on the multiplexed transmission signals using, for example, the codes used for transmission.

In the inter-multistatic code multiplexing transmission, for example, the code separation processing amount tends to increase. In addition, in the inter-multistatic code multiplexing transmission, inter-code interference occurs in a reflected wave from a target object with a relative velocity, which is likely to cause deterioration in positioning performance. In addition, when the inter-code interference is suppressed in the inter-multistatic code multiplexing transmission, the maximum Doppler that can be observed in the radar apparatus tends to be reduced.

Regarding the transmission of the radar with the multistatic configuration, the application of the multiplexing transmission to which time division, frequency division, or code division is applied has been described above.

In a non-limiting exemplary embodiment of the present disclosure, a method for improving the efficiency of target detection in the mono- & multi-static configuration is described. For example, the non-limiting exemplary embodiment of the present disclosure describes a multiplexing transmission method that enables inter-multistatic simultaneous multiplexing transmission, in addition to the monostatic configuration, and reduces the time required for radar distance measurement.

For example, in a non-limiting exemplary embodiment of the present disclosure, in addition to radar positioning with the monostatic configuration of radar #1 and radar #2 illustrated in FIG. 1, radar positioning with the multistatic configuration from radar #1 to radar #2 and radar positioning with the multistatic configuration from radar #2 to radar #1 may be performed simultaneously. In this case, for example, Doppler Division Multiplexing (DDM) using different Doppler multiplexing intervals may be applied as inter-multistatic multiplexing transmission (hereinafter, also referred to as “inter-multistatic Doppler multiplexing transmission”).

Note that the radar apparatus according to an exemplary embodiment of the present disclosure may be mounted on a mobile entity such as a vehicle, for example. A positioning output (information on an estimation result) of the radar apparatus mounted on a mobile entity may be output to, for example, an Advanced Driver Assistance System (ADAS) that enhances collision safety or a control Electronic Control Unit (ECU) (not illustrated) such as an automated driving system, and may be used for vehicle-drive control or alarm call control.

In addition, the radar apparatus according to one exemplary embodiment of the present disclosure may be attached to a relatively high-altitude structure, such as, for example, a roadside utility pole or traffic lights. Such a radar apparatus can be utilized, for example, as a sensor of a support system for enhancing the safety of passing vehicles or pedestrians, or a suspicious person intrusion prevention system. Further, the positioning output of the radar apparatus may be output to, for example, a control apparatus (not illustrated) in the support system for enhancing the safety or the suspicious person intrusion prevention system, and may be used for alarm call control or abnormality detection control.

The use of the radar apparatus is not limited to the above, and the radar apparatus may also be used for other uses.

Further, the target object is an object to be detected by the radar apparatus, and includes, for example, a vehicle (including four wheels and two wheels), a person, a block, a curbstone, or the like.

Embodiments of the present disclosure will be described below in detail with reference to the drawings. In the embodiments, the same constituent elements are identified with the same numerals, and a description thereof is omitted because of redundancy.

The following describes a configuration of a radar apparatus (for example, MIMO radar configuration) having a transmitting branch in which multiplexed different transmission signals are simultaneously sent from a plurality of transmission antennas, and a receiving branch in which the transmission signals are separated and subjected to reception processing.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is also applicable to a radar system that uses a pulse compression radar configured to transmit a pulse train after performing phase modulation or amplitude modulation on the pulse train.

### Embodiment 1

### [Configuration of Radar Apparatus]

The radar apparatus (or radar system) according to the present embodiment may include, for example, a plurality of radar sections (which corresponds to radar circuitry and is, for example, a MIMO radar). Further, the radar apparatus according to the present embodiment may include, for example, a synchronization controller (for example, corresponding to control circuitry) that performs synchronization control between a plurality of radar sections, and a positioning output integrator that integrates positioning outputs of the plurality of radar sections.

For example, radar apparatus 1 illustrated in FIG. 2 is a radar system including first radar section 10 (or expressed by radar section 10-1) having a plurality of transmission/reception antennas (not illustrated), and second radar section 10 (or expressed by radar section 10-2) having a plurality of transmission/reception antennas (not illustrated).

In radar apparatus 1 illustrated in FIG. 2, synchronization controller 20 performs synchronization control between first radar section 10 and second radar section 10. For example, synchronization controller 20 may generate a chirp signal or a reference clock signal (also referred to as a reference signal) as a common signal to first radar section 10 and second radar section 10 for synchronization control.

Here, the reference clock signal is, for example, a reference signal of a Voltage Controlled Oscillator (VCO) that generates a chirp signal, and is a high-frequency signal of about several tens to several hundreds MHz. Accordingly, in the case where the reference clock signal is used, a system cost can be lowered as compared with the case where the chirp signal (for example, GHz order) is used. Further, in the case where the reference clock signal is used, the chirp signal is generated individually in each of first radar section 10 and second radar section 10. Thus, the coherence of the phases between first radar section 10 and second radar section 10 is not guaranteed, and the phase shift to such an extent as to drift to cause displacement is likely to occur. For example, radar apparatus 1 may measure and correct a drift component of the phase between first radar section 10 and second radar section 10 in advance.

For example, radar apparatus 1 may transmit a transmission signal from a plurality of transmission antennas of radar transmitter 100-1 of first radar section 10. Radar apparatus 1 may perform positioning processing of target object #1, for example, by receiving a reflected wave signal by radar receiver 200-1 having a plurality of reception antennas of first radar section 10, the reflected wave signal being the transmission signal of first radar section 10 reflected by target object #1 (not illustrated) (for example, radar positioning using the monostatic configuration).

Further, radar apparatus 1 may perform positioning processing of target object #2, for example, by receiving a reflected wave signal by radar receiver 200-2 having a plurality of reception antennas of second radar section 10, the reflected wave signal being a transmission signal of first radar section 10 reflected by target object #2 (not illustrated) (for example, radar positioning using the multistatic configuration).

Similarly, for example, radar apparatus 1 may transmit a transmission signal from a plurality of transmission antennas of radar transmitter 100-2 of second radar section 10. Radar apparatus 1 may perform positioning processing of target object #3, for example, by receiving a reflected wave signal by radar receiver 200-2 having a plurality of reception antennas of second radar section 10, the reflected wave signal being the transmission signal of second radar section 10 reflected by target object #3 (not illustrated) (for example, radar positioning using the monostatic configuration).

Further, radar apparatus 1 may perform positioning processing of target object #2, for example, by receiving a reflected wave signal by radar receiver 200-1 having a plurality of reception antennas of first radar section 10, the reflected wave signal being a transmission signal of second radar section 10 reflected by target object #2 (not illustrated) (for example, radar positioning using the multistatic configuration).

Note that the reception processing in first radar section 10 and second radar section 10 may be performed using, for example, a MIMO virtual antenna.

In the present embodiment, radar apparatus 1 may perform multiplexing transmission of the transmission signal from radar transmitter 100-1 of first radar section 10 and the transmission signal from radar transmitter 100-2 of second radar section 10.

For example, each of first radar section 10 and second radar section 10 may include a first demultiplexer that demultiplexes, from the reception signal, the reflected wave signal for the transmission signal from radar transmitter 100 of the corresponding radar section, and a second demultiplexer that demultiplexes the reflected wave signal for the transmission signal from radar transmitter 100 of the other radar section.

Further, for example, each of first radar section 10 and second radar section 10 may include a first direction estimator that performs direction estimation using the signal demultiplexed by the first demultiplexer and a second direction estimator that performs direction estimation using the signal demultiplexed by the second demultiplexer.

In FIG. 2, for example, positioning output integrator 30 may integrate positioning outputs from first radar section 10 (for example, a first positioning output and a second positioning output) and positioning outputs from second radar section 10 (for example, a first positioning output and a second positioning output) to perform positioning of the target object.

With such a configuration, radar apparatus 1 can receive the reflected wave from the target object at radar receiver 200-1 of first radar section 10 and radar receiver 200-2 of second radar section 10, demultiplex the reception signal depending on whether the reception signal is a reflected wave of the transmission signal of the corresponding radar section or a reflected wave of the transmission signal of the other radar section, and appropriately perform the positioning processing based on the positional information of each of first radar section 10 and second radar section 10. Further, radar apparatus 1 can also shorten the positioning time.

For example, in FIG. 2, first radar section 10 and second radar section 10 may be disposed at locations apart from each other. In this case, radar apparatus 1 can be used as a radar of the so-called multistatic configuration. For example, positioning by the radar having the multistatic configuration in which the first transmission signal emitted from first radar section 10 is received by radar receiver 200-2 of second radar section 10 and positioning by the radar having the multistatic configuration in which the second transmission signal emitted from second radar section 10 is received by radar receiver 200-1 of first radar section 10 are simultaneously possible, and thus it is possible to shorten the positioning time.

Since first radar section 10 and second radar section 10 illustrated in FIG. 2 have the same configuration, they are collectively denoted and described as “radar sections 10” thereinbelow, and different operations between first radar section 10 and second radar section 10 will be described distinctively.

FIG. 3 illustrates an exemplary configuration of radar apparatus 1 in which a frequency-modulated chirp signal is used as a radar transmission signal (also referred to as a radar signal or a radar transmission wave).

Radar apparatus 1 of FIG. 3 includes, for example, a plurality of radar sections 10 (corresponding to, for example, first radar section 10 and second radar section 10 illustrated in FIG. 2), synchronization controller 20, and positioning output integrator 30 (not illustrated). In FIG. 3, an exemplary configuration of one radar section 10 among the plurality of radar sections 10 is illustrated, and the illustration of other radar sections 10 is omitted.

Radar section 10 includes, for example, radar transmitter (corresponding to a transmission branch or radar transmission circuitry) 100 and radar receiver (corresponding to a reception branch or radar reception circuitry) 200.

Radar transmitter 100 generates the radar transmission signal, for example, and transmits the radar transmission signal at a predetermined transmission period using a transmission array antenna including a plurality of transmission antennas 102-1 to 102-Nt.

Radar receiver 200 receives reflected wave signals, which are radar transmission signals reflected by a target object (target) (not illustrated), using a reception array antenna composed of a plurality of reception antennas 202-1 to 202-Na, for example. Radar receiver 200 performs signal processing on the reflected wave signals received at reception antennas 202 to, for example, detect the presence or absence of the target object, or estimate the directions of arrival of the reflected wave signals.

For example, synchronization controller 20 generates a chirp signal and supplies the generated chirp signal to the plurality of radar sections 10.

### [Exemplary Configuration of Synchronization Controller 20]

Synchronization controller 20 includes, for example, radar transmission signal generator 301 and signal controller 304.

Radar transmission signal generator 301 generates a radar transmission signal based on, for example, control by signal controller 304. The generated radar transmission signal may be, for example, a predetermined frequency modulated wave (e.g., a frequency chirp signal or a chirp signal). Radar transmission signal generator 301 outputs the generated chirp signal to the plurality of radar sections 10 (for example, radar transmitter 100).

Radar transmission signal generator 301 includes, for example, modulation signal generator 302 and VCO 303. Hereinafter, the components of radar transmission signal generator 301 will be described.

Modulation signal generator 302 periodically generates, for example, saw-toothed modulation signals. The radar transmission period is herein represented by Tᵣ.

VCO 303 generates a chirp signal based on the modulation signal output from modulation signal generator 302, and outputs the chirp signal to radar transmitter 100 (for example, Doppler shifters 101-1 to 101-Nt) and radar receiver 200 (mixer 204 described later) of radar section 10.

Signal controller 304 controls generation of the radar transmission signal of radar transmission signal generator 301 (for example, modulation signal generator 302 and VCO 303). For example, signal controller 304 may configure parameters (for example, modulation parameters) related to the chirp signal such that the chirp signal is transmitted Ne times for transmission periods Tᵣ per one radar positioning.

FIG. 4 illustrates an example of the chirp signal output from synchronization controller 20. For example, radar apparatus 1 can detect a time variation of the positioning results of positioning the target object by transmitting the chirp signal generated by synchronization controller 20 and measuring, multiple times, the reflected wave being the chirp signal reflected by the target object. In the following description, each transmission period among N_{c} transmission periods Tᵣ is represented by index “m.” Here, “m” are integers of from 1 to N_{c}.

FIG. 5 illustrates an example of the chirp signal output from synchronization controller 20.

As illustrated in FIG. 5, the modulation parameters for the chirp signal may include, for example, center frequency f_{c}, frequency sweep bandwidth B_{w}, sweep start frequency f_{cstart}, sweep end frequency f_{cend}, frequency sweep duration T_{sw}, and frequency sweep change rate Dₘ. Note that Dₘ=B_{w}/T_{sw}. Note also that B_{w}=f_{cend}−f_{cstart}, and f_{c}=(f_{cstart}+f_{cend})/2.

Frequency sweep time T_{sw} corresponds to, for example, a time range (also called a range gate) in which A/D sampled data is taken by A/D converter 207 of radar receiver 200, which will be described later. Frequency sweep time T_{sw} may be set to an entire time section of the chirp signal as illustrated at (a) in FIG. 5, or may be set to a partial time section of the chirp signal as illustrated at (b) in FIG. 5, for example.

Note that FIGS. 4 and 5 illustrate examples of up-chirp waveforms in which the modulation frequency gradually increases with time, but the present disclosure is not limited thereto, and down-chirp in which the modulation frequency gradually decreases with time may be applied. Similar effects can be obtained regardless of whether the modulation frequency is of up-chirps or down-chirps.

The chirp signals outputted from synchronization controller 20 (for example, VCO 303) are inputted to, for example, each mixer 204 of radar receiver 200 and Nt Doppler shifters 101.

### [Exemplary Configuration of Radar Transmitter 100]

In FIG. 3, radar transmitter 100 of radar section 10 includes, for example, Doppler shifters 101-1 to 101-Nt and transmission antennas 102-1 to 102-Nt (for example, Tx #1 to Tx #Nt). Radar transmitter 100 may include Nt transmission antennas 102, and transmission antennas 102 may be connected to respective different Doppler shifters 101.

To apply Doppler shift amount DOPₙ(q) to the chirp signal inputted from VCO 303, each of Doppler shifters 101 of qth radar section 10 applies phase rotation Φ_{n,q} to the chirp signal for each transmission period Tᵣ of the chirp signal, and outputs the Doppler-shifted signal to transmission antenna 102.

Here, “q” represents indices for identifying a plurality of radar sections 10 included in radar apparatus 1, and may be, for example, q=1 or 2. Further, for example, the number of transmission antennas 102 in each qth radar section 10 may be the same or may be different. Hereinafter, the number of transmission antennas in qth radar section 10 will be referred to as “Nt(q)” (or simply “Nt”). Here, Nt(q)>1. In addition, n=1 to Nt(q).

For example, qth radar section 10 may perform output while applying predetermined phase rotations Φ_{n,q}(m) for applying respective different Doppler shifts to transmission antennas 102 used for the multiplexing transmission of the monostatic radar (an exemplary operation will be described later). Further, qth radar section 10 may perform output, for example, while applying predetermined phase rotations Φ_{n,q}(m) for applying Doppler shifts for providing different Doppler multiplexing intervals (also referred to as Doppler shift intervals or Doppler intervals) between radar sections 10 that perform the multiplexing transmission of the multistatic radar (an exemplary operation will be described later).

The signals outputted from Doppler shifters 101 are amplified to a predetermined transmission power and emitted into space from respective transmission antennas 102 (e.g., Tx #1 to Tx #Nt).

### [Exemplary Configuration of Radar Receiver 200]

In FIG. 3, radar receiver 200 includes Na reception antennas 202 (for example, Rx #1 to Rx #Na), and serves as a component of an array antenna. Further, radar receiver 200 includes Na antenna system processors 201, Constant False Alarm Rate (CFAR) sections 210, Doppler demultiplexers 211, and direction estimators 212.

Here, the number of reception antennas 202 may be the same or may be different between qth radar sections 10 (for example, q=1 or 2). Hereinafter, the number of reception antennas in qth radar section 10 will be referred to as “Na(q)” (also referred to simply as “Na”). Here, Na(q)≥1.

Antenna system processors 201 may be provided to correspond respectively to Na(q) reception antennas 202, for example. In addition, CFAR sections 210, Doppler demultiplexers 211, and direction estimators 212 may be provided in each of q radar sections 10, for example, to correspond to one another.

Each of Na(q) reception antennas 202 receives a reflected wave signal being a radar transmission signal transmitted from each of the plurality of radar sections 10 and reflected by a target object (for example, a reflective object including a radar measurement target), and outputs the received reflected wave signal to corresponding antenna system processor 201 as a reception signal. For example, reception antenna 202 simultaneously receives a radar reflected wave corresponding to a monostatic configuration and a radar reflected wave corresponding to a multistatic configuration.

Each of antenna system processors 201 includes reception radio 203 and signal processor 206.

Reception radio 203 includes mixer 204 and low pass filter (LPF) 205. In reception radio 203, mixer 204 mixes the received reflected wave signal (reception signal) with the chirp signal that is the transmission signal. Further, a beat signal having a frequency corresponding to a delay time of the reflected wave signal is extracted by passing an output of mixer 204 through LPF 205. For example, as illustrated in FIG. 6, a difference frequency between a frequency of the transmission signal (transmission frequency-modulated wave) and a frequency of the reception signal (reception frequency-modulated wave) is obtained as the beat frequency (or beat signal).

In FIG. 3, Signal processor 206 of each antenna system processor 201-z (where z=any one of 1 to Na) includes A/D converter 207, beat frequency analyzer 208, and Doppler analyzer 209.

The signal (for example, beat signal) outputted from LPF 205 is converted into discretely sampled data by A/D converter 207 in signal processor 206.

Beat frequency analyzer 208 performs, for each transmission period Tᵣ, FFT processing on N_{data} pieces of discretely sampled data obtained in a predetermined time range (range gate). Here, the range gate may set frequency sweep time T_{sw}. Signal processor 206 thus outputs a frequency spectrum in which a peak appears at a beat frequency dependent on the delay time of the reflected wave signal (radar reflected wave). In the FFT processing, for example, beat frequency analyzer 208 may perform multiplication by a window function coefficient such as the Han window or the Hamming window. The use of the window function coefficient can suppress sidelobes around the beat frequency peak.

When N_{data} is not a power of 2, zero-padded data is included, for example, to obtain the data size of a power of 2 and the FFT processing can thus be performed. In such cases, the number of data including the zero-padded data may be regarded as N_{data} and treated similarly regardless of whether or not N_{data} is a power of 2.

Here, a beat frequency response obtained by the mth chirp pulse transmission of the chirp signal, which is outputted from beat frequency analyzer 208 in zth signal processor 206, is denoted as “RFT_{z}(f_{b}, m).” Here, f_{b} denotes the beat frequency index and corresponds to an FFT index (bin number). For example, f_{b}=0 to N_{data}/2−1, z=an integer of from 1 to Na, and m=an integer of from 1 to N_{C}. A beat frequency having smaller beat frequency index f_{b} indicates a shorter delay time of the reflected wave signal (for example, a shorter distance to the target object).

In addition, beat frequency index f_{b} may be converted to distance information R(f_{b}) using Expression 1 for the monostatic configuration and Expression 2 for the multistatic configuration. Thus, in the following, beat frequency index f_{b} is also referred to as “distance index f_{b}.”

$$\begin{matrix}( Expression 1 ) & \\ R ( {f}_{b} ) = \frac{{C}_{0} {f}_{b}}{2 {B}_{w}} . & ( 1 )\end{matrix}$$

$$\begin{matrix}( Expression 2 ) & \\ R ( {f}_{b} ) = \frac{{C}_{0} {f}_{b}}{{B}_{w}} . & ( 2 )\end{matrix}$$

Here, B_{w} denotes a frequency sweeping bandwidth within the range gate for a chirp signal, and C₀ denotes the speed of light.

Doppler analyzer 209 of zth signal processor 206 performs Doppler analysis for each distance index f_{b} by using beat frequency response RFT_{z}(f_{b}, 1), RFT_{z}(f_{b}, 2), . . . , and RFT_{z}(f_{b}, N_{C}) obtained by N_{C} chirp pulse transmissions of the chirp signal.

For example, when N_{c} is a power of 2, Doppler analyzer 209 of qth radar section 10 can apply FFT processing in the Doppler analysis. Here, the FFT size is N_{c}, and the maximum Doppler frequency at which no aliasing occurs and which is derived from the sampling theorem is +1/(2Tᵣ). Further, the Doppler frequency interval of Doppler frequency index fₛ is 1/(N_{c}×Tᵣ), and the range of Doppler frequency index fₛ is fₛ=—N_{c}/2, . . . , 0, . . . , and N_{c}/2-1.

By way of example, a description will be given of a case where N_{c} is a power of 2. When N_{c} is not a power of 2, zero-padded data is included, for example, to obtain the data size of a power of 2 and the FFT processing can thus be performed. In the FFT processing, Doppler analyzer 209 may perform multiplication by a window function coefficient such as the Han window or the Hamming window. It is possible to suppress sidelobes generated around the beat frequency peak by applying a window function.

For example, output VFT_{z,q}(f_{b}, fₛ) from Doppler analyzer 209 in zth signal processor 206 of qth radar section 10 is given by following Expression 3. Here, j is an imaginary unit, z is an integer of from 1 to Na, and q is 1 or 2. Note that the beat frequency response outputted from beat frequency analyzer 208 in qth radar section 10 is expressed as “RFT_{z,q}(f_{b}, m”). The same applies hereinafter.

$$\begin{matrix}( Expression 3 ) & \\ V F {T}_{z , q} ( {f}_{b} , {f}_{s} ) = {\sum }_{m = 1}^{{N}_{c}} R F {T}_{z , q} ( {f}_{b} , m ) exp [ - \frac{j 2 π ( m - 1 ) {f}_{s}}{{N}_{c}} ] . & ( 3 )\end{matrix}$$

The processing in each component of signal processor 206 has been described above.

In FIG. 3, CFAR sections 210 perform CFAR processing (for example, adaptive threshold determination) using the outputs from Doppler analyzers 209 of first to Nath signal processors 206 to extract distance indices f_{b_cfar} and Doppler frequency indices f_{s_cfar} that provide local peak signals. As illustrated in FIG. 3, CFAR sections 210 may include, for example, first CFAR section 210 (also expressed as CFAR section 210-1) corresponding to the monostatic configuration, and second CFAR section 210 (also expressed as CFAR section 210-2) corresponding to the multistatic configuration.

For example, first CFAR section 210 selectively extracts local peaks of the reflected wave signals (reception signals) for the radar transmission signals of qth radar section 10 (the corresponding radar), which has the monostatic configuration, using outputs VFT_{1,q}(f_{b}, fₛ), VFT_{2,q}(f_{b}, fₛ), . . . , and VFTN_{a(q),q}(f_{b}, fₛ) of Doppler analyzers 209 of first to Na(q)th signal processors 206. For example, first CFAR section 210 may perform the CFAR processing of performing the adaptive threshold determination after power addition at intervals matching the Doppler multiplexing intervals set for the radar transmission signals transmitted from qth radar section 10, extract distance indices f_{b_cfar} and Doppler frequency indices f_{sddm_cfar} that provide local peak signals, and output extracted distance indices f_{b_cfar} and Doppler frequency indices f_{sddm_cfar} to first Doppler demultiplexer 211 (an exemplary operation will be described later).

The radar transmitter having the monostatic configuration in first radar section 10 is radar transmitter 100 of first radar section 10. Similarly, the radar transmitter having the monostatic configuration in second radar section 10 is radar transmitter 100 of second radar section 10.

Further, for example, second CFAR section 210 selectively extracts local peaks of the reflected wave signals for the radar transmission signals of another radar section 10 different from qth radar section 10 (the corresponding radar), which has the multistatic configuration, using outputs VFT_{1,q}(f_{b}, fₛ), VFT_{2,q}(f_{b}, fₛ), . . . , and VFT_{Na(q),q}(f_{b}, fₛ) of Doppler analyzers 209 of first to Na(q)th signal processors 206. For example, second CFAR section 210 may perform the CFAR processing of performing the adaptive threshold determination after the power addition at intervals matching the Doppler multiplexing intervals set for the radar transmission signals transmitted from radar section 10 other than qth radar section 10, extract distance indices f_{b_cfar} and Doppler frequency indices f_{sddm_cfar} that provide local peak signals, and output the extracted distance indices f_{b_cfar} and Doppler frequency indices f_{sddm_cfar} to second Doppler demultiplexer 211 (an exemplary operation will be described later).

The radar transmitter having the multistatic configuration in first radar section 10 is radar transmitter 100 of second radar section 10. Similarly, radar transmitter 100 having the multistatic configuration in second radar section 10 is radar transmitter 100 of first radar section 10.

Doppler demultiplexers 211 may include first Doppler demultiplexer 211 (also referred to as Doppler demultiplexer 211-1) that performs Doppler demultiplexing processing using the outputs of Doppler analyzers 209 and first CFAR section 210, and second Doppler demultiplexer 211 (also referred to as Doppler demultiplexer 211-2) that performs Doppler demultiplexing processing using the outputs of Doppler analyzers 209 and second CFAR section 210.

For example, first Doppler demultiplexer 211 of qth radar section 10 performs Doppler demultiplexing on the reflected wave signals for the radar transmission signals of qth radar section 10 (the corresponding radar), which has the monostatic configuration, using the outputs of first CFAR section 210. Further, second Doppler demultiplexer 211 of qth radar section 10 performs Doppler demultiplexing on the reflected wave signals for the radar transmission signals of another radar section 10 that differs from qth radar section 10 (the corresponding radar), which has the multistatic configuration, using the outputs of second CFAR section 210, for example.

For example, first Doppler demultiplexer 211 outputs information on the demultiplexed signal to first direction estimator 212-1. Further, second Doppler demultiplexer 211 outputs, for example, information on the demultiplexed signal to second direction estimator 212-2. The information about the demultiplexed signal may include, for example, a distance index and a Doppler frequency index corresponding to the demultiplexed signal (which may also hereinafter be referred to as demultiplexing index information). Further, Doppler demultiplexers 211 outputs the outputs from Doppler analyzers 209 to direction estimators 212.

Hereinafter, an exemplary operation of qth Doppler demultiplexer 211 will be described together with an exemplary operation of Doppler shifters 101 and qth CFAR section 210. For example, q=1 or 2 may hold true.

The operation of qth Doppler demultiplexer 211 is related to the operation of Doppler shifters 101 of radar transmitter 100. Similarly, the operation of qth CFAR section 210 is related to the operation of Doppler shifters 101 of radar transmitter 100.

Hereinafter, an exemplary operation of Doppler shifters 101 will be described, and an exemplary operation of qth CFAR section 210 and an exemplary operation of qth Doppler demultiplexer 211 will then be described.

### [Method for Setting Doppler Shift Amount]

To begin with, an example of a method for setting the Doppler shift amount applied in Doppler shifters 101 will be described.

First to Nt(q)th Doppler shifters 101 of qth radar section 10 perform Doppler multiplexing transmission by applying respective different Doppler shift amounts DOPₙ(q) of predetermined Doppler multiplexing intervals Δfd(q) to the chirp signals inputted from synchronization controller 20. At this time, Doppler multiplexing intervals Δfd(q) may satisfy the following setting conditions (1) and (2).
(1) The Doppler multiplexing intervals may be set to different intervals between the plurality of radar sections 10. For example, the intervals for respective Doppler shift amounts applied to the radar transmission signals transmitted from the plurality of transmission antennas 102 of first radar section 10 and the intervals for respective Doppler shift amounts applied to the radar transmission signals transmitted from the plurality of transmission antennas 102 of second radar section 10 may be different from each other (for example, Δfd(1) #Δfd(2)).
(2) For example, the ratio between Δfd(1) and Δfd(2) may be set so as not to match an integer. For example, of Δfd(1) and Δfd(2), the ratio of the Doppler multiplexing interval having the larger value to the Doppler multiplexing interval having the smaller value may be different from the integer. For example, Δfd(1)/Δfd(2) or Δfd(2)/Δfd(1) may be set so as not to match the integer (so as to be different from the integer).

Hereinafter, an example of setting Doppler multiplexing interval Δfd(q) will be described.

In the following description, the number of Doppler multiplexing for qth radar section 10 will be referred to as “N_{DM}(q),” and a description is given of a case of N_{DM}(q)=Nt(q), but the present disclosure is not limited thereto. For example, radar section 10 may bundle some of the plurality of transmission antennas 102 to form a transmission beam for performing Doppler multiplexing transmission. In this case, N_{DM}(q)<Nt(q). Here, m is an integer of from 1 to N_{c}. Further, for example, index n of Doppler shift amount DOPₙ(q) represents an index of the Doppler multiplexed signal, and n is an integer of from 1 to N_{DM}(q). Also, N_{DM}(q)>1 and q=1 or 2.

For example, Doppler shifter 101 may apply a predetermined phase rotation (e.g., ranging from 0 to 2π) to the chirp signal at every transmission period Tᵣ.

Here, in Doppler analyzers 209, the range of Doppler frequency f_{d} in which no aliasing is generated and which is derived from the sampling theorem is from −1/(2Tᵣ)≤f_{d}<1/(2Tᵣ). For example, even when the Doppler frequency exceeds the range of Doppler frequency f_{d} in which no aliasing occurs, the range of Doppler frequency f_{d} observed in Doppler analyzers 209 is from −1/(2Tᵣ)≤f_{d}<1/(2Tᵣ).

Therefore, for example, when Doppler shifter 101 applies the Doppler shift within the range of −1/(2Tᵣ)≤f_{d}<1/(2Tᵣ), the maximum Doppler shift interval (for example, expressed as “Δfdmax”) for Nt(q) transmission antennas 102 (for example, the number equal to the Doppler multiplexing number) is Δfdmax=1/(TᵣNt(q))=1/(TᵣN_{DM}(q)). For example, Doppler shifters 101 may set Δfd(1) and Δfd(2) to different intervals within the range up to Δfdmax. Accordingly, Doppler shifters 101 can set the Doppler shift within the range of 0 to 2π that is the phase rotation providing the Doppler shift.

For example, the Doppler multiplexing intervals of each of first radar section 10 and second radar section 10 may be set to Δfd(1)=1/(Tᵣ×(N_{DM}(1)+δ₁)) and Δfd(2)=1/(Tᵣ×(N_{DM}(2)+δ₂)), respectively.

Here, δ₁, δ₂≥0 and satisfies N_{DM}(1)+δ₁≠N_{DM}(2)+δ₂. Further, δ₁ and δ₂ may be set so that the ratio between N_{DM}(1)+δ₁ and N_{DM}(2)+δ₂ does not match an integer. With this setting, the Doppler multiplexing interval is different between the plurality of radar sections 10 (for example, between first radar section 10 and second radar section 10) (Δfd(1)≠Δfd(2)), and the ratio between Δfd(1) and Δfd(2) does not match an integer.

Note that each of δ₁ and δ₂ may be a positive integer or a positive real number. For example, by setting δ₁ and δ₂ to positive integers, the processes in first CFAR section 210 and second CFAR section 210, which will be described later, can be simplified. Descriptions are given below of a case where δ₁ and δ₂ are each set to zero or a positive integer. However, the present disclosure is not limited thereto, and positive real numbers may be set.

In addition, when supposed situations are mostly those in which radar apparatus 1 and the target object are both stationary, a configuration may be adopted in which parameters (for example, values such as Doppler multiplexing intervals Δfd(q) or δ_{q}) which, for example, cause the Doppler shift amounts to match each other between first radar section 10 and second radar section 10 are excluded in advance. For example, for all of n₁ and n₂, the parameters may be set so as to satisfy following Expression 4:

$$\begin{matrix}( Expression 4 ) & \\ {DOP}_{n 1} ( 1 ) \neq {DOP}_{n 2} ( 2 ) , {n}_{1} ∈ \{ 1 , 2 , … Nt ( 1 ) \} , {n}_{2} ∈ \{ 1 , 2 , … Nt ( 2 ) \} . & ( 4 )\end{matrix}$$

By this setting, for example, Doppler shift amount DOPₙ₁(1) applied to the radar transmission signal of first radar section 10 and Doppler shift amount DOPₙ₂(2) applied to the radar transmission signal of second radar section 10 are set to values different from each other.

The parameter setting satisfying Expression 4 may be applied, for example, to situations in which both radar apparatus 1 and the target object are supposed to be mostly stationary. For example, when radar apparatus 1 and the target object are both stationary, a Doppler component is zero. Therefore, for example, even when the reflected wave signal for the radar transmission signal of first radar section 10 and the reflected wave signal for the radar transmission signal of second radar section 10 are included in the same distance index, Doppler shift amount DOPₙ(q) for each MIMO multiplexed transmission signal is different. Thus, radar apparatus 1 can demultiplex and receive both the reflected wave signals by utilizing the difference in detected Doppler components.

A description is given below of exemplary setting of Doppler shift amounts.

### Setting Example 1

For example, when N_{DM}(1) #N_{DM}(2) and the ratio of N_{DM}(1) to N_{DM}(2) does not match an integer multiple, then Δfd(1)=1/(Tᵣ×N_{DM}(1)) and Δfd(2)=1/(Tᵣ×N_{DM}(2)) may be set. In this case, the above-described setting conditions of the Doppler multiplexing intervals are satisfied.

In this case, the Doppler multiplexing interval can be maximized within the range of −1/(2Tᵣ)≤f_{d}<1/(2Tᵣ) of Doppler frequencies f_{d} observed by Doppler analyzers 209. Therefore, for example, even in a case where the Doppler spectrum has a spread, such as a case where the moving speed of the target is not constant and has a component such as acceleration, the interference effect between the Doppler multiplexed signals can be reduced. For example, when a Doppler velocity observable by using non-uniformity of Doppler multiplexing intervals as disclosed in PTL 1 does not increase, the Doppler velocity is −1/(2Tᵣ×N_{DM}(1))≤f_{d}<1/(2Tᵣ×N_{DM}(1)) or −1/(2Tᵣ×N_{DM}(2))≤f_{d}<1/(2Tᵣ×N_{DM}(2)).

By way of example, FIG. 7 illustrates an example of Doppler shift setting of first radar section 10 (upper part of FIG. 7) and an example of Doppler shift setting of second radar section 10 (lower part of FIG. 7) in a case of N_{DM}(1)=Nt(1)=3 and N_{DM}(2)=Nt(2)=4. In FIG. 7, Δfd(1)=1/(3Tᵣ) (e.g., δ₁=0) is set and Δfd(2)=1/(4Tᵣ) (e.g., δ₂=0) is set. For example, in FIG. 7, Doppler shift amounts DOP₁(1) and DOP₁(2) assigned to first transmission antennas 102 (Tx #1) of first radar section 10 and second radar section 10 are set to values corresponding to Doppler frequency f_{d}=0. For example, in FIG. 7, at least one Doppler shift amounts match each other between first radar section 10 and second radar section 10.

By way of another example, FIG. 8 illustrates an example of Doppler shift setting of first radar section 10 (upper part of FIG. 8) and an example of Doppler shift setting of second radar section 10 (lower part of FIG. 8) in the case of N_{DM}(1)=Nt(1)=3 and N_{DM}(2)=Nt(2)=4. In FIG. 8 as in FIG. 7, Δfd(1)=1/(3Tᵣ) (e.g., δ₁=0) is set, and Δfd(2)=1/(4Tᵣ) (e.g., δ₂=0) is set. Further, in FIG. 8, Doppler shift amounts DOPₙ₁(1) and DOPₙ₂(2) applied to respective transmission antennas 102 of first radar section 10 and second radar section 10 are set so that the Doppler shift amounts do not match each other between first radar section 10 and second radar section 10 (for example, so as to satisfy Expression 4).

### Setting Example 2

For example, when N_{DM}(1) #N_{DM}(2) and the ratio of N_{DM}(1) and N_{DM}(2) matches an integer, then the above-described Doppler multiplexing interval setting conditions are satisfied when Δfd(1)=1/(Tᵣ×(N_{DM}(1)+1)) and f_{d}(2)=1/(Tᵣ×(N_{DM}(2)+1)) are set, when Δfd(1)=1/(Tᵣ×N_{DM}(1)) and Δfd(2)=1/(Tᵣ×(N_{DM}(2)+1)) are set, or when Δfd(1)=1/(Tᵣ×(N_{DM}(1)+1)) and Δfd(2)=1/(Tᵣ×N_{DM}(2)) are set.

In this case, the Doppler multiplexing interval can be maximized within the range of −1/(2Tᵣ)≤f_{d}<1/(2Tᵣ) of Doppler frequencies f_{d} observed by Doppler analyzers 209. Therefore, for example, even in a case where the Doppler spectrum has a spread, such as a case where the moving speed of the target is not constant and has a component such as acceleration, the interference effect between the Doppler multiplexed signals can be reduced.

Further, for example, when the Doppler multiplexing intervals include a non-uniform part, the Doppler velocity observable by using the non-uniformity of the Doppler intervals is −1/(2Tᵣ)≤f_{d}<1/(2Tᵣ) as disclosed in PTL 1.

By way of example, FIG. 9 illustrates an example of Doppler shift setting of first radar section 10 (upper part of FIG. 9) and an example of Doppler shift setting of second radar section 10 (lower part of FIG. 9) in a case of N_{DM}(1)=Nt(1)=2 and N_{DM}(2)=Nt(2)=4. In FIG. 9, Δfd(1)=1/(3Tᵣ) (e.g., § 1=1) is set and Δfd(2)=1/(4Tᵣ) (e.g., δ₂=0) is set. For example, in FIG. 9, Doppler shift amounts DOP₁(1) and DOP₁(2) assigned to first transmission antennas 102 (Tx #1) of first radar section 10 and second radar section 10 are set to values corresponding to Doppler frequency f_{d}=0. For example, in FIG. 9, at least one Doppler shift amounts match each other between first radar section 10 and second radar section 10.

Further, for example, regarding the Doppler shifts set for first radar section 10 illustrated in FIG. 9, a Doppler shift for providing an interval of Δfd(1) is not assigned on the negative side and thus a non-uniform Doppler multiplexing interval portion is included. For example, the Doppler shift intervals set for first radar section 10 are set to one of intervals obtained by unequally dividing the Doppler frequency range to be subjected to the Doppler analysis.

By way of another example, FIG. 10 illustrates an example of Doppler shift setting of first radar section 10 (upper part of FIG. 10) and an example of Doppler shift setting of second radar section 10 (lower part of FIG. 10) in the case of N_{DM}(1)=Nt(1)=2 and N_{DM}(2)=Nt(2)=4. In FIG. 10 as in FIG. 9, Δfd(1)=1/(3Tᵣ) (e.g., δ₁=1) is set, and Δfd(2)=1/(4Tᵣ) (e.g., δ₂=0) is set. Further, in FIG. 10, Doppler shift amounts DOPₙ₁(1) and DOPₙ₂(2) applied to respective transmission antennas 102 of first radar section 10 and second radar section 10 are set so that the Doppler shift amounts do not match each other between first radar section 10 and second radar section 10 (for example, so as to satisfy Expression 4).

Further, for example, regarding the Doppler shifts set for first radar section 10 illustrated in FIG. 10, a Doppler shift for providing an interval of Δfd(1) is not assigned on the negative side and thus a non-uniform Doppler multiplexing interval portion is included. For example, the Doppler shift intervals set for first radar section 10 are set to one of intervals obtained by unequally dividing the Doppler frequency range to be subjected to the Doppler analysis.

In the Doppler frequency domain, the position where no Doppler shift is assigned is not limited to the negative-side region as illustrated in FIGS. 9 and 10, and may be a positive-side region.

### Setting Example 3

For example, when N_{DM}(1)=N_{DM}(2), the above-described setting conditions for the Doppler multiplexing interval are satisfied when Δfd(1)=1/(Tᵣ×N_{DM}(1)) and Δfd(2)=1/(Tᵣ×(N_{DM}(2)+1)) are set, Δfd(1)=1/(Tᵣ×(N_{DM}(1)+1)) and Δfd(2)=1/(Tᵣ×N_{DM}(2)) are set, or Δfd(1)=1/(Tᵣ×(N_{DM}(1)+1)) and Δfd(2)=1/(Tᵣ×(N_{DM}(1)+2)) are set.

In this case, the Doppler multiplexing interval can be maximized within the range of −1/(2Tᵣ)≤f_{d}<1/(2Tᵣ) of Doppler frequencies f_{d} observed by Doppler analyzers 209. Therefore, for example, even in a case where the Doppler spectrum has a spread, such as a case where the moving speed of the target is not constant and has a component such as acceleration, the interference effect between the Doppler multiplexed signals can be reduced. Further, for example, when the Doppler multiplexing intervals include a non-uniform part, the Doppler velocity observable by using the non-uniformity of the Doppler intervals is −1/(2Tᵣ)≤f_{d}<1/(2Tᵣ) as disclosed in PTL 1.

By way of example, FIG. 11 illustrates an example of Doppler shift setting of first radar section 10 (upper part of FIG. 11) and an example of Doppler shift setting of second radar section 10 (lower part of FIG. 11) in a case of N_{DM}(1)=Nt(1)=2 and N_{DM}(2)=Nt(2)=2. In FIG. 11, Δfd(1)=1/(3Tᵣ) (e.g., δ₁=1) is set, and Δfd(2)=1/(4Tᵣ) (e.g., δ₂=2) is set. For example, in FIG. 11, Doppler shift amounts DOP₁(1) and DOP₁(2) assigned to first transmission antennas 102 (Tx #1) of first radar section 10 and second radar section 10 are set to values corresponding to Doppler frequency f_{d}=0. For example, in FIG. 11, at least one Doppler shift amounts match each other between first radar section 10 and second radar section 10.

Further, for example, regarding the Doppler shifts set for first radar section 10 illustrated in FIG. 11, a Doppler shift for providing an interval of Δfd(1) is not assigned on the negative side and thus a non-uniform Doppler multiplexing interval portion is included. Further, for example, regarding the Doppler shifts set for second radar section 10 illustrated in FIG. 11, two Doppler shifts for providing an interval of Δfd(2) are not assigned on the negative side and thus a non-uniform Doppler multiplexing interval portion is included. For example, the Doppler shift interval set for each of first radar section 10 and second radar section 10 is set to one of intervals obtained by unequally dividing the Doppler frequency range to be subjected to the Doppler analysis.

By way of another example, FIG. 12 illustrates an example of Doppler shift setting of first radar section 10 (upper part of FIG. 12) and an example of Doppler shift setting of second radar section 10 (lower part of FIG. 12) in the case of N_{DM}(1)=Nt(1)=2 and N_{DM}(2)=Nt(2)=2. In FIG. 12 as in FIG. 11, Δfd(1)=1/(3Tᵣ) (e.g., δ₁=1) is set, and Δfd(2)=1/(4Tᵣ) (e.g., δ₂=2) is set. Further, in FIG. 12, Doppler shift amounts DOPₙ₁(1) and DOPₙ₂(2) applied to respective transmission antennas 102 of first radar section 10 and second radar section 10 are set so that the Doppler shift amounts do not match each other between first radar section 10 and second radar section 10 (for example, so as to satisfy Expression 4).

Further, for example, regarding the Doppler shifts set for first radar section 10 illustrated in FIG. 12, a Doppler shift for providing an interval of Δfd(1) is not assigned on the negative side and thus a non-uniform Doppler multiplexing interval portion is included. Further, for example, regarding the Doppler shifts set for second radar section 10 illustrated in FIG. 12, two Doppler shifts for providing an interval of Δfd(2) are not assigned on the positive side and thus a non-uniform Doppler multiplexing interval portion is included. For example, the Doppler shift interval set for each of first radar section 10 and second radar section 10 is set to one of intervals obtained by unequally dividing the Doppler frequency range to be subjected to the Doppler analysis.

The example of setting the doppler shift amounts have been described above.

As described above, setting the Doppler multiplexing intervals for each of first radar section 10 and second radar section 10 is performed such that the above-described setting conditions for Doppler multiplexing intervals are satisfied. This setting of the Doppler multiplexing intervals makes it more likely for the Doppler components corresponding to the radar reflected waves (reception signals) for the radar transmission signals from first radar section 10 and second radar section 10 to appear at respective different positions within the range of −1/(2Tᵣ)≤f_{d}<1/(2Tᵣ) of Doppler frequencies f_{d} observed by Doppler analyzers 209, and facilitates demultiplexing the reflected wave signals corresponding to first radar section 10 and second radar section 10 from each other.

By way of example, FIG. 13 illustrates an example of outputs (for example, reception Doppler frequencies) of Doppler analyzers 209 in a case where reflected wave signals for radar transmission signals from first radar section 10 and second radar section 10 are received. In FIG. 13, the vertical axis represents the distance axis, and the horizontal axis represents the Doppler frequency axis. Further, in FIG. 13, Doppler components having high power are represented by arrows.

When the Doppler components corresponding to interval Δfd(1) or the Doppler components corresponding to an integer multiple of interval Δfd(1) are observed at distance index fb1 or fb2 illustrated in FIG. 13, radar apparatus 1 can distinguish (or detect) that these Doppler components are reflected wave signals for the radar transmission signals transmitted from first radar section 10.

Further, when the Doppler components corresponding to interval Δfd(2) or the Doppler components corresponding to an integer multiple of interval Δfd(2) are observed at distance index fb3 or fb4 illustrated in FIG. 13, radar apparatus 1 can distinguish that these Doppler components are reflected wave signals for the radar transmission signals transmitted from second radar section 10.

Further, when a Doppler component that matches interval Δfd(1) (or an integer multiple of Δfd(1)) and a Doppler component that matches the interval of Δfd(2) (or an integer multiple of Δfd(2)) are observed in a mixed manner at distance index fb5 illustrated in FIG. 13, radar apparatus 1 can distinguish the reflected wave signals for the radar transmission signals transmitted from first radar section 10 and the reflected wave signals for the radar transmission signals transmitted from second radar section 10, for example, based on the intervals of the Doppler components.

As described above, radar apparatus 1 can distinguish whether the observed Doppler components are the reflected wave signals for the radar transmission signals transmitted from the radar section of first radar section 10 or from second radar section 10, based on the difference between the Doppler multiplexing intervals of the Doppler multiplexing transmissions in first radar section 10 and the Doppler multiplexing intervals of the Doppler multiplexing transmissions in second radar section 10.

For example, Doppler shifters 101 may set the Doppler shift amount corresponding to each transmission antenna 102 using the Doppler multiplexing interval set as described above, and apply the phase rotation for applying the Doppler shift amount to the chirp signal at each chirp transmission period.

For example, nth Doppler shifter 101 of qth radar section 10 applies, to the mth chirp signal as input, phase rotation Φ_{n,q}(m) for applying Doppler shift amount DOPₙ(q) different for each nth transmission antenna 102, and outputs the resultant signal. As a result, different Doppler shifts are applied to the transmission signals transmitted respectively from multiple transmission antennas 102.

Here, n is an integer of from 1 to Nt(q), m is an integer of from 1 to N_{c}, and q is 1 or 2.

For example, phase rotations Φ_{n,q}(m) for applying Doppler shift amounts DOPₙ(q) for Doppler shift intervals Δfd(q) to the radar transmission signals transmitted from Nt(q) (e.g., Nt(q)=N_{DM}(q)) transmission antennas 102 are expressed by following Expression 5. Expression 6 represents Doppler shift amounts DOPₙ(q) for Doppler shift intervals Δfd(q).

$$\begin{matrix}( Expression 5 ) & \\ {ϕ}_{n , q} ( m ) = \{ 2 π {T}_{r} \times {DOP}_{n} ( q ) + Δ {ϕ}_{0} \} ( m - 1 ) + {ϕ}_{0} = \{ 2 π {T}_{r} \times Δ {f}_{d} ( q ) ( n - α ) + Δ {ϕ}_{0} \} ( m - 1 ) + {ϕ}_{0} . & ( 5 )\end{matrix}$$

$$\begin{matrix}( Expression 6 ) & \\ {DOP}_{n} ( q ) = Δ {f}_{d} ( q ) ( n - α ) . & ( 6 )\end{matrix}$$

In the expression, Φ₀ is the initial phase and ΔΦ₀ is a reference Doppler shift phase. Note that α is a coefficient for offsetting the Doppler shift amount for each Doppler multiplexed signal and a real value may be used for the coefficient. For example, when α=1, the Doppler shift amount for the first Doppler multiplexed signal is zero.

For example, when Nt(1)=Nt(2)=3, ΔΦ₀=0, Φ₀=0, δ₁=1, and δ₂=2, the Doppler multiplexing intervals are set to Δfd(1)=1/(4Tᵣ) and Δfd(2)=1/(5Tᵣ). Further, for example, when α=1, Doppler shift amount DOPₙ(q) corresponding to nth transmission antenna 102 is expressed by following Expression 7:

$$\begin{matrix}( Expression 7 ) & \\ {DOP}_{n} ( q ) = Δ {f}_{d} ( q ) ( n - 1 ) . & ( 7 )\end{matrix}$$

Further, for example, phase rotations Φ_{n,q}(m) for applying Doppler shift amounts DOPₙ(q) different for nth (n=1, 2, 3) transmission antennas 102 to the mth chirp signal as input are expressed by following Expression 8:

$$\begin{matrix}( Expression 8 ) & \\ {ϕ}_{1 , 1} ( m ) = 0 , {ϕ}_{2 , 1} ( m ) = \frac{π}{2} ( m - 1 ) , {ϕ}_{3 , 1} ( m ) = π ( m - 1 ) , & ( 8 )\end{matrix}$$

$${ϕ}_{1 , 2} ( m ) = 0 , {ϕ}_{2 , 2} ( m ) = \frac{2 π}{5} ( m - 1 ) , {ϕ}_{3 , 2} ( m ) = \frac{4 π}{5} ( m - 1 ) .$$

For example, when first radar section 10 performs Doppler multiplexing transmission using number Nt of transmission antennas=3, first Doppler shifter 101 in first radar section 10 applies phase rotation Φ_{1,1}(m) to the chirp signal inputted from synchronization controller 20 for each transmission period Tᵣ as shown in following Expression 9. The output of first Doppler shifter 101 is output from, for example, first transmission antenna 102 (Tx #1). Here, cp(t) denotes the chirp signal for each transmission period.

$$\begin{matrix}( Expression 9 ) & \\ exp \{ j {ϕ}_{1 , 1} ( 1 ) \} c p ( t ) , exp \{ j {ϕ}_{1 , 1} ( 2 ) \} c p ( t ) , … , exp \{ j {ϕ}_{1 , 1} ( {N}_{c} ) \} c p ( t ) & ( 9 )\end{matrix}$$

Further, as illustrated in following Expression 10, for example, second Doppler shifter 101 in first radar section 10 applies, for each transmission period Tᵣ, phase rotation Φ_{2,1}(m) to the chirp signal inputted from synchronization controller 20. The output of second Doppler shifter 101 is output from, for example, second transmission antenna 102 (Tx #2).

$$\begin{matrix}( Expression 10 ) & \\ exp \{ j {ϕ}_{2 , 1} ( 1 ) \} c p ( t ) , exp \{ j {ϕ}_{2 , 1} ( 2 ) \} c p ( t ) , … , exp \{ j {ϕ}_{2 , 1} ( {N}_{c} ) \} c p ( t ) . & ( 10 )\end{matrix}$$

Similarly, for example, as illustrated in following Expression 11, third Doppler shifter 101 in first radar section 10 applies, for each transmission period Tᵣ, phase rotation Φ_{3,1}(m) to the chirp signal inputted from synchronization controller 20. The output of third Doppler shifter 101 is output from, for example, third transmission antenna 102 (Tx #3).

$$\begin{matrix}( Expression 11 ) & \\ exp \{ j {ϕ}_{3 , 1} ( 1 ) \} c p ( t ) , exp \{ j {ϕ}_{3 , 1} ( 2 ) \} c p ( t ) , … , exp \{ j {ϕ}_{3 , 1} ( {N}_{c} ) \} c p ( t ) & ( 11 )\end{matrix}$$

Further, for example, when second radar section 10 performs Doppler multiplexing transmission using number Nt of transmission antennas=3, first Doppler shifter 101 in second radar section 10 applies, for each transmission period Tᵣ, phase rotation Φ_{1,2}(m) to the chirp signal inputted from synchronization controller 20, as illustrated in following Expression 12. The output of first Doppler shifter 101 is output from, for example, first transmission antenna 102 (Tx #1). Here, cp(t) denotes the chirp signal for each transmission period.

$$\begin{matrix}( Expression 12 ) & \\ exp \{ j {ϕ}_{1 , 2} ( 1 ) \} c p ( t ) , exp \{ j {ϕ}_{1 , 2} ( 2 ) \} c p ( t ) , … , exp \{ j {ϕ}_{1 , 2} ( {N}_{c} ) \} c p ( t ) & ( 12 )\end{matrix}$$

Further, for example, second Doppler shifter 101 in second radar section 10 applies phase rotation Φ_{2,2}(m) to the chirp signal inputted from synchronization controller 20, as illustrated in following Expression 13, for each transmission period Tᵣ. The output of second Doppler shifter 101 is output from, for example, second transmission antenna 102 (Tx #2).

$$\begin{matrix}( Expression 13 ) & \\ exp \{ j {ϕ}_{2 , 2} ( 1 ) \} c p ( t ) , exp \{ j {ϕ}_{2 , 2} ( 2 ) \} c p ( t ) , … , exp \{ j {ϕ}_{2 , 2} ( {N}_{c} ) \} c p ( t ) & ( 13 )\end{matrix}$$

Similarly, for example, third Doppler shifter 101 in second radar section 10 applies phase rotation Φ_{3,2}(m) to the chirp signal inputted from synchronization controller 20 for each transmission period Tᵣ as illustrated in following Expression 14. The output of third Doppler shifter 101 is output from, for example, third transmission antenna 102 (Tx #3).

$$\begin{matrix}( Expression 14 ) & \\ exp \{ j {ϕ}_{3 , 2} ( 1 ) \} c p ( t ) , exp \{ j {ϕ}_{3 , 2} ( 2 ) \} c p ( t ) , … , exp \{ j {ϕ}_{3 , 2} ( {N}_{c} ) \} c p ( t ) & ( 14 )\end{matrix}$$

The example of setting the doppler shift amounts has been described above.

Next, an exemplary operation of first CFAR section 210, second CFAR section 210, first Doppler demultiplexer 211, and second Doppler demultiplexer 211 in qth radar section 10 corresponding to the operation of Doppler shifters 101 described above will be described.

### [Exemplary Operation of First CFAR Section 210]

For example, in order to receive the reflected wave signals for the radar transmission signals from radar transmitter 100 of qth radar section 10, first CFAR section 210 of qth radar section 10 may perform the following operation.

For example, when δ₁ and δ₂ are set to values that differ from positive integers for Doppler shifters 101, first CFAR section 210 may perform peak detection by, for example, searching, in the power addition values outputted from Doppler analyzers 209 of first to Na(q)th signal processors 206, for a power peak that matches the Doppler shift intervals set for the radar transmission signals of qth radar section 10 for each distance index, and performing adaptive threshold processing (CFAR processing).

On the other hand, for example, when δ₁ and δ₂ are set to positive integers for Doppler shifters 101, an interval of Δfd(q) or an interval of an integer multiple of Δfd(q) is used as an interval of the Doppler shift amounts. Here, q may be 1 or 2. Therefore, Doppler multiplexed signals can be detected as aliasing at an interval of Δfd(q) in the Doppler frequency domain of the outputs of Doppler analyzers 209. By using such characteristics, for example, the operation of first CFAR section 210 can be simplified as follows.

For example, first CFAR section 210 of qth radar section 10 detects a Doppler peak by applying a threshold to a power addition value obtained by adding together the reception powers of the reflected wave signals for respective ranges (for example, ranges of Δfd(q)) within the Doppler frequency range that is outputted from Doppler analyzers 209 and subjected to the CFAR processing, the ranges corresponding to the intervals of the Doppler shift amounts applied respectively to the radar transmission signals.

For example, first CFAR section 210 performs the CFAR processing on the outputs from Doppler analyzers 209 of first to Na(q)th signal processors 206 by calculating power addition value PowerDDM_{q}(f_{b}, f_{sddm}) obtained by adding power values Power_{q}FT(f_{b}, fₛ) at the intervals of Δfd(q) (for example, corresponding to N_{Δfd(q)}) as illustrated in following Expressions 15 and 16:

$$\begin{matrix}( Expression 15 ) & \\ P o w e r D D {M}_{q} ( {f}_{b} , {f}_{s d d m} ) = {\sum }_{ndm = 1}^{{N}_{DM} ( q ) + {δ}_{q}} P o w e r F {T}_{q} ( {f}_{b} , {f}_{s d d m} + ( n d m - 1 ) \times {N}_{Δ {f}_{d} ( q )} ) ; and & ( 15 )\end{matrix}$$

$$\begin{matrix}( Expression 16 ) & \\ Powe r F {T}_{q} ( {f}_{b} , {f}_{s} ) = {\sum }_{z = 1}^{{N}_{a}} {\vert {VFT}_{z , q} ( {f}_{b} , {f}_{s} ) \vert}^{2} . & ( 16 )\end{matrix}$$

In the expressions, f_{sddm}=−N_{c}/2, . . . , and −N_{c}/2+N_{Δfd(q)}−1 and N_{Δfd(q)}=round (Δfd(q)/(1/(TᵣN_{c}). In addition, round(x) is an operator that rounds off real number x and outputs an integer value.

The operation in the CFAR processing may be based on the operation disclosed in NPL 3, for example, and detailed explanation of the exemplary operation is omitted.

Accordingly, the range of the Doppler frequencies subjected to the CFAR processing in first CFAR section 210 can be set (for example, reduced) to 1/(Nt(q)+δ_{q})=1/(N_{DM}(q)+δ_{q}) of the entire range (for example, the range of from —N_{c}/2 to N_{c}/2−1). It is thus possible to reduce the computational amount of the CFAR processing.

For example, first CFAR section 210 adaptively sets a threshold, and outputs, to first Doppler demultiplexer 211, distance indices f_{b_cfar}, Doppler frequency indices f_{sddm_cfar}, and the reception power information (PowerFT(f_{b_cfar}, f_{sddm_cfar}+(ndm−1)×N_{Δfd(q)})) that provide reception power greater than the threshold. In the expression, ndm is an integer of from 1 to N_{DM}(q)+δ_{q}.

### [Exemplary Operation of First Doppler Demultiplexer 211]

First Doppler demultiplexer 211 performs the following operations, for example, based on distance indices f_{b_cfar}, Doppler frequency indices f_{sddm_cfar}, and the reception power information (PowerFT(f_{b_cfar}, f_{sddm_cfar}+(ndm−1)×N_{Δfd(q)})) (ndm is an integer of from 1 to N_{DM}(q)+δ_{q})) inputted from first CFAR section 210.

<(1) Case of δ_{q}=0>

For example, assuming that the Doppler velocity of the target object is −1/(2Tᵣ×N_{DM}(q))≤f_{d}<1/(2Tᵣ×N_{DM}(q)), first Doppler demultiplexer 211 associates the Doppler shift amounts of the Doppler multiplexed signals to be transmitted with f_{sddm_cfar}+(ndm−1)×N_{Δfd(q)}, and outputs, to first direction estimator 212, the resulting demultiplexing index information (for example, f_{demul_Tx#1}(q), . . . , and f_{demul_Tx#NDM}(q)) of the Doppler multiplexed signals.

Here, f_{demul_Tx#n}(q) indicates the Doppler frequency index of the reflected wave signal for the radar transmission signal transmitted from nth transmission antenna 102 (Tx #n) of qth radar section 10.

By way of example, a Doppler shift setting example illustrated in FIG. 7 in which N_{DM}(1)=Nt(1)=3 and N_{DM}(2)=Nt(2)=4 will be described. In this case, Δfd(1)=1/(3Tᵣ) and Δfd(2)=1/(4Tᵣ).

Here, it may be assumed that the Doppler frequencies of the reflected wave signals for the radar transmission signals transmitted from first radar section 10, which are received by first radar section 10, are −1/(2Tᵣ×N_{DM}(1))≤f_{d}<1/(2Tᵣ×N_{DM}(1)). Therefore, in FIG. 7, the demultiplexing index information (f_{demul_Tx#1}(1), f_{demul_Tx#2}(1), and f_{demul_Tx#3}(1)) of the Doppler multiplexed signals for f_{sddm_cfar}+(ndm−1)×N_{Δfd(1)} has a correspondence relation of f_{demul_Tx#3}(1)<f_{demul_Tx#1}(1)<f_{demul_Tx#2}(1). First Doppler demultiplexer 211 may, for example, output each of f_{sddm_cfar}+(ndm−1)×N_{Δfd(1)} (ndm is an integer of from 1 to 3) as f_{demul_Tx#3}(1), f_{demul_Tx#1}(1), and f_{demul_Tx#2}(1).

Similarly, it may be assumed that the Doppler frequencies of the reflected wave signals for the radar transmission signals transmitted from second radar section 10 and received by second radar section 10 are −1/(2Tᵣ×N_{DM}(2))≤f_{d}<1/(2Tᵣ×N_{DM}(2)). Therefore, in FIG. 7, the demultiplexing index information (f_{demul_Tx#1}(2), f_{demul_Tx#2}(2), f_{demul_Tx#3}(2), and f_{demul_Tx#4}(2)) of the Doppler multiplexed signals for f_{sddm_cfar}+(ndm−1)×N_{Δfd(2)} has a correspondence relation of f_{demul_Tx#3}(2)<f_{demul_Tx#4}(2)<f_{demul_Tx#1}(2)<f_{demul_Tx#2}(2) when 0≤f_{d}<1/(2Tᵣ×N_{DM}(1)). In this case, first Doppler demultiplexer 211 may, for example, output each of f_{sddm_cfar}+(ndm−1)×N_{Δfd(2)} (ndm is an integer of from 1 to 4) as f_{demul_Tx#3}(2), f_{demul_Tx#4}(2), f_{demul_Tx#1}(2) and f_{demul_Tx#2}(2). In addition, in FIG. 7, the demultiplexing index information (f_{demul_Tx#1}(2), f_{demul_Tx#2}(2), f_{demul_Tx#3}(2), and f_{demul_Tx#4}(2)) of the Doppler multiplexed signals for f_{sddm_cfar}+(ndm−1)×N_{Δfd(2)} has a correspondence relation of f_{demul_Tx#4}(2)<f_{demul_Tx#1}(2)<f_{demul_Tx#2}(2)<f_{demul_Tx#3}(2) when −1/(2Tᵣ×N_{DM}(1))≤f_{d}<0). Here, first Doppler demultiplexer 211 may, for example, output each of f_{sddm_cfar}+(ndm−1)×N_{Δfd(2)} (ndm is an integer of from 1 to 4) as f_{demul_Tx#4}(2), f_{demul_Tx#1}(2), f_{demul_Tx#2}(2), and f_{demul_Tx#3}(2).

When a difference between the powers for N_{DM}(q) Doppler frequency indices is larger than a predetermined value (for example, a threshold), first Doppler demultiplexer 211 may regard (or determine) that the components of the reception signal for the multistatic configuration are highly likely to be mixed, and may add an operation of removing a reception signal without outputting the reception signal to subsequent processing (for example, direction estimation processing).

<(2) Case of δ_{q}>0>

For example, it may be assumed that the Doppler velocity of the target object is −1/(2Tᵣ)≤f_{d}<1/(2Tᵣ). Further, a large difference between, on one hand, the reception levels for top N_{DM}(q) Doppler frequency indices of reception power and, on the other hand, the reception levels for δ_{q} Doppler frequency indices different from the top N_{DM} Doppler frequency indices of reception power (for example, the difference being equal to or greater than the threshold) may be used. For example, first Doppler demultiplexer 211 compares the reception power information inputted from first CFAR section 210 and determines the Doppler frequency in the range of −1/(2Tᵣ)≤f_{d}<1/(2Tᵣ). Note that an exemplary operation of first Doppler demultiplexer 211 is disclosed in, for example, PTL 1, and therefore description of the exemplary operation is omitted here.

For example, first Doppler demultiplexer 211 associates the Doppler shift amounts of the transmitted Doppler multiplexed signals with f_{sddm_cfar}+(ndm−1)×N_{Δfd(q)} based on the relation between δ_{q} Doppler frequency indices of a lower reception level and top N_{DM} Doppler frequency indices of a higher reception power, and performs an output to first direction estimator 212 as demultiplexing index information (f_{demul_Tx#1}(q), . . . , and f_{demul_Tx#NDM}(q)) of the Doppler multiplexed signals.

Here, f_{demul_Tx#n}(q) indicates the Doppler frequency index of the reflected wave signal for the radar transmission signal transmitted from nth transmission antenna 102 (Tx #n) of qth radar section 10.

By way of example, FIG. 14 illustrates an example of an output (for example, a reception Doppler frequency) of Doppler analyzer 209 in a case where a reflected wave signal with respect to a radar transmission signal from first radar section 10 is received. In FIG. 14, the vertical axis represents the distance axis, and the horizontal axis represents the Doppler frequency axis.

For example, when the Doppler components corresponding to interval Δfd(1) or the Doppler components corresponding to an integer multiple of interval Δfd(1) are observed at distance index fb1 illustrated in FIG. 14, first Doppler demultiplexer 211 can distinguish (for example, detect) that these Doppler components are reflected wave signals for radar transmission signals transmitted from first radar section 10.

Further, for example, in FIG. 14, δ_{q} (=1) Doppler frequency index for a lower reception level is indicated by mark “o,” and top N_{DM} (=2) Doppler frequency indices of reception power are indicated by marks “x” and “Δ.” For example, since the Doppler components (mark “o” in FIG. 14) that do not match the interval of Δfd(1) are uniquely determined in the range of −1/(2Tᵣ)≤f_{d}<1/(2Tᵣ), first Doppler demultiplexer 211 can uniquely determine the Doppler velocity of the target object in the range of −1/(2Tᵣ)≤f_{d}<1/(2Tᵣ).

Further, first Doppler demultiplexer 211 can determine the association between the Doppler frequencies and transmission antennas 102, for example, based on the magnitude relationship between the Doppler frequency indices (mark “o” in FIG. 14) that do not match the interval of Δfd(1) and other Doppler frequency indices (mark “x” in FIG. 14) that match the interval of Δfd(1).

By way of example, a description will be given in which at distance index fb1 of FIG. 14, N_{DM}(1)=Nt(1)=2, a radar transmission signal is transmitted by assigning Tx #1 to the Doppler frequency (mark “x” in FIG. 14) higher by Δfd(1) than the Doppler frequency index (mark “o” in FIG. 14), and a radar transmission signal is transmitted by assigning Tx #2 to the Doppler frequency (mark “Δ” in FIG. 14) lower by Δfd(1) than the Doppler frequency index (mark “o” in FIG. 14).

In this case, at distance index fb1 of FIG. 14, first Doppler demultiplexer 211, for example, detects δ_{q} (=1) Doppler frequency index for a lower reception level (“o” in FIG. 14), and can thus determine that the Doppler frequency (mark “x” in FIG. 14) higher by Δfd(1) than the detected Doppler frequency corresponds to Tx #1 and the Doppler frequency (mark “Δ” in FIG. 14) lower by Δfd(1) than the detected Doppler frequency corresponds to Tx #2.

Further, it is, for example, assumed that at distance index fb2 of FIG. 14, the same assignment of the Doppler multiplexed signals as at distance index fb1 is performed. In this case, for example, as is seen at distance index fb2 of FIG. 14, there may be a case where δ_{q} (=1) Doppler frequency index for a lower reception level (“o” in FIG. 14) is lower by Δfd(1) than top N_{DM} (=2) Doppler frequency indices of reception power. In this case, the Doppler frequency range that can be observed by Doppler analyzers 209 is a range of −1/(2Tᵣ)≤f_{d}<1/(2Tᵣ), and the Doppler frequency (mark “Δ” in FIG. 14) that is lower by Δfd(1) than δ_{q} (=1) Doppler frequency index (mark “o” in FIG. 14) for a lower reception level can be observed with aliasing on the higher-frequency side. Since first Doppler demultiplexer 211 can assume the occurrence of such aliasing in advance, first Doppler demultiplexer 211 can, for example, detect δ_{q} (=1) Doppler frequency index (mark “o” in FIG. 14) for a lower reception level, and can thus determine that the Doppler frequency (mark “x” in FIG. 14) higher by Δfd(1) than the detected Doppler frequency for the lower reception level corresponds to Tx #1 and the Doppler frequency (mark “Δ” in FIG. 14) even higher by Δfd(1) than the detected Doppler frequency for the lower reception level corresponds to Tx #2.

Likewise, it is, for example, assumed that also at distance index fb3 of FIG. 14, the same assignment of the Doppler multiplexed signals as at distance index fb1 is performed. In this case, for example, as is seen at distance index fb3 of FIG. 14, there may be a case where δ_{q} (=1) Doppler frequency index for a lower reception level (“o” in FIG. 14) is higher by Δfd(1) than top N_{DM} (=2) Doppler frequency indices of reception power. In this case, the Doppler frequency range that can be observed by Doppler analyzers 209 is a range of −1/(2Tᵣ)≤f_{d}<1/(2Tᵣ), and the Doppler frequency (mark “x” in FIG. 14) that is higher by Δfd(1) than δ_{q} (=1) Doppler frequency index (mark “o” in FIG. 14) for the lower reception level can be observed with aliasing on the lower-frequency side. Since first Doppler demultiplexer 211 can assume the occurrence of such aliasing in advance, first Doppler demultiplexer 211 can determine that, for example, the Doppler frequency (mark “Δ” in FIG. 14) lower by Δfd(1) than δ_{q} (=1) Doppler frequency index (mark “o” in FIG. 14) for the lower reception level corresponds to Tx #2 and the Doppler frequency (mark “x” in FIG. 14) even lower by Δfd(1) than the detected Doppler frequency for the lower reception level corresponds to Tx #1.

When the difference between the powers for top N_{DM}(q) Doppler frequency indices of reception power is larger than a predetermined value (threshold), first Doppler demultiplexer 211 may regard (or determine) that signals of the reception signals of the multistatic configuration are highly likely to be mixed, and may add an operation of removing the reception signals without performing an output for subsequent processing (for example, direction estimation processing).

The exemplary operation of first Doppler demultiplexer 211 has been described above.

### [Exemplary Operation of Second CFAR Section 210]

For example, second CFAR section 210 of qth radar section 10 may perform the following operations in order to receive the reflected wave signal for the radar transmission signal from radar transmitter 100 of radar section 10 that differs from qth radar section 10.

For example, when δ₁ and δ₂ are set to values that differ from positive integers for Doppler shifters 101, second CFAR section 210 may perform peak detection by, for example, searching, in the power addition values outputted from Doppler analyzers 209 of first to Na(q)th signal processors 206, for a power peak that matches the Doppler shift interval set for the radar transmission signal of radar section 10 different from qth radar section 10 for each distance index, and performing adaptive threshold processing (CFAR processing).

On the other hand, for example, when δ₁ and δ₂ are set to positive integers for Doppler shifters 101, an interval of Δfd(q) or an interval of an integer multiple of Δfd(q) is used as an interval of the Doppler shift amounts. In this case, q may be 1 or 2. Therefore, Doppler multiplexed signals can be detected as aliasing at an interval of Δfd(q) in the Doppler frequency domain of the outputs of Doppler analyzers 209. By using such characteristics, for example, the operation of second CFAR section 210 can be simplified as follows.

For example, second CFAR section 210 of qth radar section 10 detects a Doppler peak by applying a threshold to a power addition value obtained by adding together the reception powers of the reflected wave signals for respective ranges (for example, ranges of Δfd(qe)) within the Doppler frequency range that is outputted from Doppler analyzers 209 and subjected to the CFAR processing, the ranges corresponding to the intervals of the Doppler shift amounts applied respectively to the radar transmission signals.

Here, “qe” represents a radar number of radar section 10 that differs from qth radar section 10. For example, “qe” may be 2 in the case of first radar section 10 (q=1), or “qe” may be 1 in the case of second radar section 10 (q=2).

For example, second CFAR section 210 performs the CFAR processing on the outputs from Doppler analyzers 209 of first to Na(q)th signal processors 206 by calculating power addition value PowerDDM_{qe}(f_{b}, f_{sddm}) obtained by adding power values Power_{q}FT(f_{b}, fₛ) at the intervals of Δfd(qe) (for example, corresponding to N_{Δfd(qe)}) as illustrated in following Expression 17:

$$\begin{matrix}( Expression 17 ) & \\ P o w e r D D {M}_{q e} ( {f}_{b} , {f}_{s d d m} ) = {\sum }_{n d m = 1}^{{N}_{D M} ( q e ) + {δ}_{q e}} P o w e r F {T}_{q} ( {f}_{b} , {f}_{s d d m} + ( n d m - 1 ) \times {N}_{Δ {f}_{d} ( q e )} ) . & ( 17 )\end{matrix}$$

In the expressions, f_{sddm}=−N_{c}/2, . . . , and −N_{c}/2+N_{Δfd(qe)}−1 and N_{Δfd(qe)}=round(Δfd(qe)/(1/(TᵣN_{c}). In addition, round(x) is an operator that rounds off real number x and outputs an integer value.

The operation in the CFAR processing may be based on the operation disclosed in NPL 3, for example, and detailed explanation of the exemplary operation is omitted.

Thus, the Doppler frequency range on which the CFAR processing is performed in second CFAR section 210 can be set (e.g., reduced) to 1/(Nt(qe)+δ_{qe})=1/(N_{DM}(qe)+δ_{qe} of the entire range (e.g., the range of −N_{c}/2 to N_{c}/2−1), thereby reducing the computational amount of the CFAR processing.

For example, second CFAR section 210 adaptively sets a threshold, and outputs, to second Doppler demultiplexer 211, distance indices f_{b_cfar}, Doppler frequency indices f_{sddm_cfar}, and the reception power information (PowerFT(f_{b_cfar}, f_{sddm_cfar}+(ndm−1)×N_{Δfd(qe)})) that provide reception power greater than the threshold. Here, ndm is an integer of from 1 to N_{DM}(qe)+δ_{qe}.

### [Exemplary Operation of Second Doppler Demultiplexer 211]

Second Doppler demultiplexer 211 performs the following operations based on, for example, distance indices f_{b_cfar}, Doppler frequency indices f_{sddm_cfar}, and the reception power information (PowerFT(f_{b_cfar}, f_{sdm_cfar}+(ndm−1)×N_{Δfd(qe)})) (ndm is an integer of from 1 to N_{DM}(qe)+δ_{qe})) inputted from second CFAR section 210.

<(1) Case of δ_{qe}=0>

For example, assuming that the Doppler velocity of the target object is −1/(2Tᵣ×N_{DM}(qe))≤f_{d}<1/(2Tᵣ×N_{DM}(qe)), second Doppler demultiplexer 211 associates the Doppler shift amounts of the Doppler multiplexed signals to be transmitted with f_{sddm_cfar}+(ndm−1)×N_{Δfd(qe)}, and outputs, to second direction estimator 212, the resulting demultiplexing index information (for example, f_{demul_Tx#1}(qe), . . . , and f_{demul_Tx#NDM}(qe)) of the Doppler multiplexed signals.

Here, f_{demul_Tx#n}(qe) indicates the Doppler frequency index of the reflected wave signal for the radar transmission signal transmitted from nth transmission antenna 102 (Tx #n) of qeth radar section 10.

By way of example, a Doppler shift setting example illustrated in FIG. 7 in which N_{DM}(1)=Nt(1)=3 and N_{DM}(2)=Nt(2)=4 will be described. In this case, Δfd(1)=1/(3Tᵣ) and Δfd(2)=1/(4Tᵣ).

Here, it may be assumed that the Doppler frequencies of the reflected wave signals for the radar transmission signals transmitted from second radar section 10, which are received by first radar section 10, are −1/(2Tᵣ×N_{DM}(2))≤f_{d}<1/(2Tᵣ×N_{DM}(2)). Therefore, in FIG. 7, the demultiplexing index information (f_{demul_Tx#1}(2), f_{demul_Tx#2}(2), f_{demul_Tx#3}(2), and f_{demul_Tx#4}(2)) of the Doppler multiplexed signals for f_{sddm_cfar}+(ndm−1)×N_{Δfd(2)} has a correspondence relation of f_{demul_Tx#3}(2)<f_{demul_Tx#4}(2)<f_{demul_Tx#1}(2)<f_{demul_Tx#2}(2) when 0≤f_{d}<1/(2Tᵣ×N_{DM}(1)). In this case, second Doppler demultiplexer 211 may, for example, output each of f_{sddm_cfar}+(ndm−1)×N_{Δfd(2)} (ndm is an integer of from 1 to 4) as f_{demul_Tx#3}(2), f_{demul_Tx#4}(2), f_{demul_Tx#1}(2) and f_{demul_Tx#2}(2). In addition, in FIG. 7, the demultiplexing index information (f_{demul_Tx#1}(2), f_{demul_Tx#2}(2), f_{demul_Tx#3}(2), and f_{demul_Tx#4}(2)) of the Doppler multiplexed signals for f_{sddm_cfar}+(ndm−1)×N_{Δfd(2)} has a correspondence relation of f_{demul_Tx#4}(2)<f_{demul_Tx#1}(2)<f_{demul_Tx#2}(2)<f_{demul_Tx#3}(2) when −1/(2Tᵣ×N_{DM}(1))≤f_{d}<0). In this case, second Doppler demultiplexer 211 may, for example, output each of f_{sddm_cfar}+(ndm−1)×N_{Δfd(2)} (ndm is an integer of from 1 to 4) as f_{demul_Tx#3}(2), f_{demul_Tx#4}(2), f_{demul_Tx#1}(2) and f_{demul_Tx#2}(2).

Similarly, it may be assumed that the Doppler frequency of the radar reflected wave for the radar transmission signal transmitted from first radar section 10 received by second radar section 10 is −1/(2Tᵣ×N_{DM}(1))≤f_{d}<1/(2Tᵣ×N_{DM}(1)). Therefore, in FIG. 7, the demultiplexing index information (f_{demul_Tx#1}(1), f_{demul_Tx#2}(1), and f_{demul_Tx#3}(1)) of the Doppler multiplexed signals for f_{sddm_cfar}+(ndm−1)×N_{Δfd(1)} has a correspondence relation of f_{demul_Tx#3}(1)<f_{demul_Tx#1}(1)<f_{demul_Tx#2}(1). Second Doppler demultiplexer 211 may, for example, output each of f_{sddm_cfar}+(ndm−1)×N_{Δfd(1)} (ndm is an integer of from 1 to 3) as f_{demul_Tx#3}(1), f_{demul_Tx#1}(1), and f_{demul_Tx#2}(1).

When a difference between the powers for N_{DM}(qe) Doppler frequency indices is larger than a predetermined value (for example, a threshold), second Doppler demultiplexer 211 may regard (or determine) that the reception signals for the monostatic configuration are highly likely to be mixed, and may add an operation of removing a reception signal without outputting the reception signal to subsequent processing (for example, direction estimation processing).

<(2) Case of δ_{qe}>0>

For example, it may be assumed that the Doppler velocity of the target object is −1/(2Tᵣ)≤f_{d}<1/(2Tᵣ). Further, a large difference between, on one hand, the reception levels for top N_{DM}(qe) Doppler frequency indices of reception power and, on the other hand, the reception levels of δ_{qe} Doppler frequency indices different from the top N_{DM} Doppler frequency indices of reception power (for example, the difference being equal to or greater than the threshold) may be used. For example, second Doppler demultiplexer 211 compares the reception power information inputted from second CFAR section 210 and determines the Doppler frequency in the range of −1/(2Tᵣ)≤f_{d}<1/(2Tᵣ). Note that an exemplary operation of second Doppler demultiplexer 211 is disclosed in, for example, PTL 1, and therefore description of the exemplary operation is omitted here.

When the difference between the powers of N_{DM}(qe) Doppler frequency indices for the higher reception powers is larger than a predetermined value (threshold), second Doppler demultiplexer 211 may regard (or determine) that components of the reception signals of the monostatic configuration are highly likely to be mixed, and may add an operation of removing the reception signals without performing an output for subsequent processing (for example, direction estimation processing).

The exemplary operation of second Doppler demultiplexer 211 has been described above.

Next, an exemplary operation of first direction estimator 212 and second direction estimator 212 illustrated in FIG. 3 will be described.

### [Exemplary Operation of First Direction Estimator 212]

First direction estimator 212 of qth radar section 10 performs direction estimation processing on the target object based on, for example, the information inputted from first Doppler demultiplexer 211 (for example, distance indices f_{b_cfar}(q) and the demultiplexing index information (f_{demul_Tx#1}(q), f_{demul_Tx#2}(q), . . . , and f_{demul_Tx#Nt}(q)) on the Doppler multiplexed signal).

For example, first direction estimator 212 performs the direction estimation processing by extracting the outputs of Doppler analyzer 209 based on distance indices f_{b_cfar}(q) and the demultiplexing index information (f_{demul_Tx#1}(q), f_{demul_Tx#2}(q), . . . , and f_{demul_Tx#Nt}(q)) on the Doppler multiplexed signals, and generating qth virtual reception array correlation vector h_{q}(f_{b_cfar}(q), f_{demul_Tx#1}(q), f_{demul_Tx#2}(q), . . . , and f_{demul_Tx#Nt}(q)) of first direction estimator 212 as illustrated in following Expression 18. Here, for example, q=1, 2.

The qth virtual reception array correlation vector h_{q}(f_{b_cfar}(q), f_{demul_Tx#1}(q), f_{demul_Tx#2}(q), . . . , and f_{demul_Tx#Nt}(q)) of the first direction estimator includes Nt(q)×Na(q) elements that are the product of number Nt(q) of transmission antennas and number Na(q) of reception antennas as illustrated in Expression 18. The qth virtual reception array correlation vectors h_{q}(f_{b_cfar}(q), f_{demul_Tx#1}(q), f_{demul_Tx#2}(q), . . . , and f_{demul_Tx#Nt}(q)) are used in a process of performing direction estimation on the reflected wave signals from the target based on phase differences between respective reception antennas 202. Here, z is an integer of from 1 to Na(q).

$$\begin{matrix}[ Expression 18 ) & \\ {h}_{q} ( {f}_{b \_ cfar} ( q ) , {f}_{demul \_ Tx \#2} ( q ) , … , , {d}_{demul \_ Tx {\#N}_{t}} ( q ) ) = [ \begin{matrix}{h}_{ca l [ 1 ]} {VFT}_{1} ( {f}_{b \_ cfar} ( q ) , {f}_{demul \_ Tx \#1} ( q ) ) \\ {h}_{ca l [ 2 ]} {VFT}_{2} ( {f}_{b \_ cfar} ( q ) , {f}_{demul \_ Tx \#1} ( q ) ) \\ ⋮ \\ {h}_{ca l [ {N}_{a} ( q ) ]} {VFT}_{{N}_{a} ( q )} ( {f}_{b \_ cfar} ( q ) , {f}_{demul \_ Tx \#1} ( q ) ) \\ {h}_{ca l [ {N}_{a} ( q ) + 1 ]} {VFT}_{1} ( {f}_{b \_ cfar} ( q ) , {f}_{demul \_ Tx \#2} ( q ) ) \\ {h}_{ca l [ {N}_{a} ( q ) + 2 ]} {VFT}_{2} ( {f}_{b \_ cfar} ( q ) , {f}_{demul \_ Tx \#2} ( q ) ) \\ ⋮ \\ {h}_{ca l [ 2 {N}_{a} ( q ) ]} {VFT}_{{N}_{a} ( q )} ( {f}_{b \_ cfar} ( q ) , {f}_{demul \_ Tx \#2} ( q ) ) \\ ⋮ \\ {h}_{ca l [ {N}_{a} ( q ) ( {N}_{t} ( q ) - 1 ) + 1 ]} {VFT}_{1} ( {f}_{b \_ cfar} ( q ) , {f}_{demul \_ Tx \#N t} ( q ) ) \\ {h}_{ca l [ {N}_{a} ( q ) ( {N}_{t} ( q ) - 1 ) + 2 ]} {VFT}_{2} ( {f}_{b \_ cfar} ( q ) , {f}_{demul \_ Tx \#N t} ( q ) ) \\ ⋮ \\ {h}_{ca l [ {N}_{a} ( q ) {N}_{t} ( q ) ]} {VFT}_{{N}_{a} ( q )} ( {f}_{b \_ cfar} ( q ) , {f}_{demul \_ Tx \#Nt} ( q ) )\end{matrix} ] & ( 18 )\end{matrix}$$

In Expression 18, h_{cal[b]} is an array correction value for correcting a phase deviation and an amplitude deviation between transmission array antennas and reception array antennas. The character “b” is an integer of from 1 to (Nt(q)×Na(q)).

First direction estimator 212 of qth radar section 10 calculates a spatial profile by, for example, changing azimuth direction θᵤ in direction estimation evaluation function values P_{H}(θᵤ, f_{b_cfar}(q), f_{demul_Tx#1}(q) to f_{demul_Tx#Nt}(q)) within a predetermined angular range. First direction estimator 212 may extract a predetermined number of maximum peaks of the calculated spatial profile in descending order, and output the azimuth directions of the maximum peaks to positioning output integrator 30 as direction-of-arrival estimation values (for example, positioning outputs).

Note that, there are various methods with direction estimation evaluation function values P_{H}(θᵤ, f_{b_cfar}(q), f_{demul_Tx#1}(q), . . . , and f_{demul_Tx#Nt}(q)) depending on direction-of-arrival estimation algorithms. For example, an estimation method using an array antenna disclosed in NPL 4 may be used.

For example, when Nt(q)×Na(q) virtual reception arrays are arranged linearly at equal intervals d_{H}, a beamformer method can be expressed as following Expression 19. In addition to the beamformer method, techniques such as Capon, MUSIC, and the like are also applicable. In Expression 19, superscript H denotes the Hermitian transpose operator.

$$\begin{matrix}( Expression 19 ) & \\ {P}_{H} ( {θ}_{u} , {f}_{b \_ cfar} ( q ) , {f}_{demul \_ Tx \#1} ( q ) , … , {f}_{demaul \_ Tx {\#N}_{t} ( q )} ( q ) , ) = {a}_{q}^{H} ( {θ}_{u} ) {h}_{q} ( {f}_{b \_ cfar} ( q ) , {f}_{demul \_ Tx \#1} ( q ) , {f}_{demul \_ Tx \#2} ( q ) , … , , {f}_{demul \_ Tx \# {N}_{t} ( q )} ( q ) ) . & ( 19 )\end{matrix}$$

In Expression 19, a_{q}(θᵤ) represents direction vectors of the virtual reception arrays to an incoming wave in azimuth direction θᵤ at center frequency f_{c} of the radar transmission signal, and is expressed by Expression (20). In Expression 20, λ is the wavelength of the radar transmission signal (e.g., chirp signal) for center frequency f_{c}, and λ=C₀/f_{c}.

$$\begin{matrix}( Expression 20 ) & \\ {a}_{q} ( {θ}_{u} ) = [ \begin{matrix}1 \\ exp ( - j 2 π {d}_{H} sin {θ}_{u} / λ ) \\ ⋮ \\ exp ( - j 2 π ( {N}_{t} ( q ) - 1 ) {d}_{H} sin {θ}_{u} / λ )\end{matrix} ] & ( 20 )\end{matrix}$$

Azimuth direction θᵤ is a vector that is changed at predetermined azimuth interval β₁ in an azimuth range over which direction-of-arrival estimation is performed. For example, θᵤ may be set as follows.

θᵤ=θₘᵢₙ+uβ₁, where integer u is 0 to NU

$$NU = floor [ ( θ max - θmin ) / {β}_{1} ] + 1$$

Here, floor(x) is a function that returns the largest integer value not greater than real number x.

Further, regarding the above-described example, the description has been given of the example in which first direction estimator 212 calculates the azimuth direction as the direction-of-arrival estimation value, but the present disclosure is not limited thereto, and a direction-of-arrival estimation in the elevation direction or a direction-of-arrival estimation in the azimuth direction and the elevation direction can also be performed by using MIMO antennas arranged in a rectangular grid pattern. For example, first direction estimator 212 may calculate the azimuth direction and the elevation direction as the direction-of-arrival estimation values and use them as the positioning outputs.

Through the above-described operations, first direction estimator 212 of qth radar section 10 may output, for example, as the positioning outputs, the direction-of-arrival estimation values for distance indices f_{b_cfar}(q) and the demultiplexing index information (f_{demul_Tx#1}(q), f_{demul_Tx#2}(q), . . . , and f_{demul_Tx#Nt}(q)) of the Doppler multiplexed signals. Further, first direction estimator 212 may further output distance indices f_{b_cfar}(q) and the demultiplexing index information (f_{demul_Tx#1}(q), f_{demul_Tx#2}(q), . . . , and f_{demul_Tx#Nt}(q)) of the Doppler multiplexed signal as the positioning outputs.

Further, distance indices f_{b_cfar}(q) may be outputted after converted into distance information by using Expression 1.

The exemplary operation of first direction estimator 212 has been described above.

### [Exemplary Operation of Second Direction Estimator 212]

Second direction estimator 212 of qth radar section 10 performs direction estimation processing on the target object based on, for example, the information inputted from second Doppler demultiplexer 211 (for example, distance indices f_{b_cfar}(qe) and the demultiplexing index information (f_{demul_Tx#1}(qe), f_{demul_Tx#2}(qe), . . . , and f_{demul_Tx#Nt}(qe)) on the Doppler multiplexed signals.

For example, second direction estimator 212 extracts the outputs of Doppler analyzers 209 based on distance indices f_{b_cfar}(qe) and the demultiplexing index information (f_{demul_Tx#1}(qe), f_{demul_Tx#2}(qe), . . . , and f_{demul_Tx#Nt}(qe)) of the Doppler multiplexed signal, generates qeth virtual reception array correlation matrix H_{qe}(f_{b_cfar}(qe), f_{demul_Tx#1}(qe), f_{demul_Tx#2}(qe), . . . , and f_{demul_Tx#Nt}(qe) of second direction estimator 212 as illustrated in following Expression 21, and performs the direction estimation processing. Here, for example, qe=1, 2.

The qeth virtual reception array correlation matrix H_{qe}(f_{b_cfar}(qe), f_{demul_Tx#1}(qe), f_{demul_Tx#2}(qe), . . . , and f_{demul_Tx#Nt}(qe)) of second direction estimator 212 is an Nt(qe)×Na(q)−order matrix consisting of columns of number Nt(qe) of transmission antennas and rows of number Na(q) of reception antennas as illustrated in Expression 21. The qeth virtual reception array correlation matrix H_{qe}(f_{b_cfar}(qe), f_{demul_Tx#1}(qe), f_{demul_Tx#2}(qe), . . . , and f_{demul_Tx#Nt}(qe)) is used in description of processing for performing direction estimation on the reflected wave signals from the target based on a phase difference between reception antennas 202. Here, integer z=1 to Na(qe).

$$\begin{matrix}( Expression 21 ) & \\ {H}_{qe} ( {f}_{b \_ cfar} ( qe ) , {f}_{demul \_ Tx \#1} ( qe ) , {f}_{demul \_ Tx \#2} ( qe ) , … , {f}_{demul \_ Tx {\#N}_{t}} ( qe ) ) = [ \begin{matrix}{h}_{ca l [ 1 ]} {VFT}_{1} ( {f}_{b \_ cfar} ( qe ) , {f}_{demul \_ Tx \#1} ( qe ) ) {h}_{ca l [ {N}_{a} ( q ) + 1 ]} {VFT}_{1} ( {f}_{b \_ cfar} ( qe ) , {f}_{demul \_ Tx \#2} ( qe ) ) … {h}_{ca l [ {N}_{a} ( q ) ( Nt ( qe ) - 1 ) + 1 ]} {VFT}_{1} ( {f}_{b \_ cfar} ( qe ) , {f}_{demul \_ Tx \# Nt} ( qe ) ) \\ {h}_{ca l [ 2 ]} {VFT}_{2} ( {f}_{b \_ cfar} ( qe ) , {f}_{demul \_ Tx \#1} ( qe ) ) {h}_{ca l [ {N}_{a} ( q ) + 2 ]} {VFT}_{2} ( {f}_{b \_ cfar} ( qe ) , {f}_{demul \_ Tx \#2} ( qe ) ) … {h}_{ca l [ {N}_{a} ( q ) ( Nt ( qe ) - 1 ) + 2 ]} {VFT}_{2} ( {f}_{b \_ cfar} ( qe ) , {f}_{demul \_ Tx \# Nt} ( qe ) ) \\ ⋮ \\ {h}_{ca l [ {N}_{a} ( q ) ]} {VFT}_{Na ( qe )} ( {f}_{b \_ cfar} ( qe ) , {f}_{demul \_ Tx \#1} ( qe ) {h}_{ca l [ 2 {N}_{a} ( q ) ]} {VFT}_{Na ( qe )} ( {f}_{b \_ cfar} ( qe ) , {f}_{demul \_ Tx \#2} ( qe ) ) … {h}_{ca l [ {N}_{a} ( q ) ( Nt ( qe ) ]} {VFT}_{Na ( q )} ( {f}_{b \_ cfar} ( qe ) , {f}_{demul \_ Tx \# Nt} ( qe ) )\end{matrix} ] & ( 21 )\end{matrix}$$

In Expression 21, h_{cal[b]} is an array correction value for correcting a phase deviation and an amplitude deviation between transmission array antennas and reception array antennas. The character “b” is an integer of from 1 to (Nt(qe)×Na(q)).

Second direction estimator 212 of qth radar section 10 calculates a spatial profile by, for example, changing azimuth direction θᵤ in direction estimation evaluation function values P_{T×H}(θᵤ, f_{b_cfar}(qe), f_{demul_Tx#1}(qe) to f_{demul_Tx#Nt}(qe)) of the transmission direction within a predetermined angular range. Second direction estimator 212 may extract a predetermined number of maximum peak directions of the calculated spatial profile in descending order, and output the transmission azimuth directions of the maximum peaks to positioning output integrator 30 as direction estimation values (for example, positioning outputs).

Note that, there are various methods with direction estimation evaluation function values P_{T×H}(θᵤ, f_{b_cfar}(qe), f_{demul_Tx#1}(qe), . . . , and f_{demul_Tx#Nt}(qe)) depending on direction estimation algorithms. For example, an estimation method using an array antenna disclosed in NPL 4 may be used. For example, the beamformer method can be expressed as following Expression 22. In addition to the beamformer method, techniques such as Capon, MUSIC, and the like are also applicable. In Expression 19, superscript H denotes the Hermitian transpose operator.

$$\begin{matrix}( 22 ) & \\ {P}_{TxH} ( {θ}_{u} , {f}_{b\_cfar} ( qe ) , {f}_{demaul\_Tx \#1} ( qe ) … , {f}_{demaul \_ Tx \# {N}_{t}} ( qe ) ) = {a}_{Tx ( qe )}^{N} ( {θ}_{u} ) {H}_{qe}^{H} {H}_{qe} {a}_{Tx ( qe )} ( {θ}_{u} ) . & ( Expression 22 )\end{matrix}$$

In Expression 22, a_{Tx(qe)}(θᵤ) represents a transmission array direction vector of the transmission antenna in qeth radar section 10 to an incoming wave in azimuth direction θᵤ at center frequency f_{c}.

Further, for the direction-of-arrival estimation, second direction estimator 212 of qth radar section 10 calculates a spatial profile by, for example, changing azi muth direction θ_{Rx} in direction estimation evaluation function values P_{R×H}(θᵤ, f_{b_cfar}(qe), f_{demul_Tx#1}(qe) to f_{demul_Tx#Nt}(qe)) of the reception direction within a predetermined angular range. Second direction estimator 212 may extract a predetermined number of maximum peak directions of the calculated spatial profile in descending order, and output the reception azimuth directions of the maximum peaks to positioning output integrator 30 as direction estimation values (for example, positioning outputs).

Note that, there are various methods with direction estimation evaluation function values P_{R×H}(θᵤ, f_{b_cfar}(qe), f_{demul_Tx#1}(qe), . . . , and f_{demul_Tx#Nt}(qe)) depending on direction estimation algorithms. For example, an estimation method using an array antenna disclosed in NPL 4 may be used. For example, the beamformer method can be expressed as following Expression 23. In addition to the beamformer method, techniques such as Capon, MUSIC, and the like are also applicable. In Expression 19, superscript H denotes the Hermitian transpose operator.

$$\begin{matrix}( 23 ) & \\ {P}_{TxH} ( {θ}_{u} , {f}_{b\_cfar} ( qe ) , {f}_{demaul\_Tx \#1} ( qe ) … , {f}_{demaul \_ Tx \# {N}_{t}} ( qe ) ) = {a}_{Tx ( qe )}^{N} ( {θ}_{u} ) {H}_{qe}^{H} {H}_{qe} {a}_{Tx ( qe )} ( {θ}_{u} ) & ( Expression 23 )\end{matrix}$$

In Expression 23, a_{Rx(q)}(θᵤ) represents a reception array direction vector of the reception antenna in qth radar section 10 to an incoming wave in azimuth direction θᵤ at center frequency f_{c}.

Azimuth direction θᵤ is a vector that is changed at predetermined azimuth interval β₁ in an azimuth range over which the direction estimation is performed. For example, θᵤ may be set as follows.

θᵤ=θₘᵢₙ+uβ₁, where integer u=0 to NU

$$NU = floor [ ( θ max - θ min ) / {β}_{1} ] + 1$$

Here, floor(x) is a function that returns the largest integer value not greater than real number x.

Further, regarding the above-described example, the description has been given of the example in which second direction estimator 212 calculates the azimuth direction as the direction estimation value, but the present disclosure is not limited thereto, and a direction estimation in the elevation direction or a direction estimation in the azimuth direction and the elevation direction can also be performed by using MIMO antennas arranged in a rectangular grid pattern. For example, second direction estimator 212 may calculate the azimuth direction and the elevation direction as the direction estimation values and use them as the positioning outputs.

Through the above-described operations, second direction estimator 212 of qth radar section 10 may output, for example, as the positioning outputs, the transmission azimuth direction estimation values and reception azimuth direction estimation values for distance indices f_{b_cfar}(qe) and the demultiplexing index information (f_{demul_Tx#1}(qe), f_{demul_Tx#2}(qe), . . . , and f_{demul_Tx#Nt}(qe)) of the Doppler multiplexed signals. Further, second direction estimator 212 may further output distance indices f_{b_cfar}(qe) and the demultiplexing index information (f_{demul_Tx#1}(qe), f_{demul_Tx#2}(qe), . . . , and f_{demul_Tx#Nt}(qe)) of the Doppler multiplexed signal as the positioning outputs.

Further, distance indices f_{b_cfar}(qe) may be outputted after converted into distance information by using Expression 2.

Here, the positions of first radar section 10 and second radar section 10 are known to radar apparatus 1 in advance. For example, when the positions of first radar section 10 and second radar section 10 are regarded as forcal points, the target object may be present on an elliptic curve which gives, by the sum of the distances from two focal points, a distance for the multistatic configuration as indicated by distance indices f_{b_cfar}(qe) outputted from second direction estimator 212.

Further, since the transmission azimuth direction of qeth radar section 10 and the reception azimuth direction of qth radar section 10 are estimated, second direction estimator 212 can determine the target-object position using a result of angle measurement. Second direction estimator 212 may output, for example, the estimation result of the target-object position in the radar having such a multistatic configuration. A method for estimating a target-object position in a radar having a multistatic configuration is described in, for example, NPL 5. Thus, a detailed description of the estimation method will be omitted.

The exemplary operation of second direction estimator 212 has been described above.

In FIG. 2, positioning output integrator 30 integrates the positioning outputs of first direction estimator 212 and second direction estimator 212 from first radar section 10 and the positioning outputs of first direction estimator 212 and second direction estimator 212 from second radar section 10, and performs positioning of the target object.

For example, positioning output integrator 30 may determine the type of the target object based on correspondence between a positioning result of second direction estimator 212 of first radar section 10 and a positioning result of second direction estimator 212 of second radar section 10, which are the positioning results of the multistatic configuration. For example, positioning output integrator 30 may utilize the tendency that the correspondence is high for poles (metal poles) and the correspondence of a reflection point is low for target objects having a large horizontal dimension, such as a wall.

Further, for example, in a case where the detection areas overlap between the positioning outputs of first direction estimator 212 of first radar section 10 and the positioning outputs of first direction estimator 212 of second radar section 10, which are the positioning results of the monostatic configuration, positioning output integrator 30 may output components of high correspondence between both estimation results. For example, positioning output integrator 30 may not output components of low correspondence between both of the estimation results. In this case, positioning output integrator 30 can remove multipath reflection or the like that becomes a virtual image.

Note that positioning output integrator 30 may output the positioning output (or the positioning result) to, for example, a control apparatus (ECU or the like) of the vehicle in the case of an in-vehicle radar, or to an infrastructure control apparatus in the case of an infrastructure radar, which are not illustrated.

As described above, in the present embodiment, radar apparatus 1 includes first radar section 10 that transmits radar transmission signals from a plurality of transmission antennas 102, and second radar section 10 that transmits radar transmission signals from a plurality of transmission antennas 102. Here, the Doppler multiplexing interval between the Doppler shift amounts applied respectively to the radar transmission signals transmitted from the plurality of transmission antennas 102 of first radar section 10 is different from the Doppler multiplexing interval between the Doppler shift amounts applied respectively to the radar transmission signals transmitted from the plurality of transmission antennas 102 of second radar section 10.

Accordingly, radar apparatus 1 can demultiplex the reflected wave signals corresponding to the radar transmission signals of radar sections 10 from the reception signals, for example, based on the Doppler multiplexing intervals set in radar sections 10. Therefore, radar apparatus 1 can simultaneously perform the radar positioning by the monostatic configuration of each of first radar section 10 and second radar section 10, and in addition the radar positioning by the multistatic configuration from first radar section 10 to second radar section 10 and the multistatic configuration from second radar section 10 to first radar section 10. In addition, radar apparatus 1 can shorten the radar positioning time as compared with the multistatic time-division transmission.

Further, in the present embodiment, Doppler multiplexing is used in the monostatic configuration and the multistatic configuration. Thus, radar apparatus 1 does not need to perform code separation processing, and thus the amount of demultiplexing operations can be reduced as compared with inter-multistatic code multiplexing transmission. Further, radar apparatus 1 does not use the inter-multistatic code multiplexing transmission. Thus, even a reflected wave from a target object having a relative speed does not cause inter-code interference.

Further, for example, radar apparatus 1 can expand the observable Doppler range (for example, can set the observable Doppler range to +1/(2Tᵣ)) by performing Doppler aliasing determination using unequal-interval Doppler multiplexing, and can suppress reduction of the maximum Doppler observable by the inter-multistatic multiplexing transmission. For example, radar apparatus 1 can maintain the same observation range as the maximum Doppler in a case where a single transmission antenna is used.

Further, for example, when radar apparatus 1 is applied to a radar that performs vehicle periphery monitoring, the use of the multistatic configuration can be used even when the observable area of each radar section 10 does not overlap completely. Accordingly, an effect of reducing the number of radars (the number of radar sections 10) in radar apparatus 1 can be expected. In addition, the multistatic configuration allows radar apparatus 1 to utilize reflection at different angles. Thus, for example, the performance of detecting a planar object such as a wall can be improved.

Further, in radar apparatus 1, the radar having the multistatic configuration can observe a Doppler component of even a moving object in the cross-range direction for a radar having the monostatic configuration. Thus, detection of the moving object is facilitated.

In addition, in radar apparatus 1, the number of chirp signals that are a common signal between a plurality of radar sections 10 may be one, and the present disclosure can be realized by a smaller number of chirp signals than in the case of the inter-multistatic frequency-division transmission. It is thus possible to reduce the system cost.

### Variation 1 of Embodiment 1

In Embodiment 1 (for example, FIG. 3), a chirp signal (an output signal of VCO 303) is output from synchronization controller 20, but the present disclosure is not limited thereto. FIG. 15 is a block diagram illustrating an exemplary configuration of radar apparatus 1a according to Variation 1 of Embodiment 1. In radar apparatus 1a, synchronization controller 20a may output a low-frequency reference signal in reference signal generator 401 and output information on the timing of transmission period Tᵣ in signal controller 402.

Each of a plurality of radar sections 10a (for example, first radar section 10a and second radar section 10a) individually includes synchronization controller 103 including radar transmission signal generator 301 (for example, including modulation signal generator 302 and VCO 303). Each of the plurality of radar sections 10a may generate a chirp signal using the reference signal input from synchronization controller 20a, for example, based on the information on the timing of transmission period Tᵣ input from synchronization controller 20a.

In the configuration illustrated in FIG. 15, for example, there is a possibility that the phase between first radar section 10a and second radar section 10a changes like a drift. Therefore, a drift component of the phase may be corrected in advance in radar apparatus 1a.

In general, an expensive cable which focuses on a low loss property is used for a transmission line for the high-frequency signal, and thus, the system cost is likely to increase. Contrastingly, the configuration according to Variation 1 of Embodiment 1 as illustrated in FIG. 15 makes the low-frequency reference signal less than or equal to about 100 MHz. It is thus not necessary to use the cable which focuses on the low loss property. Accordingly, the system cost can be reduced and radar apparatus 1a can be realized with a simpler configuration.

Further, in the configuration illustrated in FIG. 15, signal controller 402 may synchronously output the timing of transmission period Tᵣ such that the transmission period is the same between first radar section 10a and second radar section 10a, but the present disclosure is not limited thereto. For example, signal controller 402 may control the timing of transmission period Tᵣ so as to shift the transmission period by Δt between first radar section 10a and second radar section 10a. For example, the transmission timing of the radar transmission signal in first radar section 10a may be different from the transmission timing of the radar transmission signal in second radar section 10a.

The shift of the transmission timing between radar section 10a may affect the distance measurement in a multistatic configuration. However, for example, shift amount Δt of the transmission timing is known to radar apparatus 1a, and radar apparatus 1a can thus maintain the accuracy of the distance measurement by correcting a distance measurement value.

In addition, for example, signal controller 402 may vary shift amount Δt of the transmission period per predetermined time, for example, per radar positioning (per N_{c} transmission measurement times for each transmission period Tᵣ). For example, when a Doppler component of a reflected wave in the monostatic configuration and a Doppler component of a reflected wave in the multistatic configuration, which are present at the same distance component from radar apparatus 1a, partially match each other, it is difficult for radar apparatus 1a to properly demultiplex them from each other, and there is a possibility that the target object is undetected. On the other hand, since shift amount Δt of the transmission period is set to be variable, the transmission timings between the multistatic configurations are periodically shifted and the distances thereof are shifted, radar apparatus 1a can prevent continuous non-detection of the target object and reduce the likelihood that the target object is undetected.

Note that the configuration of Variation 1 can be similarly applied to the following embodiments or variations, and the same effects can be obtained.

### Variation 2 of Embodiment 1

FIG. 16 is a block diagram illustrating an exemplary configuration of radar apparatus 1b according to Variation 2 of Embodiment 1.

In Variation 2 of Embodiment 1, for example, radar transmitter 100a includes Doppler multiplexing controller 104 in addition to the configuration of radar transmitter 100 (FIG. 3).

For example, Doppler multiplexing controller 104 may variably set the Doppler multiplexing interval between the multistatic configurations per predetermined time, for example, per radar positioning (per N_{c} transmission measurement times for each transmission period Tᵣ). For example, at least one of the Doppler multiplexing intervals set for each of the plurality of radar sections 10b of radar apparatus 1b may be variably set.

For example, when a Doppler component of a reflected wave in the monostatic configuration and a Doppler component of a reflected wave in the multistatic configuration, which are present at the same distance from radar apparatus 1b, partially match each other, it is difficult for radar apparatus 1b to properly demultiplex them from each other, and there is a possibility that the target object is undetected.

On the other hand, Doppler multiplexing controller 104 shifts the Doppler multiplexing intervals between the multistatic configurations periodically (for example, per radar positioning), thereby shifting the Doppler components (for example, the distance components). Therefore, in radar apparatus 1b, it is possible to prevent continuous non-detection of the target object, and to reduce the likelihood that the target object is undetected.

Note that the configuration of Variation 2 can be similarly applied to the preceding or succeeding embodiments or variations, for example, and the same effects can be obtained.

### Variation 3 of Embodiment 1

The description has been given of Embodiment 1 having the configuration and operation in which the radar having the monostatic configuration and the radar having the multistatic configuration perform simultaneous multiplexing to perform positioning. A description will be given of Variation 3 of Embodiment 1 having a configuration in which, for example, a plurality of radars having the monostatic configuration perform simultaneous multiplexing to perform positioning.

FIG. 17 is a block diagram illustrating an exemplary configuration of radar apparatus 1c according to Variation 3 of Embodiment 1.

Radar apparatus 1c illustrated in FIG. 17 has a configuration in which, as compared with Embodiment 1 (FIG. 3), second CFAR section 210, second Doppler demultiplexer 211, and second direction estimator 212 corresponding to the multistatic configuration are excluded from radar receiver 200c of radar section 10c.

For example, first radar section 10c may remove a reflected wave signal corresponding to a radar transmission signal transmitted from second radar section 10c, based on a Doppler multiplexing interval set for first radar section 10c and a Doppler multiplexing interval set for second radar section 10c, and perform the direction estimation processing using the reflected wave signal corresponding to the radar transmission signal transmitted from first radar section 10c. Similarly, second radar section 10c may remove the reflected wave signal corresponding to the radar transmission signal transmitted from first radar section 10c, based on the Doppler multiplexing interval set for first radar section 10c and the Doppler multiplexing interval set for second radar section 10c, and perform the direction estimation processing using the reflected wave signal corresponding to the radar transmission signal transmitted from second radar section 10c.

According to the configuration of radar apparatus 1c, for example, a plurality of radar sections 10c having the monostatic configuration that uses radar transmission waves (for example, chirp signals) in the same frequency band may be disposed close to each other. For example, even when the reflected wave signal for the radar transmission signal of first radar section 10c is inputted in second radar section 10c, second radar section 10c is able to demultiplex and not receive such a reflected wave signal by using different Doppler multiplexing intervals between neighboring radar sections 10c. Thus, an interference-canceling effect can be obtained. Similarly, for example, even when the reflected wave signal for the radar transmission signal of second radar section 10c is inputted in first radar section 10c, first radar section 10c is able to demultiplex and not receive such a reflected wave signal.

The configuration of Variation 3 can be similarly applied to, for example, the previous or subsequent embodiments or variations, and the same effects can be obtained.

### Variation 4 of Embodiment 1

In Variation 4 of Embodiment 1, for example, the multiplexing transmission method may be switched between the multiplexing transmission method of Embodiment 1 (for example, multiplexing transmission based on the Doppler shift amount) and the other multiplexing methods.

For example, radar apparatus 1 may perform multiplexing transmission by temporally or periodically switching between the multistatic time-division transmission and the multiplexing transmission method of Embodiment 1.

In such a transmission method, the multiplexing transmission of Embodiment 1 is applied to some radar positioning. Thus, for example, the positioning time can be reduced as compared with a case where the inter-multistatic time-division transmission is applied to every radar positioning.

Further, in addition to the effects according to Embodiment 1, Variation 4 achieves a more preferable ratio of the desired signal (for example, the power of the transmission signal from first radar section 10) to the interference power (for example, the power of the transmission signal from second radar section 10) since simultaneous multiplexing is not performed in the inter-multistatic time-division transmission. As described above, erroneous detection can be reduced by temporally switching the multiplexing transmission methods of the plurality of radar sections 10 (for example, every positioning period).

The configuration of Variation 4 can be similarly applied to, for example, the previous or subsequent embodiments or variations, and the same effects can be obtained.

### Variation 5 of Embodiment 1

In Variation 5 of Embodiment 1, synchronization controller 20 may be included in any one of the plurality of radar sections 10 (for example, first radar section 10 and second radar section 10). Even in this case, the same effects as those of Embodiment 1 can be obtained.

FIG. 18 is a block diagram illustrating an exemplary configuration of radar apparatus 1d according to Variation 5 of Embodiment 1. In FIG. 18, synchronization controller 20 is included in a housing of first radar section 10d. Synchronization controller 20 may supply an output signal not only to radar transmitter 100 in first radar section 10 but also to second radar section 10d outside first radar section 10d.

Note that the present disclosure is not limited to the example illustrated in FIG. 18, and for example, synchronization controller 20 may be included in a housing of second radar section 10d, and the output signal of synchronization controller 20 may be supplied to first radar section 10d outside second radar section 10d (not illustrated).

The configuration of Variation 5 can be similarly applied to, for example, the previous or subsequent embodiments or variations, and the same effects can be obtained.

### Variation 6 of Embodiment 1

The description has been given of Embodiment 1 in which each of the plurality of radar sections 10 (for example, first radar section 10 and second radar section 10) has the monostatic configuration, but the present disclosure is not limited thereto. For example, at least one of the plurality of radar sections 10 may be a radar having the multistatic configuration (or bi-static configuration).

For example, each of the plurality of radar sections 10 may have a configuration in which radar transmitter 100 and radar receiver 200 are included in the same housing (for example, the monostatic configuration), or a configuration in which radar transmitter 100 and radar receiver 200 are included in respective different housings (for example, the multistatic configuration (or bi-static configuration)). Radar section 10 may have the multistatic configuration including, for example, a plurality of radar transmitters 100 and at least one radar receiver 200 (not illustrated).

FIG. 19 is a block diagram illustrating an exemplary configuration of radar apparatus 1e according to Variation 6, as an example.

In the example illustrated in FIG. 19, both first radar section 10e and second radar section 10e do not have the monostatic configuration, but are radars having the bi-static configuration. For example, in each of first radar section 10e and second radar section 10e, radar transmitter 100 and radar receiver 200 may be disposed at distances apart from each other. In this case, a signal from synchronization controller 20 may be inputted to each of radar transmitter 100 and radar receiver 200 of first radar section 10e. Similarly, a signal from synchronization controller 20 may be inputted to each of radar transmitter 100 and radar receiver 200 of second radar section 10e.

Regarding the operations of first radar section 10e and second radar section 10e in the configuration as illustrated in FIG. 19, the operation of first direction estimator 212 (not illustrated in FIG. 19) is different, and the operations of the other components may be the same, for example. For example, the direction estimation operation of first direction estimator 212 of radar receiver 200 in first radar section 10e or second radar section 10e is an operation of a radar having the multistatic configuration, and may thus be the same operation as the direction estimation operation described for second direction estimator 212. Further, for example, Expression 2, which is a conversion equation for the multistatic configuration, may be used for converting beat frequency index f_{b} (or the distance index) into distance information R(f_{b}) in a positioning output of first direction estimator 212.

The configuration of Variation 6 can be similarly applied to, for example, the previous or subsequent embodiments or variations, and the same effects can be obtained.

### Variation 7 of Embodiment 1

The description given of Embodiment 1 is of the configuration and operation of simultaneous multiplexing transmission of the radar having the monostatic configuration and the multistatic configuration that uses the two radar sections of first radar section 10 and second radar section 10. Here, the number of radar sections included in radar apparatus 1 (or the number of radar sections used for radar positioning) is not limited to two, and a larger number (three or more) of radar sections may be used. By increasing the number of simultaneous multiplexing, the effect of reducing the measurement time is further enhanced. Further, for example, positioning output integrator 30 can improve detection accuracy or reduce erroneous detection by using the positioning results of a larger number of radar sections.

By way of example, radar apparatus 1f illustrated in FIG. 20 includes three radar sections 10f. Hereinafter, operations different from those of Embodiment 1 will be described.

In FIG. 20, first to Nt(q)th Doppler shifters 101 (not illustrated in FIG. 20) of qth radar section 10f perform Doppler multiplexing transmission of the chirp signals inputted from synchronization controller 20 by applying different Doppler shift amounts DOPₙ(q) to the chirp signals based on predetermined Doppler multiplexing intervals Δfd(q).

Further, for example, the Doppler multiplexing intervals between the plurality of radar sections 10f (in FIG. 20, between first radar section 10f, second radar section 10f, and third radar section 10f) may be set to different intervals (for example, Δfd(1)≠Δfd(2)≠Δfd(3)).

Further, for example, the ratio between Δfd(1) and Δfd(2) may be set so as not to match an integer. For example, Δfd(1)/Δfd(2) or Δfd(2)/Δfd(1) may be set so as not to match an integer.

Further, for example, the ratio between Δfd(2) and Δfd(3) may be set so as not to match an integer. For example, Δfd(2)/Δfd(3) or Δfd(3)/Δfd(2) may be set so as not to match an integer.

Similarly, for example, the ratio between Δfd(3) and Δfd(1) may be set so as not to match an integer. For example, Δfd(3)/Δfd(1) or Δfd(1)/Δfd(3) may be set so as not to match an integer.

In addition, in FIG. 20, radar receiver 200f of qth radar section 10f may include, as CFAR sections 210, third CFAR section 210 in addition to first CFAR section 210 and second CFAR section 210 (not illustrated in FIG. 20).

For example, each of second and third CFAR sections 210 of qth radar section 10f performs the CFAR processing by extracting reflected waves matching the Doppler multiplexing intervals for any one of the other two radar sections 10f forming the multistatic radar.

For example, in first radar section 10f, first CFAR section 210 performs the CFAR processing by extract a reflected wave matching Doppler multiplexing intervals Δfd(1) for first radar section 10f. Second CFAR section 210 performs the CFAR processing by extracting a reflected wave that matches Doppler multiplexing intervals Δfd(2) for second radar section 10f. Third CFAR section 210 performs the CFAR processing by extracting a reflected wave that matches Doppler multiplexing intervals Δfd(3) for third radar section 10f.

Similarly, for example, in second radar section 10f, first CFAR section 210 performs the CFAR processing by extracting a reflected wave that matches Doppler multiplexing intervals Δfd(2) for second radar section 10f. Second CFAR section 210 performs the CFAR processing by extracting a reflected wave that matches Doppler multiplexing intervals Δfd(3) for third radar section 10f. Third CFAR section 210 performs the CFAR processing by extracting a reflected wave that matches Doppler multiplexing intervals Δfd(1) for first radar section 10f.

Similarly, for example, in third radar section 10f, first CFAR section 210 performs the CFAR processing by extracting a reflected wave matching Doppler multiplexing interval Δfd(3) for third radar section 10f. Second CFAR section 210 performs the CFAR processing by extracting a reflected wave that matches Doppler multiplexing intervals Δfd(1) for first radar section 10f. Third CFAR section 210 performs the CFAR processing by extracting a reflected wave that matches Doppler multiplexing interval Δfd(2) for second radar section 10f.

Thereafter, first Doppler demultiplexer 211 of qth radar section 10f demultiplexes and outputs a Doppler multiplexed signal based on an output of first CFAR section 210, second Doppler demultiplexer 211 demultiplexes and outputs a Doppler multiplexed signal based on an output of second CFAR section 210, and third Doppler demultiplexer 211 demultiplexes and outputs a Doppler multiplexed signal based on an output of third CFAR section 210.

Further, first direction estimator 212 of qth radar section 10f performs azimuth estimation based on the output of first Doppler demultiplexer 211 and outputs a positioning result. Second direction estimator 212 performs azimuth estimation based on the output of second Doppler demultiplexer 211 and outputs a positioning result. Third direction estimator 212 performs azimuth estimation based on the output of third Doppler demultiplexer 211 and outputs a positioning result.

Third direction estimator 212 may perform, for example, the direction estimation processing and distance conversion of the distance index using a radar having a multistatic configuration, and output the positioning result.

The configuration of Variation 7 can be similarly applied to, for example, the previous or subsequent embodiments or variations, and the same effects can be obtained.

### Embodiment 2

Embodiment 1 has been described in which the Doppler multiplexing is applied to the transmission multiplexing in the monostatic MIMO radar, but the present disclosure is not limited thereto, and the time division multiplexing may be applied. In the present embodiment, an operation performed in a case where the Doppler multiplexing is applied in a multistatic MIMO radar and time division multiplexing is applied in a monostatic MIMO radar will be described.

FIG. 21 is a block diagram illustrating an exemplary configuration of radar apparatus 1g according to the present embodiment. In FIG. 21, components that perform the same operations as those in FIG. 3 are denoted by the same reference numerals. Hereinafter, operations different from those of Embodiment 1 will be mainly described.

Radar apparatus 1g illustrated in FIG. 21 may include, for example, a plurality of radar sections 10g, synchronization controller 20, and positioning output integrator 30 (not illustrated in FIG. 21). FIG. 21 illustrates an exemplary configuration of one radar section 10g.

In FIG. 21, synchronization controller 20 includes, for example, radar transmission signal generator 301 including modulation signal generator 302 and Voltage-Controlled Oscillator (VCO) 303, and signal controller 304. Radar transmission signal generator 301 generates a radar transmission signal (for example, a predetermined frequency-modulated wave (chirp signal)) based on, for example, control by signal controller 304, and outputs the generated radar transmission signal to a plurality of radar sections 10g (for example, radar transmitters 100g) constituting the multistatic configuration. The chirp signal outputted by synchronization controller 20 is also inputted to radar receiver 200g (each mixer 204). The operation of synchronization controller 20 may be the same as that of Embodiment 1.

In addition, in FIG. 21, each of the plurality of radar sections 10g may perform time-division transmission of radar transmission signals to which different Doppler shift amounts are applied, from a plurality of transmission antennas 102. Each of radar sections 10g may include, for example, radar transmitter 100g and radar receiver 200g. In the present embodiment, for example, the numbers of transmission antennas 102 (or transmission antennas 102 as used) included in each qth radar section 10g may be the same. In the following description, the number of transmission antennas in qth radar section 10g may be referred to as Nt(q) (or simply “Nt”). For example, Nt(1)=Nt(2) and Nt(q)>1.

[Exemplary Configuration of Radar Transmitter 100g]

In FIG. 21, radar transmitter 100g of radar section 10g includes, for example, Doppler shifters 101-1 to 101-Nt, transmission antennas 102-1 to 102-Nt (for example, Tx #1 to Tx #Nt), antenna switching controller 105, and switches (SWs) 106-1 to 106-Nt. For example, radar transmitter 100g includes Nt transmission antennas 102, and transmission antennas 102 are connected to respective switches 106.

To apply Doppler shift amount DOPₙ(q) to the chirp signal inputted from VCO 303, each of Doppler shifters 101 of qth radar section 10g applies phase rotation Φ_{n,q}(m) to the chirp signal for each transmission period Tᵣ of the chirp signal, and outputs the Doppler-shifted signal to switch 106.

For example, qth radar section 10g may perform output while applying predetermined phase rotations Φ_{n,q}(m) for applying Doppler shifts for providing Doppler multiplexing intervals that differ between radar sections 10g that perform multistatic radar multiplexing transmission (an exemplary operation will be described later). Here, n is an integer of from 1 to Nt(q), and q is 1 or 2.

For example, antenna switching controller 105 controls switches 106 to switch transmission antennas 102 in a predetermined order for each transmission period Tᵣ. In addition, antenna switching controller 105 outputs information on the antenna switching control to output switcher 213 of radar receiver 200g.

For example, antenna switching controller 105 may set switch 106 corresponding to first transmission antenna 102 (Tx #1) to ON in the first transmission period, and set switches 106 corresponding to other transmission antennas 102 different from first transmission antenna 102 to OFF.

Further, for example, antenna switching controller 105 may set switch 106 corresponding to second transmission antenna 102 (Tx #2) to ON in the second transmission period, and set switches 106 corresponding to other transmission antennas 102 different from second transmission antenna 102 to OFF.

Antenna switching controller 105 may repeat the control (switching) of these switches 106, set switch 106 corresponding to Nt(q)th transmission antenna 102 (Tx #Nt(q) to ON in the Nt(q)th transmission period, and set switches 106 corresponding to other transmission antennas 102 different from Nt(q)th transmission antenna 102 to OFF.

Further, for example, antenna switching controller 105 may set switch 106 corresponding to first transmission antenna 102 (Tx #1) to ON in a subsequent Nt(q)+1th transmission period, and set switches 106 corresponding to other transmission antennas 102 different from first transmission antenna 102 to OFF.

Antenna switching controller 105 may repeatedly perform the same antenna switching control hereinafter.

Switch 106 (SW) switches the states of ON and OFF based on, for example, control by antenna switching controller 105. Here, when switch 106 is in the ON state, the transmission signal inputted from Doppler shifter 101 is outputted. On the other hand, when switch 106 is in the OFF state, the transmission signal inputted from Doppler shifter 101 is not outputted. Therefore, the output signal of Doppler shifter 101 is amplified to a predetermined transmission power and is emitted into space from corresponding transmission antenna 102 for which switch 106 is switched to the ON state. [Exemplary Configuration of Radar Receiver 200g]

In FIG. 21, radar receiver 200g includes Na reception antennas 202 (for example, Rx #1 to Rx #Na), and serves as a component of an array antenna. Radar receiver 200g includes Na antenna system processors 201, CFAR sections 210, Doppler demultiplexers 211, and direction estimators 212.

Here, the number of reception antennas 202 may be the same or may be different between qth radar sections 10g (for example, q=1 or 2). Hereinafter, the number of reception antennas in qth radar section 10g will be referred to as “Na(q)” (also referred to simply as “Na”). Here, Na(q)≥1.

The operation of reception radio 203 of antenna system processor 201 is the same as that of Embodiment 1, and the description thereof is omitted.

The operations of A/D converter 207 and beat frequency analyzer 208 in signal processor 206g of the antenna system processor 201 are the same as those in Embodiment 1, and the explanation thereof is omitted.

Output switcher 213 performs, for example, an operation associated with the switching operation of switch 106 performed by antenna switching controller 105 based on the control by antenna switching controller 105 of radar transmitter 100g, and selectively switches a destination of an output of beat frequency analyzer 208 to one of Nt(q) Doppler analyzers 209 (for example, also represented by Doppler analyzers 209-1 to 209-Nt(q)) for each transmission period Tᵣ.

For example, when antenna switching controller 105 controls switches 106 so that switch 106 corresponding to first transmission antenna 102 (Tx #1) is set to ON and switches 106 corresponding to other transmission antennas 102 are set to OFF in the first transmission period, output switcher 213 outputs the output signal from beat frequency analyzer 208 to first Doppler analyzer 209 and does not output the output to other Doppler analyzers 209.

Similarly, when antenna switching controller 105 controls switches 106 so that switch 106 corresponding to mth transmission antenna 102 (Tx #n) is set to ON and switches 106 corresponding to other transmission antennas 102 are set to OFF in the nth transmission period, output switcher 213 outputs the output signal from beat frequency analyzer 208 to nth Doppler analyzer 209 and does not output the output to other Doppler analyzers 209. Here, n is an integer of from 1 to Nt(q).

The nth Doppler analyzer 209 (or Doppler analyzer 209-n) of zth signal processor 206g performs Doppler analysis for each distance index f_{b} based on a beat frequency response for the transmission period in which a signal is transmitted from each transmission antenna 102, among beat frequency responses RFT_{z}(f_{b}, 1), RFT_{z}(f_{b}, 2), . . . , and RFT_{z}(f_{b}, N_{C}) obtained by N_{C} chirp pulse transmissions of the chirp signals.

For example, in a case where the time-division transmission in which Nt(q) transmission antennas 102 cyclically switch from first transmission antenna 102 to Nt(q)th transmission antenna 102 for each transmission period Tᵣ is applied under the control of antenna switching controller 105, Doppler analyzer 209 may apply Fast Fourier Transform (FFT) processing as illustrated in following Expression 24, and may output VFT_{n,z,q}(f_{b}, fₛ) as the output of nth Doppler analyzer 209 in zth signal processor 206g. Note that N_{d} is an integer multiple of Nt(q), and may be set to, for example, N_{d}=N_{c}/Nt(q). Note that RFT_{z,q}(f_{b}, m) represents the beat frequency response outputted from beat frequency analyzer 208 in qth radar section 10.

$$\begin{matrix}( Expression 24 ) & \\ V F {T}_{n , z , q} ( {f}_{b} , {f}_{s} ) = {\sum }_{s = 1}^{{N}_{d}} R F {T}_{z , q} ( {f}_{b} , ( s - 1 ) \times {N}_{t} ( q ) + n ) exp [ ‐ \frac{j 2 π ( s - 1 ) {f}_{s}}{{N}_{d}} ] . & ( 24 )\end{matrix}$$

Here, the FFT size is N_{d}, and the maximum Doppler frequency at which no aliasing occurs and which is derived from the sampling theorem is ±1/(2TᵣNt(q)). Further, the Doppler frequency interval of Doppler frequency index fₛ is 1/(N_{d}×TᵣNt(q)), and the range of Doppler frequency index fₛ is fₛ=N_{d}/2, . . . , 0, . . . , and N_{d}/2−1.

By way of example, a description will be given of a case where N_{d} is a power of 2. When N_{d} is not a power of 2, zero-padded data is included, for example, to obtain the data size of a power of 2 and the FFT processing can thus be performed. In the FFT processing, Doppler analyzer 209 may perform multiplication by a window function coefficient such as the Han window or the Hamming window. It is possible to suppress sidelobes generated around the beat frequency peak by applying a window function.

In FIG. 21, for example, first CFAR section 210 selectively extracts local peaks of reflected wave signals for radar transmission signals of qth radar section 10g (corresponding radar), which has the monostatic configuration, using outputs VFT_{n,z,q}(f_{b}, fₛ) of first to Nt(q)th Doppler analyzers 209 of first to Na(q)th signal processors 206g. For example, first CFAR section 210 may perform the CFAR processing of performing the adaptive threshold determination after power addition at intervals matching the Doppler multiplexing intervals set for the radar transmission signals transmitted from qth radar section 10g, extract distance indices f_{b_cfar} and Doppler frequency indices f_{sddm_cfar} that provide local peak signals, and output extracted distance indices f_{b_cfar} and Doppler frequency indices f_{sddm_cfar} to first Doppler demultiplexer 211 (an exemplary operation will be described later).

The radar transmitter having the monostatic configuration in first radar section 10g is radar transmitter 100g of first radar section 10g. Similarly, the radar transmitter having the monostatic configuration in second radar section 10g is radar transmitter 100g of second radar section 10g.

Further, for example, second CFAR section 210 selectively extracts local peaks of radar reflected waves (reception signals) for radar transmission signals of another radar section 10g that differ from qth radar section 10g (corresponding radar), which is the multistatic configuration, using outputs VFT_{n,z,q}(f_{b}, fₛ) of first to Nt(q)th Doppler analyzers 209 of first to Na(q)th signal processors 206g. For example, second CFAR section 210 may perform the CFAR processing of performing the adaptive threshold determination after the power addition at intervals matching the Doppler multiplexing intervals set for the radar transmission signals transmitted from radar section 10g other than qth radar section 10g, extract distance indices f_{b_cfar} and Doppler frequency indices f_{sddm_cfar} that provide local peak signals, and output the extracted distance indices f_{b_cfar} and Doppler frequency indices f_{sddm_cfar} to second Doppler demultiplexer 211 (an exemplary operation will be described later).

The radar transmitter having the multistatic configuration in first radar section 10g is radar transmitter 100g of second radar section 10g. Similarly, the radar transmitter having the multistatic configuration in second radar section 10g is radar transmitter 100g of first radar section 10.

Next, the operation of qth Doppler demultiplexer 211 will be described together with the exemplary operation of Doppler shifters 101 and qth CFAR section 210. For example, q=1 or 2 may hold true.

Doppler demultiplexers 211 of qth radar section 10g may include, for example, first Doppler demultiplexer 211 that performs Doppler demultiplexing on the reflected wave signals for the radar transmission signals from qth radar section 10g (corresponding radar), which has the monostatic configuration, using the outputs of first CFAR section 210 and second Doppler demultiplexer that performs Doppler demultiplexing on the reflected wave signals for the radar transmission signals from another radar section 10g different from qth radar rsection 10g, which has the multistatic configuration, using the outputs of second CFAR section 210.

The operation of qth Doppler demultiplexer 211 is related to the operation of Doppler shifters 101 of radar transmitter 100g. Similarly, the operation of qth CFAR section 210 is related to the operation of Doppler shifters 101 of radar transmitter 100g.

Hereinafter, an exemplary operation of Doppler shifters 101 will be described, and an exemplary operation of qth CFAR section 210 and an exemplary operation of qth Doppler demultiplexer 211 will then be described.

### [Method for Setting Doppler Shift Amount]

To begin with, an example of a method for setting the Doppler shift amount applied in Doppler shifters 101 will be described.

In the present embodiment, by the operation of antenna switching controller 105 and switches 106, a radio wave is transmitted from each of transmission antennas 102 at each period of Nt(q)×Tᵣ. First to Nt(q)th Doppler shifters 101 of qth radar section 10g perform Doppler multiplexing transmission by applying respective different Doppler shift amounts DOPₙ(q) of predetermined Doppler multiplexing intervals Δfd(q) for respective Nt(q) transmission antennas 102 to the chirp signals inputted from synchronization controller 20. At this time, Doppler multiplexing intervals Δfd(q) may satisfy the following setting conditions (1) and (2) as in Embodiment 1.
(1) The Doppler multiplexing intervals between the plurality of radar sections 10g may be set to different intervals. For example, the intervals for respective Doppler shift amounts applied to the radar transmission signals transmitted from the plurality of transmission antennas 102 of first radar section 10g and the intervals for respective Doppler shift amounts applied to the radar transmission signals transmitted from the plurality of transmission antennas 102 of second radar section 10g may be different from each other (for example, Δfd(1)≠Δfd(2)).
(2) For example, the ratio between Δfd(1) and Δfd(2) may be set so as not to match an integer. For example, of Δfd(1) and Δfd(2), the ratio of the Doppler multiplexing interval having the larger value to the Doppler multiplexing interval having the smaller value may be different from the integer. For example, Δfd(1)/Δfd(2) or Δfd(2)/Δfd(1) may be set so as not to match the integer (so as to be different from the integer).

Hereinafter, an example of setting Doppler multiplexing interval Δfd(q) will be described.

In the following, a description is given of a case where the number of Doppler multiplexing of qth radar section 10g is N_{DM}(q)=Nt(q), but the present disclosure is not limited thereto. For example, radar section 10g may bundle some of the plurality of transmission antennas 102 to form a transmission beam for performing Doppler multiplexing transmission. Here, N_{DM}(q)<Nt(q) holds true. Here, m is an integer of from 1 to N_{c}. Further, for example, index n of Doppler shift amount DOPₙ(q) is an integer of n=1 to Nt(q). Also, N_{DM}(q)>1 and q=1 or 2.

For example, by the operation of antenna switching controller 105 and switches 106, radio waves are transmitted from transmission antennas 102 for each of Nt(q)×Tᵣ periods Tᵣ, and Doppler shifters 101 may thus apply predetermined phase rotations (for example, ranging from 0 to 2π) for the chirp signals to Nt(q) transmission antennas 102 for each of Nt(q)×Tᵣ periods.

Here, in Doppler analyzers 209, the range of Doppler frequency f_{d} in which no aliasing is generated and which is derived from the sampling theorem is from −1/(2Tᵣ×N_{DM}(q))≤f_{d}<1/(2Tᵣ×N_{DM}(q)). For example, even when the Doppler frequency exceeds the range of Doppler frequency f_{d} in which no aliasing occurs, the range of Doppler frequency f_{d} observed in Doppler analyzers 209 is −1/(2Tᵣ×N_{DM}(q))≤f_{d}<1/(2Tᵣ×N_{DM}(q)).

Therefore, for example, when Doppler shifters 101 apply Doppler shifts within the range of −1/(2Tᵣ×N_{DM}(q))≤f_{d}<1/(2Tᵣ×N_{DM}(q)), maximum Doppler shift interval Δfdmax with respect to Nt(q) transmission antennas 102 (for example, the number equal to the Doppler multiplexing number) is Δfdmax=1/(TᵣNt(q)Nt(q))=1/(TᵣN_{DM}(q)N_{DM}(q)). For example, Doppler shifters 101 may set Δfd(1) and Δfd(2) to different intervals within the range up to Δfdmax. Accordingly, Doppler shifters 101 can set the Doppler shift within the range of 0 to 2π that is the phase rotation providing the Doppler shift.

For example, the Doppler multiplexing intervals of each of first radar section 10g and second radar section 10g may be set to Δfd(1)=1/(Tᵣ×N_{DM}(1)×(N_{DM}(1)+δ₁)) and Δfd(2)=1/(Tᵣ×N_{DM}(2)×(N_{DM}(2)+δ₂)), respectively.

Here, N_{DM}(1)=N_{DM}(2), and δ₁, δ₂≥0 hold true, and N_{DM}(1)+δ₁+N_{DM}(2)+δ₂ is satisfied (e.g., δ₁≠δ₂). Further, δ₁ and δ₂ may be set so that the ratio between N_{DM}(1)+δ₁ and N_{DM}(2)+δ₂ does not match an integer. With this setting, the Doppler multiplexing interval between the plurality of radar sections 10g (for example, between first radar section 10g and second radar section 10g) is different (Δfd(1) #Δfd(2)), and the ratio between Δfd(1) and Δfd(2) does not match an integer.

Note that each of δ₁ and δ₂ may be a positive integer or a positive real number. For example, by setting δ₁ and δ₂ to be positive integers, the processes in first CFAR section 210 and second CFAR section 210, which will be described later, can be simplified. Descriptions are given below of a case where δ₁ and δ₂ are each set to zero or a positive integer. However, the present disclosure is not limited thereto, and positive real numbers may be set.

In addition, if supposed situations are mostly those in which radar apparatus 1g and the target are both stationary, a configuration may be adopted in which parameters (for example, values such as Doppler multiplexing intervals Δfd(q) or δ_{q}) which, for example, cause the Doppler shift amounts to match each other between first radar section 10g and second radar section 10g are excluded in advance. For example, for all of n₁ and n₂, the parameters may be set to satisfy following Expression 25.

$$\begin{matrix}( Expression 25 ) & \\ {DOP}_{n 1} ( 1 ) \neq {DOP}_{n 2} ( 2 ) , {n}_{1} ∈ \{ 1 , 2 , … Nt ( 1 ) \} , {n}_{2} ∈ \{ 1 , 2 , … Nt ( 2 ) \} . & ( 25 )\end{matrix}$$

By this setting, for example, Doppler shift amount DOPₙ₁(1) applied to the radar transmission signal of first radar section 10g and Doppler shift amount DOPₙ₂(2) applied to the radar transmission signal of second radar section 10g are set to values different from each other.

The parameter setting satisfying Expression 25 may be applied, for example, to situations in which both radar apparatus 1g and the target are supposed to be mostly stationary. For example, when radar apparatus 1g and the target are both stationary, a Doppler component is zero. Therefore, for example, even when the reflected wave signal for the radar transmission signal of first radar section 10g and the reflected wave signal for the radar transmission signal of second radar section 10g are included in the same distance index, Doppler shift amount DOPₙ(q) for each MIMO multiplexed transmission signal is different. Thus, radar apparatus 1g can demultiplex and receive both the reflected wave signals by utilizing the difference in detected Doppler components.

A description is given below of exemplary setting of Doppler shift amounts.

For example, in the case of N_{DM}(1)=N_{DM}(2), Δfd(1)=1/(Tᵣ×N_{DM}(1)×N_{DM}(1)) and Δfd(2)=1/(Tᵣ×N_{DM}(2)×(N_{DM}(2)+1)) may be set, Δfd(1)=1/(Tᵣ×N_{DM}(1)×(N_{DM}(1)+1)) and Δfd(2)=1/(Tᵣ×N_{DM}(2)×N_{DM}(2)) may be set, or Δfd(1)=1/(Tᵣ×N_{DM}(1)×(N_{DM}(1)+1)) and Δfd(2)=1/(Tᵣ×N_{DM}(2)×(N_{DM}(2)+2)) may be set. In this case, the above-described setting conditions of the Doppler multiplexing intervals are satisfied.

In this case, the Doppler intervals can be maximized within the range of −1/(2Tᵣ×N_{DM}(1))≤f_{d}<1/(2Tᵣ×N_{DM}(1)) of Doppler frequencies f_{d} observed by Doppler analyzers 209. Therefore, for example, even in a case where the Doppler spectrum has a spread, such as a case where the moving speed of the target is not constant and has a component such as acceleration, it is possible reduce a determination error in first Doppler demultiplexer 211 or second Doppler demultiplexer 211.

By way of example, FIG. 22 illustrates a setting example of Doppler shifts for first radar section 10g ((a) of FIG. 22) and a setting example of Doppler shifts for second radar section 10g ((b) of FIG. 22) in the case of N_{DM}(1)=Nt(1)=2 and N_{DM}(2)=Nt(2)=2. In FIG. 22, Δfd(1)=1/(6Tᵣ) (e.g., § 1=1) is set, and Δfd(2)=1/(8Tᵣ) (e.g., δ₂=2) is set.

In addition, the operation of antenna switching controller 105 and switches 106 performed when N_{DM}(1)=Nt(1)=2 and N_{DM}(2)=Nt(2)=2 switches transmission antennas 102 used for the transmission of the radar transmission signals between odd-numbered transmission periods Tᵣ and even-numbered transmission periods Tᵣ. For example, in first radar section 10g, at odd-numbered transmission periods Tᵣ (m=1, 3, 5, . . . ) as illustrated at the upper part at (a) of FIG. 22, switch 106 corresponding to Tx #1 is switched to the ON state (switch 106 corresponding to Tx #2 is switched to the OFF state), and radio waves are emitted from Tx #1. Further, at even-numbered transmission periods Tᵣ (m=2, 4, 6, . . . ) as illustrated at the lower part at (a) of FIG. 22, switch 106 corresponding to Tx #2 is switched to the ON state (switch 106 corresponding to Tx #1 is switched to the OFF state), and radio waves are emitted from Tx #2.

Similarly, in second radar section 10g, at odd-numbered transmission periods Tᵣ (m=1, 3, 5, . . . ) as illustrated at the upper part at (b) of FIG. 22, switch 106 corresponding to Tx #1 is switched to the ON state (switch 106 corresponding to Tx #2 is switched to the OFF state), and radio waves are emitted from Tx #1. Further, at even-numbered transmission periods Tᵣ (m=2, 4, 6, . . . ) as illustrated at the lower part at (b) of FIG. 22, switch 106 corresponding to Tx #2 is switched to the ON state (switch 106 corresponding to Tx #1 is switched to the OFF state), and radio waves are emitted from Tx #2.

Note that the switching order of transmission antennas 102 is not limited to this, and may be different switching orders. The same applies to the following description.

Further, by way of another example, FIG. 23 illustrates a setting example of the Doppler shifts for first radar section 10g ((a) of FIG. 23) and a setting example of the Doppler shifts for second radar section 10g ((b) of FIG. 23) in the case of N_{DM}(1)=Nt(1)=2 and N_{DM}(2)=Nt(2)=2. In FIG. 23, Δfd(1)=1/(6Tᵣ) (e.g., δ₁=1) is set, and Δfd(2)=1/(8Tᵣ) (e.g., δ₂=2) is set.

Further, in FIG. 23, Doppler shift amounts DOPₙ₁(1) and DOPₙ₂(2) applied to respective transmission antennas 102 of first radar section 10g and second radar section 10g are set so that the Doppler shift amounts do not match each other between first radar section 10g and second radar section 10g.

As described above, setting the Doppler multiplexing intervals for each of first radar section 10g and second radar section 10g is performed such that the above-described setting conditions for Doppler multiplexing intervals are satisfied. This setting of the Doppler multiplexing intervals makes it more likely for the Doppler components corresponding to the radar reflected waves (reception signals) for the radar transmission signals from first radar section 10g and second radar section 10g to appear at respective different positions within the range of −1/(2TᵣN_{DM}(1))≤f_{d}<1/(2TᵣN_{DM}(1)) of Doppler frequencies f_{d} observed by Doppler analyzers 209, and facilitates demultiplexing the reflected wave signals corresponding to first radar section 10g and second radar section 10g from each other.

By way of example, FIG. 24 illustrates an example of an output (for example, a reception Doppler frequency) of Doppler analyzer 209 in a case where reflected wave signals for radar transmission signals from first radar section 10g and second radar section 10g are received. In FIG. 24, the vertical axis represents the distance axis, and the horizontal axis represents the Doppler frequency axis. Further, in FIG. 24, Doppler components having high power are represented by arrows.

In the present embodiment, radar transmission signals are transmitted from a plurality of transmission antennas 102 while the transmission antennas are switched in a time-division manner, and different Doppler shifts are applied to the signals transmitted from respective transmission antennas 102. Thus, for example, by adding together the powers of all the outputs of first to Nt(q)th Doppler analyzers 209, radar apparatus 1g can detect one of Doppler multiplexing intervals Δfd(1) and Δfd(2) in the reception signals. For example, since the radar transmission signals are transmitted at Doppler multiplexing intervals different between first radar section 10g and second radar section 10g, radar apparatus 1g can distinguish whether the reception signals are reflected wave signals for the radar transmission signals from first radar section 10g or from second radar section 10g based on the detected Doppler multiplexing intervals of the reception signals.

For example, when a Doppler component that matches the interval (e.g., 1/(6Tᵣ) in FIG. 24) of Δfd(1) or a Doppler component that matches an integer multiple of the interval of Δfd(1) is observed at distance index fb1 or fb2 illustrated in FIG. 24, radar apparatus 1g can distinguish (or detect) that these Doppler components are reflected wave signals for the radar transmission signals transmitted from first radar section 10g.

Further, when a Doppler component that matches the interval (e.g., 1/(8Tᵣ) in FIG. 24) of Δfd(2) or a Doppler component that matches an integer multiple of the interval of Δfd(2) is observed at distance index fb3 or fb4 illustrated in FIG. 24, radar apparatus 1g can distinguish that these Doppler components are reflected wave signals for the radar transmission signals transmitted from second radar section 10g.

Further, when a Doppler component that matches interval Δfd(1) (or an integer multiple of Δfd(1)) and a Doppler component that matches the interval of Δfd(2) (or an integer multiple of Δfd(2)) are observed in a mixed manner at distance index fb5 illustrated in FIG. 24, radar apparatus 1g can distinguish the reflected wave signals for the radar transmission signals transmitted from first radar section 10g and the reflected wave signals for the radar transmission signals transmitted from second radar section 10g, for example, based on the intervals of the Doppler components.

As described above, radar apparatus 1g can distinguish whether the observed Doppler components are the reflected wave signals for the radar transmission signals transmitted from the radar section of first radar section 10g or from second radar section 10g, based on the difference between the Doppler multiplexing intervals of the Doppler multiplexing transmissions in first radar section 10g and the Doppler multiplexing intervals of the Doppler multiplexing transmissions in second radar section 10g.

For example, Doppler shifters 101 may set the Doppler shift amount corresponding to each transmission antenna 102 using the Doppler multiplexing interval set as described above, and apply the phase rotation for applying the Doppler shift amount to the chirp signal at each chirp transmission period.

For example, nth Doppler shifter 101 of qth radar section 10g applies, to the mth chirp signal as input, phase rotation Φ_{n,q}(m) for applying Doppler shift amount DOPₙ(q) different for each nth transmission antenna 102, and outputs the resultant signal. As a result, different Doppler shifts are applied to the transmission signals transmitted respectively from multiple transmission antennas 102.

Here, n is an integer of from 1 to Nt(q), m is an integer of from 1 to N_{c}, and q is 1 or 2.

For example, phase rotations Φ_{n,q}(m) for applying Doppler shift amounts DOPₙ(q) for Doppler shift intervals Δfd(q) to the radar transmission signals transmitted from Nt(q) (e.g., Nt(q)=N_{DM}(q)) transmission antennas 102 are expressed by following Expression 26. Expression 27 represents Doppler shift amounts DOPₙ(q) for Doppler shift intervals Δfd(q).

$$\begin{matrix}( Expression 26 ) & \\ {ϕ}_{n , q} ( m ) = \{ 2 π {N}_{D M} ( q ) {T}_{r} \times {DOP}_{n} ( q ) + Δ {ϕ}_{0} \} floor [ \frac{( m - 1 )}{{N}_{D M ( q )}} ] + {ϕ}_{0} = \{ 2 π {N}_{D M} ( q ) {T}_{r} \times Δ {f}_{d} ( q ) ( n - α ) + Δ {ϕ}_{0} \} ( m - 1 ) + {ϕ}_{0} . & ( 26 )\end{matrix}$$

$$\begin{matrix}( Expression 27 ) & \\ {DOP}_{n} ( q ) = Δ {f}_{d} ( q ) ( n - α ) . & ( 27 )\end{matrix}$$

In the expression, Φ₀ is the initial phase and ΔΦ₀ is a reference Doppler shift phase. Note that α is a coefficient for offsetting the Doppler shift amount for each Doppler multiplexed signal and a real value may be used for the coefficient. For example, when α=1, the Doppler shift amount for the first Doppler multiplexed signal is zero.

Expression 26 represents the phase rotations in the case of time-division transmission of Nt(q) transmission antennas 102 cyclically switched from the first transmission antenna to the Nt(q)th transmission antenna for each transmission period Tᵣ based on the control of antenna switching controller 105, but the present disclosure is not limited thereto. Floor[x] represents the floor function outputting the minimum integer less than or equal to real number x.

For example, when Nt(1)=Nt(2)=3, ΔΦ₀=0, Φ₀=0, δ₁=1, and δ₂=2, the Doppler multiplexing intervals are set to Δfd(1)=1/(12Tᵣ) and Δfd(2)=1/(15Tᵣ). Further, for example, when α=1, phase rotations Φ_{n,q}(m) for applying Doppler shift amounts DOPₙ(q) different for nth (n=1, 2, 3) transmission antennas 102 to the mth chirp signal as input are expressed by following Expression 28:

$$\begin{matrix}( Expression 28 ) & \\ {ϕ}_{1 , 1} ( m ) = 0 , {ϕ}_{2 , 1} ( m ) = \frac{π}{2} floor [ \frac{( m - 1 )}{{N}_{{DM}_{( q )}}} ] , {ϕ}_{3 , 1} ( m ) = π floor [ \frac{( m - 1 )}{{N}_{{DM}_{( q )}}} ] , & ( 28 )\end{matrix}$$

$${ϕ}_{1 , 2} ( m ) = 0 , {ϕ}_{2 , 2} ( m ) = \frac{2 π}{2} floor [ \frac{( m - 1 )}{{N}_{{DM}_{( q )}}} ] , {ϕ}_{3 , 2} ( m ) = \frac{4 π}{5} floor [ \frac{( m - 1 )}{{N}_{{DM}_{( q )}}} ] .$$

For example, when first radar section 10g performs Doppler multiplexing transmission using number Nt of transmission antennas=3, first Doppler shifter 101 in first radar section 10g applies phase rotation Φ_{1,1}(m) to the chirp signal inputted from synchronization controller 20 for each transmission period Tᵣ as shown in following Expression 29. The output of first Doppler shifter 101 is output from, for example, first transmission antenna 102 (Tx #1). Here, cp(t) denotes the chirp signal for each transmission period.

$$\begin{matrix}( Expression 29 ) & \\ exp \{ j {ϕ}_{1 , 1} ( 1 ) \} c p ( t ) , exp \{ j {ϕ}_{1 , 1} ( 2 ) \} c p ( t ) , … , exp \{ j {ϕ}_{1 , 1} ( {N}_{c} ) \} c p ( t ) & ( 29 )\end{matrix}$$

Further, for example, second Doppler shifter 101 in first radar section 10g applies phase rotation Φ_{2,1}(m) to the chirp signal inputted from synchronization controller 20, as illustrated in following Expression 30, for each transmission period. The output of second Doppler shifter 101 is output from, for example, second transmission antenna 102 (Tx #2).

$$\begin{matrix}( Expression 30 ) & \\ exp \{ j {ϕ}_{2 , 1} ( 1 ) \} c p ( t ) , exp \{ j {ϕ}_{2 , 1} ( 2 ) \} c p ( t ) , … , exp \{ j {ϕ}_{2 , 1} ( {N}_{c} ) \} c p ( t ) & ( 30 )\end{matrix}$$

Similarly, for example, third Doppler shifter 101 in first radar section 10g applies phase rotation Φ_{3,1}(m) to the chirp signal inputted from synchronization controller 20, as illustrated in following Expression (31), for each transmission period. The output of third Doppler shifter 101 is output from, for example, third transmission antenna 102 (Tx #3).

$$\begin{matrix}( Expression 31 ) & \\ exp \{ j {ϕ}_{3 , 1} ( 1 ) \} c p ( t ) , exp \{ j {ϕ}_{3 , 1} ( 2 ) \} c p ( t ) , … , exp \{ j {ϕ}_{3 , 1} ( {N}_{c} ) \} c p ( t ) & ( 31 )\end{matrix}$$

Further, for example, when second radar section 10g performs Doppler multiplexing transmission using number Nt of transmission antennas=3, first Doppler shifter 101 in second radar section 10g applies, for each transmission period Tᵣ, phase rotation Φ_{1,2}(m) to the chirp signal inputted from synchronization controller 20, as illustrated in following Expression 32. The output of first Doppler shifter 101 is output from, for example, first transmission antenna 102 (Tx #1). Here, cp(t) denotes the chirp signal for each transmission period.

$$\begin{matrix}( Expression 32 ) & \\ exp \{ j {ϕ}_{1 , 2} ( 1 ) \} c p ( t ) , exp \{ j {ϕ}_{1 , 2} ( 2 ) \} c p ( t ) , … , exp \{ j {ϕ}_{1 , 2} ( {N}_{c} ) \} c p ( t ) & ( 32 )\end{matrix}$$

Further, for example, second Doppler shifter 101 in second radar section 10g applies phase rotation Φ_{2,2}(m) to the chirp signal inputted from synchronization controller 20, as illustrated in following Expression 33, for each transmission period. The output of second Doppler shifter 101 is output from, for example, second transmission antenna 102 (Tx #2).

$$\begin{matrix}( Expression 33 ) & \\ exp \{ j {ϕ}_{2 , 2} ( 1 ) \} c p ( t ) , exp \{ j {ϕ}_{2 , 2} ( 2 ) \} c p ( t ) , … , exp \{ j {ϕ}_{2 , 2} ( {N}_{c} ) \} c p ( t ) & ( 33 )\end{matrix}$$

Similarly, for example, third Doppler shifter 101 in second radar section 10g applies phase rotation Φ_{3,2}(m) to the chirp signal inputted from synchronization controller 20 for each transmission period Tᵣ as illustrated in following Expression 34. The output of third Doppler shifter 101 is output from, for example, third transmission antenna 102 (Tx #3).

$$\begin{matrix}( Expression 34 ) & \\ exp \{ j {ϕ}_{3 , 2} ( 1 ) \} c p ( t ) , exp \{ j {ϕ}_{3 , 2} ( 2 ) \} c p ( t ) , … , exp \{ j {ϕ}_{3 , 2} ( {N}_{c} ) \} c p ( t ) & ( 34 )\end{matrix}$$

The exemplary setting for Doppler shift amounts has been described above.

Next, an exemplary operation of first CFAR section 210, second CFAR section 210, first Doppler demultiplexer 211, and second Doppler demultiplexer 211 in qth radar section 10g corresponding to the operation of Doppler shifters 101 described above will be described.

### [Exemplary Operation of First CFAR Section 210]

For example, in order to receive the reflected wave signals for the radar transmission signals from radar transmitter 100g of qth radar section 10g, first CFAR section 210 of qth radar section 10g may perform the following operation.

For example, when δ₁ and δ₂ are set to values that differ from positive integers for Doppler shifters 101, first CFAR section 210 may perform peak detection by, for example, searching, in the power addition values outputted from Doppler analyzers 209 of first to Na(q)th signal processors 206, for a power peak that matches the Doppler shift intervals set for the radar transmission signals of qth radar section 10g for each distance index, and performing adaptive threshold processing (CFAR processing).

On the other hand, for example, when δ₁ and δ₂ are set to positive integers for Doppler shifters 101, an interval of Δfd(q) or an interval of an integer multiple of Δfd(q) is used as an interval of the Doppler shift amounts. In this case, q may be 1 or 2. Therefore, the Doppler multiplexed signals may be detected as having aliasing at intervals of Δfd(q) in the Doppler frequency domain of the outputs of first to Nt(q)th Doppler analyzers 209. By using such characteristics, for example, the operation of first CFAR section 210 can be simplified as follows.

For example, first CFAR section 210 of qth radar section 10g detects a Doppler peak by applying a threshold to a power addition value obtained by adding together the reception powers of the reflected wave signals for respective ranges (for example, ranges of Δfd(q)) within the Doppler frequency range to be subjected to the CFAR processing in the output obtained by performing power addition on the outputs of first to Nt(q)th Doppler analyzers 209, the ranges corresponding to the intervals of the Doppler shift amounts applied respectively to the radar transmission signals.

For example, first CFAR section 210 performs the CFAR processing on on outputs PowerFT_{q}(f_{b}, fₛ) obtained by adding the powers of the outputs of first to Nt(q)th Doppler analyzers 209 of first to Na(q)th signal processors 206, by calculating power addition value PowerDDM_{q}(f_{b}, f_{sddm}) obtained by adding power values Power_{q}FT(f_{b}, fₛ) at the intervals of Δfd(q) (for example, corresponding to N_{Δfd(q)}) as illustrated in following Expressions 35 and 36:

$$\begin{matrix}( Expression 35 ) & \\ P o w e r D D {M}_{q} ( {f}_{b} , {f}_{s d d m} ) = {\sum }_{n d m = 1}^{{N}_{D M} ( q ) + {δ}_{q}} P o w e r F {T}_{q} ( {f}_{b} , {f}_{s d d m} + ( n d m - 1 ) \times {N}_{Δ {f}_{d} ( q )} ) ; and & ( 35 )\end{matrix}$$

$$\begin{matrix}( Expression 36 ) & \\ {PowerFT}_{q} ( {f}_{b} , {f}_{s} ) = {\sum }_{n = 1}^{{N}_{t} ( q )} {\sum }_{z = 1}^{{N}_{a}} {\vert {VFT}_{n , z , q} ( {f}_{b} , {f}_{s} ) \vert}^{2} . & ( 36 )\end{matrix}$$

In the expressions, f_{sddm}=−N_{d}/2, . . . , −N_{d}/2+N_{Δfd(q)}−1 and N_{Δfd(q)}=round(Δfd(q)/(1/(TᵣN_{d}). In addition, round(x) is an operator that rounds off real number x and outputs an integer value.

The operation in the CFAR processing may be based on the operation disclosed in NPL 3, for example, and detailed explanation of the exemplary operation is omitted.

Accordingly, the range of the Doppler frequencies subjected to the CFAR processing in first CFAR section 210 can be set (for example, reduced) to 1/(Nt(q)+δ_{q})=1/(N_{DM}(q)+δ_{q}) of the entire range (for example, the range of from −N_{d}/2 to N_{d}/2−1). It is thus possible to reduce the computational amount of the CFAR processing.

For example, first CFAR section 210 adaptively sets a threshold, and outputs, to first Doppler demultiplexer 211, distance indices f_{b_cfar}, Doppler frequency indices f_{sddm_cfar}, and the reception power information (PowerFT(f_{b_cfar}, f_{sddm_cfar}+(ndm−1)×N_{Δfd(q)})) that provide reception power greater than the threshold. In the expression, ndm is an integer of from 1 to N_{DM}(q)+δ_{q}.

### [Exemplary Operation of First Doppler Demultiplexer 211]

First Doppler demultiplexer 211 performs the following operations, for example, based on distance indices f_{b_cfar}, Doppler frequency indices f_{sddm_cfar}, and the reception power information (PowerFT(f_{b_cfar}, f_{sdm_cfar}+(ndm−1)×N_{Δfd(q)})) (ndm is an integer of from 1 to N_{DM}(q)+δ_{q})) inputted from first CFAR section 210.

For example, assuming that the Doppler velocity of the target object is −1/(2Tᵣ×N_{DM}(q))≤f_{d}<1/(2Tᵣ×N_{DM}(q)), first Doppler demultiplexer 211 associates the Doppler shift amounts for the transmitted Doppler multiplexed signals with f_{sddm_cfar}+(ndm−1)×N_{Δfd(q)} and outputs resultant demultiplexing index information (for example, f_{demul_Tx#1}(q), . . . , f_{demul_Tx#NDM}(q)) of the Doppler multiplexed signals to first direction estimator 212.

Here, f_{demul_Tx#n}(q) indicates the Doppler frequency index of the reflected wave signal for the radar transmission signal transmitted from nth transmission antenna 102 (Tx #n) of qth radar section 10g.

In the present embodiment, for example, transmission antennas 102 are switched in the time-division manner. From the above, first Doppler demultiplexer 211 determines, for example, that, among Doppler frequency indices f_{sddm_cfar}+(ndm−1)×N_{Δfd(q)} (ndm is an integer of from 1 to N_{DM}(q)+δ_{q}), a signal with highest reception power |VFT_{n,z,q} (f_{b_cfar}, f_{sddm_cfar}+(ndm−1)×N_{Δfd(q)}|² of nth Doppler analyzer 209 is the reception signal for the radar transmission signal from nth transmission antenna 102.

When the difference between the powers of N_{DM}(q) Doppler frequency indices for the higher reception powers is larger than a predetermined value (threshold), first Doppler demultiplexer 211 may regard (or determine) that signals of the reception signals of the multistatic configuration are highly likely to be mixed, and may add an operation of removing the reception signals without performing an output for subsequent processing (for example, direction estimation processing).

The exemplary operation of first Doppler demultiplexer 211 has been described above.

### [Exemplary Operation of Second CFAR Section 210]

For example, second CFAR section 210 of qth radar section 10g may perform the following operations in order to receive the reflected wave signal for the radar transmission signal from radar transmitter 100g of radar section 10g that differs from qth radar section 10g.

For example, when δ₁ and δ₂ are set to values that differ from positive integers for Doppler shifters 101, second CFAR section 210 may perform peak detection by, for example, searching, in the power addition values outputted from first to Nt(q)th Doppler analyzers 209 of first to Na(q)th signal processors 206, for a power peak that matches the Doppler shift interval set for the radar transmission signal of radar section 10g different from qth radar section 10g for each distance index, and performing adaptive threshold processing (CFAR processing).

On the other hand, for example, when δ₁ and δ₂ are set to positive integers for Doppler shifters 101, an interval of Δfd(q) or an interval of an integer multiple of Δfd(q) is used as an interval of the Doppler shift amounts. In this case, q may be 1 or 2. Therefore, the Doppler multiplexed signals may be detected as having aliasing at intervals of Δfd(q) in the Doppler frequency domain of the outputs of first to Nt(g)th Doppler analyzers 209. By using such characteristics, for example, the operation of second CFAR section 210 can be simplified as follows.

For example, second CFAR section 210 of qth radar section 10g detects a Doppler peak by applying a threshold to a power addition value obtained by adding together the reception powers of the reflected wave signals for respective ranges (for example, ranges of Δfd(qe)) within the Doppler frequency range to be subjected to the CFAR processing in the output value obtained by performing power addition on the outputs of first to Nt(q)th Doppler analyzers 209, the ranges corresponding to the intervals of the Doppler shift amounts applied respectively to the radar transmission signals.

Here, “qe” represents a radar number of radar section 10g that differs from qth radar section 10g. For example, in the case of first radar section 10g (q=1), qe may be 2, and in the case of second radar section 10g (q=2), qe may be 1.

For example, second CFAR section 210 performs the CFAR processing on the output obtained by adding the powers of the outputs of first to Nt(q)th Doppler analyzers 209 of first to Na(q)th signal processors 206, by calculating power addition value PowerDDM_{qe}(f_{b}, f_{sddm}) obtained by adding power values PowerFT_{q}(f_{b}, fₛ) at the intervals of Δfd(qe) (for example, corresponding to +N_{Δfd(qe)}) as illustrated in following Expression 37:

$$\begin{matrix}( Expression 37 ) & \\ P o w e r D D {M}_{q e} ( {f}_{b} , {f}_{s d d m} ) = {\sum }_{n d m = 1}^{{N}_{D M} ( q e ) + {δ}_{q e}} P o w e r F {T}_{q} ( {f}_{b} , {f}_{s d d m} + ( n d m - 1 ) \times {N}_{Δ {f}_{d} ( qe )} ) . & ( 37 )\end{matrix}$$

In the expression, f_{sddm}=−N_{d}/2, . . . , −N_{d}/2+N_{Δfd(qe)}−1. N_{Δfd(qe)}=round(Δfd(qe)/(1/(TᵣN_{d})). In addition, round(x) is an operator that rounds off real number x and outputs an integer value.

The operation in the CFAR processing may be based on the operation disclosed in NPL 3, for example, and detailed explanation of the exemplary operation is omitted.

Thus, the Doppler frequency range on which the CFAR processing is performed in second CFAR section 210 can be set (e.g., reduced) to 1/(Nt(qe)+δ_{qe})=1/(N_{DM}(qe)+δ_{qe} of the entire range (e.g., the range of −N_{d}/2 to N_{d}/2−1), thereby reducing the computational amount of the CFAR processing.

For example, second CFAR section 210 adaptively sets a threshold, and outputs to second Doppler demultiplexer 211 distance indices f_{b_cfar}, Doppler frequency indices f_{sddm_cfar}, and the reception power information (PowerFT(f_{b_cfar}, f_{sddm_cfar}+(ndm−1)×N_{Δfd(qe)})) that provide reception power greater than the threshold. Here, ndm is an integer of from 1 to Nt(qe)+δ_{qe}.

### [Exemplary Operation of Second Doppler Demultiplexer 211]

Second Doppler demultiplexer 211 performs the following operations based on, for example, distance indices f_{b_cfar}, Doppler frequency indices f_{sddm_cfar}, and the reception power information (PowerFT(f_{b_cfar}, f_{sddm_cfar}+(ndm−1)×N_{Δfd(qe)}))(ndm=1 to N_{DM}(qe)+δ_{qe} integers)) inputted from second CFAR section 210.

For example, assuming that the Doppler velocity of the target object is −1/(2Tᵣ×N_{DM}(qe))≤f_{d}<1/(2Tᵣ×N_{DM}(qe)), second Doppler demultiplexer 211 associates the Doppler shift amounts of the Doppler multiplexed signals to be transmitted with f_{sddm_cfar}+(ndm−1)×N_{Δfd(qe)}, and outputs, to second direction estimator 212, the resulting demultiplexing index information (f_{demul_Tx#1}(qe), . . . , and f_{demul_Tx#NDM}(qe)) of the Doppler multiplexed signals.

Here, f_{demul_Tx#n}(qe) indicates the Doppler frequency index of the reflected wave signal for the radar transmission signal transmitted from nth transmission antenna 102 (Tx #n) of qeth radar section 10g.

In the present embodiment, for example, transmission antennas 102 are switched in the time-division manner. From the above, second Doppler demultiplexer 211 includes determines, for example, that, among Doppler frequency indices f_{sddm_cfar}+(ndm−1)×N_{Δfd(qe)} (ndm is an integer of from 1 to N_{DM}(q)+δ_{q}), a signal with highest reception power |VFT_{n,z,q} (f_{b_cfar}, f_{sddm_cfar}+(ndm−1)×NΔfd(q)|² of nth Doppler analyzer 209 is the reception signal for the radar transmission signal from nth transmission antenna 102.

When a difference between the powers for N_{DM}(qe)=Nt(qe) Doppler frequency indices is larger than a predetermined value (for example, a threshold), second Doppler demultiplexer 211 may regard (or determine) that the reception signals for the monostatic configuration are highly likely to be mixed, and may add an operation of removing a reception signal without outputting the reception signal to subsequent processing (for example, direction estimation processing).

The exemplary operation of second Doppler demultiplexer 211 has been described above.

In FIG. 21, first direction estimator 212 of qth radar section 10g performs the direction estimation processing on the target object based on, for example, the information (for example, distance indices f_{b_cfar} and demultiplexing index information (f_{demul_Tx#1}(q), f_{demul_Tx#2}(q), . . . , and f_{demul_Tx#Nt}(q)) on the Doppler multiplexed signal) inputted from first Doppler demultiplexer 211. Since the operation of first direction estimator 212 according to the present embodiment is the same as the operation of first direction estimator 212 according to Embodiment 1, the description thereof will be omitted.

In FIG. 21, second direction estimator 212 of qth radar section 10g performs the direction estimation processing on the target object based on, for example, the information (for example, distance indices f_{b_cfar} and demultiplexing index information (f_{demul_Tx#1}(qe), f_{demul_Tx#2}(qe), . . . , and f_{demul_Tx#NDM}(qe)) on the Doppler multiplexed signal) inputted from second Doppler demultiplexer 211. Since the operation of second direction estimator 212 according to the present embodiment is the same as the operation of second direction estimator 212 according to Embodiment 1, the description thereof will be omitted.

Positioning output integrator 30 integrates the positioning outputs of first direction estimator 212 and second direction estimator 212 from first radar section 10g and the positioning outputs of first direction estimator 212 and second direction estimator 212 from second radar section 10g, and performs positioning of the target object. Since the operation of positioning output integrator 30 according to the present embodiment is the same as the operation of positioning output integrator 30 in Embodiment 1, the description thereof will be omitted.

As described above, in the present embodiment, radar apparatus 1g includes first radar section 10g that transmits radar transmission signals from a plurality of transmission antennas 102, and second radar section 10g that transmits radar transmission signals from a plurality of transmission antennas 102. Here, the Doppler multiplexing interval between the Doppler shift amounts applied respectively to the radar transmission signals transmitted from the plurality of transmission antennas 102 of first radar section 10g is different from the Doppler multiplexing interval between the Doppler shift amounts applied respectively to the radar transmission signals transmitted from the plurality of transmission antennas 102 of second radar section 10g.

Accordingly, radar apparatus 1g can demultiplex the reflected wave signals corresponding to the radar transmission signals of radar sections 10g from the reception signals, for example, based on the Doppler multiplexing intervals set in radar sections 10g.

Therefore, radar apparatus 1g can simultaneously perform radar positioning by the monostatic configuration of each of first radar section 10g and second radar section 10g using time-division multiplexing transmission, and radar positioning by the multistatic configuration from first radar section 10g to second radar section 10g and the multistatic configuration from second radar section 10g to first radar section 10g by using Doppler multiplexing transmission.

Therefore, according to the present embodiment, even when time-division multiplexing is applied in the monostatic MIMO radar, the radar positioning time can be reduced as compared with the case where inter-multistatic time-division transmission is used, and the same advantages as those in Embodiment 1 can be obtained.

Further, for example, radar apparatus 1g can expand the observable Doppler range (for example, can set the observable Doppler range to +1/(2NtTᵣ)) by performing Doppler aliasing determination using unequal-interval Doppler multiplexing, and can suppress reduction of the maximum Doppler observable by the inter-multistatic multiplexing transmission. For example, radar apparatus 1g can maintain the same observation range as the maximum Doppler in the case of time-division multiplexing transmission in which Nt transmission antennas are used.

Also in the present embodiment, for example, at least one of Variations 1 to 7 of Embodiment 1 may be applied, and the same effect can be obtained.

### Embodiment 3

Embodiment 1 has been described in which the Doppler multiplexing is applied to the transmission multiplexing in the monostatic MIMO radar, but the present disclosure is not limited thereto, and the code multiplexing may be applied. In the present embodiment, an exemplary operation when Doppler multiplexing is applied to a multistatic MIMO radar and code multiplexing is applied to a monostatic MIMO radar will be described.

FIG. 25 is a block diagram illustrating an exemplary configuration of radar apparatus 1 h according to the present embodiment. In FIG. 25, components that perform the same operations as those in FIG. 3 are denoted by the same reference numerals. Hereinafter, operations different from those of Embodiment 1 will be mainly described.

Radar apparatus 1h illustrated in FIG. 25 may include, for example, a plurality of radar sections 10h, synchronization controller 20, and positioning output integrator 30 (not illustrated in FIG. 25). FIG. 25 illustrates an exemplary configuration of one radar section 10h.

In FIG. 25, synchronization controller 20 includes, for example, radar transmission signal generator 301 including modulation signal generator 302 and Voltage-Controlled Oscillator (VCO) 303, and signal controller 304. Radar transmission signal generator 301 generates a radar transmission signal (for example, a predetermined frequency-modulated wave (chirp signal)) based on, for example, control by signal controller 304, and outputs the generated radar transmission signal to a plurality of radar sections 10h (for example, radar transmitters 100h) constituting the multistatic configuration. The chirp signal outputted by synchronization controller 20 is also inputted to radar receiver 200h (each mixer 204). The operation of synchronization controller 20 may be the same as that of Embodiment 1.

In addition, each of the plurality of radar sections 10h illustrated in FIG. 25 may transmit radar transmission signals by code multiplexing, for example, for each Doppler shift amount. By way of example, FIG. 25 illustrates an example in which code multiplexers 108 are provided to code-multiplex a signal to be transmitted from two transmission antennas 102 for each output of one Doppler shifter 101 (for example, each signal to which one Doppler shift amount is applied). However, the present disclosure is not limited thereto, and the longer the code length of code multiplexing, the more the signals transmitted from transmission antennas 102 can be code-multiplexed.

Radar section 10h may include, for example, radar transmitter 100h and radar receiver 200h.

[Exemplary Configuration of Radar Transmitter 100h]

In FIG. 25, radar transmitter 100h of radar section 10h includes, for example, Doppler shifters 101-1 to 101-N_{DM}, transmission antennas 102-1 to 102-Nt (for example, Tx #1 to Tx #Nt), code multiplexing controller 107, and code multiplexers 108.

To apply Doppler shift amount DOPₙ(q) to the chirp signal inputted from VCO 303, each of Doppler shifters 101 of qth radar section 10h applies phase rotation Φ_{n,q}(m) to the chirp signal for each transmission period Tᵣ of the chirp signal, and outputs the Doppler-shifted signal to code multiplexers 108.

For example, qth radar section 10h may apply a predetermined phase rotation Φ_{n,q}(m) to apply Doppler shifts that provide Doppler multiplexing intervals different between radar section 10h that perform multistatic radar multiplexing transmission (an exemplary operation will be described later). Here, n is an integer of from 1 to N_{DM}(q), and q is 1 or 2.

For example, code multiplexing controller 107 controls code multiplexers 108 such that one or more codes with code length N_{colen} are superimposed on the output of each of Doppler shifters 101 (an exemplary operation will be described later). In addition, code multiplexing controller 107 outputs information on the code multiplexing control to radar receiver 200h (output switcher 214).

Note that same code length N_{colen} is used for both first radar section 10h and second radar section 10h. This makes it easy to distinguish Doppler multiplexed signals used in both first radar section 10h and second radar section 10h.

For example, one or more (two in FIG. 25) code multiplexers 108 are connected to each Doppler shifter 101. Code multiplexers 108 superimpose codes having code length N_{colen} on the outputs of Doppler shifters 101 under the control of code multiplexing controller 107 (an exemplary operation will be described later).

The signals outputted from code multiplexers 108 are amplified to a predetermined transmission power, and are emitted from transmission antennas 102 (Tx #1 to Tx #Nt(q) into space.

Here, in the present embodiment, for example, the numbers of transmission antennas 102 (or the numbers of transmission antennas 102 used) included in respective qth radar sections 10h (q=1 or 2) may be the same or different. In the following description, the number of transmission antennas in qth radar section 10h is referred to as Nt(q) (or simply “Nt”). Here, Nt(q)>1.

[Exemplary Configuration of Radar Receiver 200h]

In FIG. 25, radar receiver 200h includes Na reception antennas 202 (for example, Rx #1 to Rx #Na), and serves as a component of an array antenna. Further, radar receiver 200h includes Na antenna system processors 201, CFAR sections 210, Doppler demultiplexers 211, code separators 215, and direction estimators 212.

For example, the number of reception antennas 202 may be the same or different between qth radar sections 10h (e.g., q=1 or 2). Hereinafter, the number of reception antennas in qth radar section 10h will be referred to as “Na(q).” Here, Na(q)≥1.

The operation of reception radio 203 of antenna system processor 201 is the same as that of Embodiment 1, and the description thereof is omitted.

The operations of A/D converter 207 and beat frequency analyzer 208 in signal processor 206h of the antenna system processor 201 are the same as those in Embodiment 1, and the explanation thereof is omitted.

Output switcher 214 performs, for example, an operation associated with the operation of code multiplexing controller 107 based on the control by code multiplexing controller 107 of radar transmitter 100h, and selectively switches a destination of an output of beat frequency analyzer 208 to one of N_{colen} Doppler analyzers 209 (for example, also represented by Doppler analyzers 209-1 to 209-N_{colen}) for each transmission period Tᵣ.

For example, when code multiplexing controller 107 performs control to add a first code element to an output signal of Doppler shifters 101, output switcher 214 outputs an output signal from beat frequency analyzer 208 to first Doppler analyzer 209, but does not output the output signal to other Doppler analyzers 209.

Similarly, for example, when code multiplexing controller 107 performs control to add a second code element to the output signal of Doppler shifters 101, output switcher 214 outputs the output signal from beat frequency analyzer 208 to second Doppler analyzer 209, but does not output the output signal to other Doppler analyzers 209.

Similarly, for example, when code multiplexing controller 107 performs control to add a nclth code element to the output signal of Doppler shifters 101, output switcher 214 outputs the output signal from beat frequency analyzer 208 to nclth Doppler analyzer 209 but does not output the output signal to other Doppler analyzers 209. Here, ncl is an index indicating each element of the code with code length N_{colen}, and is represented by an integer of ncl=1 to N_{colen}.

Here, for example, code multiplexing controller 107 may perform control to apply the N_{colen}th code element to the output signal of Doppler shifters 101, and then may perform control to apply the first code element to the output signal of Doppler shifters 101 at subsequent transmission period Tᵣ. Thereafter, code multiplexing controller 107 cyclically repeatedly adds a code element to an output signal of Doppler shifters 101 for each transmission period Tᵣ. Output switcher 214 switches the output destination of the output signal from beat frequency analyzer 208 in accordance with the operation of control of code multiplexing controller 107.

The nclth Doppler analyzer 209 (or Doppler analyzer 209-ncl) of zth signal processor 206h performs Doppler analysis for each distance index f_{b} based on a beat frequency response for transmission period Tᵣ in which a signal is transmitted with the nclth code element being superimposed thereon, among beat frequency responses RFT_{z}(f_{b}, 1), RFT_{z}(f_{b}, 2), . . . , and RFT_{z}(f_{b}, N_{C}) obtained by N_{C} chirp pulse transmissions of the chirp signals.

For example, when the control for applying codes composed of N_{colen} code elements to the output signals of Doppler shifters 101 in an order from the first code element to the N_{colen}th code element for each transmission period Tᵣ is cyclically repeated based the control of code multiplexing controller 107, Doppler analyzers 209 may apply Fast Fourier Transform (FFT) processing as illustrated in following Expression 38, and output VFT_{ncl,z,q}(f_{b}, fₛ) as the output of nclth Doppler analyzer 209 in zth signal processor 206h. Note that Nₛ is an integer multiple of N_{colen}, and may be set to Nₛ=N_{c}/N_{colen}, for example. Note that RFT_{z,q}(f_{b}, m) represents the beat frequency response outputted from beat frequency analyzer 208 in qth radar section 10.

$$\begin{matrix}( Expression 38 ) & \\ V F {T}_{ncl , z , q} ( {f}_{b} , {f}_{s} ) = {\sum }_{s = I}^{{N}_{s}} R F {T}_{z , q} ( {f}_{b} , ( s - 1 ) \times {N}_{c o l e n} + n c l ) exp [ ‐ \frac{j 2 π ( s - 1 ) {f}_{s}}{{N}_{s}} ] & ( 38 )\end{matrix}$$

Here, the FFT size is Nₛ, and the maximum Doppler frequency at which no aliasing occurs and which is derived from the sampling theorem is +1/(2TᵣNₛ). Further, the Doppler frequency interval of Doppler frequency index fₛ is 1/(Nₛ×Tᵣ), and the range of Doppler frequency index fₛ is fₛ=−Nₛ/2, . . . , 0, . . . , and Nₛ/2−1.

In the following, a case where Nₛ is a power of 2 will be described. When Nₛ is not a power of 2, zero-padded data is included, for example, to obtain the data size of a power of 2 and the FFT processing can thus be performed. In the FFT processing, Doppler analyzer 209 may perform multiplication by a window function coefficient such as the Han window or the Hamming window. It is possible to suppress sidelobes generated around the beat frequency peak by applying a window function.

In FIG. 25, for example, first CFAR section 210 selectively extracts local peaks of reflected wave signals for radar transmission signals of qth radar section 10h (corresponding radar), which has the monostatic configuration, using outputs VFT_{ncl,z,q}(f_{b}, fₛ) of first to N_{colen}th Doppler analyzers 209 of first to Na(q)th signal processors 206h. For example, first CFAR section 210 may perform the CFAR processing of performing the adaptive threshold determination after power addition at intervals matching the Doppler multiplexing intervals set for the radar transmission signals transmitted from qth radar section 10h, extract distance indices f_{b_cfar} and Doppler frequency indices f_{sddm_cfar} that provide local peak signals, and output extracted distance indices f_{b_cfar} and Doppler frequency indices f_{sddm_cfar} to first Doppler demultiplexer 211 (an exemplary operation will be described later).

The radar transmitter having the monostatic configuration in first radar section 10h is radar transmitter 100h of first radar section 10h. Similarly, the radar transmitter having the monostatic configuration in second radar section 10h is radar transmitter 100h of second radar section 10h.

Further, for example, second CFAR section 210 selectively extracts local peaks of the reflected wave signals for the radar transmission signals of another radar section 10h different from qth radar section 10h (the corresponding radar), which has the multistatic configuration, using outputs VFT_{ncl,z,q}(f_{b}, fₛ) of first to N_{colen}th Doppler analyzers 209 of first to Na(q)th signal processors 206h. For example, second CFAR section 210 may perform the CFAR processing of performing the adaptive threshold determination after the power addition at intervals matching the Doppler multiplexing intervals set for the radar transmission signals transmitted from radar section 10h other than qth radar section 10h, extract distance indices f_{b_cfar} and Doppler frequency indices f_{sddm_cfar} that provide local peak signals, and output the extracted distance indices f_{b_cfar} and Doppler frequency indices f_{sdm_cfar} to second Doppler demultiplexer 211 (an exemplary operation will be described later).

The radar transmitter having the multistatic configuration in first radar section 10h is radar transmitter 100h of second radar section 10h. Similarly, radar transmitter 100h having the multistatic configuration in second radar section 10h is radar transmitter 100h of first radar section 10.

Next, the operation of qth Doppler demultiplexer 211 will be described together with the exemplary operation of Doppler shifters 101 and qth CFAR section 210. For example, q=1 or 2 may hold true.

Doppler demultiplexers 211 of qth radar section 10h may include, for example, first Doppler demultiplexer 211 that performs Doppler demultiplexing on the reflected wave signals for the radar transmission signals from qth radar section 10h (corresponding radar), which has the monostatic configuration, using the outputs of first CFAR section 210 and second Doppler demultiplexer that performs Doppler demultiplexing on the reflected wave signals for the radar transmission signals from another radar section 10h different from qth radar section 10h, which has the multistatic configuration, using the outputs of second CFAR section 210.

The operation of qth Doppler demultiplexer 211 is related to the operation of Doppler shifters 101, code multiplexing controller 107, and code multiplexers 108 of radar transmitter 100h. Similarly, the operation of qth CFAR section 210 is related to the operation of Doppler shifters 101 of radar transmitter 100h.

Hereinafter, an exemplary operation of Doppler shifters 101, code multiplexing controller 107, and code multiplexers 108 will be described, and thereafter, an exemplary operation of qth CFAR section 210 and an exemplary operation of qth Doppler demultiplexer 211 will be described.

To begin with, exemplary operations of Doppler shifters 101, code multiplexing controller 107, and code multiplexer 108 in radar transmitter 100h will be described.

For example, number N_{DM}(q) of Doppler multiplexing and number N_{code} of code multiplexing may be preset to satisfy N_{DM}×N_{code}≥Nt(q) for first to Nt(q)th transmission antennas 102 in qth radar section 10h.

In addition, for example, an orthogonal code such as a Walsh Hadamard code or a pseudo-orthogonal code may be applied to the code multiplexing. By using same code length N_{colen} for both first radar section 10h and second radar section 10h, it becomes easier for radar apparatus 1h to distinguish the Doppler multiplexed signals used in each of first radar section 10h and second radar section 10h.

In addition, in the present embodiment, first to N_{DM}(q)th Doppler shifters 101 of qth radar section 10h perform Doppler multiplexing transmission by applying respective different Doppler shift amounts DOPₙ(q) of predetermined Doppler multiplexing intervals Δfd(q) to the chirp signals inputted from synchronization controller 20. Here, n is an integer of from 1 to N_{DM}(q). At this time, Doppler multiplexing intervals Δfd(q) may satisfy the following setting conditions (1) and (2).
(1) The Doppler multiplexing intervals between the plurality of radar sections 10h may be set to different intervals. For example, the intervals for respective Doppler shift amounts applied to the radar transmission signals transmitted from the plurality of transmission antennas 102 of first radar section 10h and the intervals for respective Doppler shift amounts applied to the radar transmission signals transmitted from the plurality of transmission antennas 102 of second radar section 10h may be different from each other (for example, Δfd(1) #Δfd(2)).
(2) For example, the ratio between Δfd(1) and Δfd(2) may be set so as not to match an integer. For example, of Δfd(1) and Δfd(2), the ratio of the Doppler multiplexing interval having the larger value to the Doppler multiplexing interval having the smaller value may be different from the integer. For example, Δfd(1)/Δfd(2) or Δfd(2)/Δfd(1) may be set so as not to match the integer (so as to be different from the integer).

Hereinafter, an example of setting Doppler multiplexing interval Δfd(q) will be described.

For example, Doppler shifters 101 apply the same phase rotation within a period (for example, a transmission period of N_{colen}×Tᵣ) of a code length in code multiplexing. For example, Doppler shifter 101 may apply a predetermined phase rotation (e.g., ranging from 0 to 2π) to the chirp signal at every N_{colen}×Tᵣ period.

Here, in Doppler analyzers 209, the range of Doppler frequency f_{d} in which no aliasing is generated and which is derived from the sampling theorem is from −1/(2Tᵣ×N_{colen}(q))≤f_{d}<1/(2Tᵣ×N_{colen}(q)). For example, even when the Doppler frequency exceeds the range of Doppler frequency f_{d} in which no aliasing occurs, the range of Doppler frequency f_{d} observed in Doppler analyzers 209 is −1/(2Tᵣ×N_{colen}(q))≤f_{d}<1/(2Tᵣ×N_{colen}(q)).

Therefore, for example, when Doppler shifters 101 apply a Doppler shift within −1/(2Tᵣ×N_{colen}(q))≤f_{d}<1/(2Tᵣ×N_{colen}(q)), maximum Doppler shift interval Δfdmax for N_{DM}(q) Doppler multiplexed signals is Δfdmax=1/(TᵣN_{colen}N_{DM}(q)). For example, Doppler shifters 101 may set Δfd(1) and Δfd(2) to different intervals within the range up to Δfdmax. Accordingly, Doppler shifters 101 can set the Doppler shift within the range of 0 to 2π that is the phase rotation providing the Doppler shift.

For example, the Doppler multiplexing intervals of each of first radar section 10h and second radar section 10h may be set to Δfd(1)=1/(Tᵣ×N_{colen}×(N_{DM}(1)+δ₁)) and Δfd(2)=1/(Tᵣ×N_{colen}×(N_{DM}(2)+δ₂)), respectively.

Here, δ₁, δ₂≥0 and satisfies N_{DM}(1)+δ₁≠N_{DM}(2)+δ₂. Further, δ₁ and δ₂ may be set so that the ratio between N_{DM}(1)+δ₁ and N_{DM}(2)+δ₂ does not match an integer. With this setting, the Doppler multiplexing interval between the plurality of radar sections 10h (for example, between first radar section 10h and second radar section 10h) is different (Δfd(1) #Δfd(2)), and the ratio between Δfd(1) and Δfd(2) does not match an integer.

Note that each of δ₁ and δ₂ may be a positive integer or a positive real number. For example, by setting δ₁ and δ₂ to be positive integers, the processes in first CFAR section 210 and second CFAR section 210, which will be described later, can be simplified. Descriptions are given below of a case where δ₁ and δ₂ are each set to zero or a positive integer. However, the present disclosure is not limited thereto, and positive real numbers may be set.

In addition, a configuration may be adopted in which parameters (for example, values such as Doppler multiplexing intervals Δfd(q) or δ_{q}) which, for example, cause the Doppler shift amounts to match each other between first radar section 10h and second radar section 10h are excluded in advance. For example, for all of n₁ and n₂, the parameters may be set so as to satisfy following Expression 39:

$$\begin{matrix}( Expression 39 ) & \\ {DOP}_{n 1} ( 1 ) \neq {DOP}_{n 2} ( 2 ) , {n}_{1} ∈ \{ 1 , 2 , … {N}_{D M} ( 1 ) \} , {n}_{2} ∈ \{ 1 , 2 , … {N}_{D M} ( 2 ) \} . & ( 39 )\end{matrix}$$

By this setting, for example, Doppler shift amount DOPₙ₁(1) applied to the radar transmission signal of first radar section 10h and Doppler shift amount DOPₙ₂(2) applied to the radar transmission signal of second radar section 10h are set to values different from each other.

The parameter setting satisfying Expression 39 may be applied, for example, to situations in which both radar apparatus 1h and the target are supposed to be mostly stationary. For example, when radar apparatus 1h and the target are both stationary, a Doppler component is zero. Therefore, for example, even when the reflected wave signal for the radar transmission signal of first radar section 10h and the reflected wave signal for the radar transmission signal of second radar section 10h are included in the same distance index, Doppler shift amount DOPₙ(q) for each MIMO multiplexed transmission signal is different. Thus, radar apparatus 1h can demultiplex and receive both the reflected wave signals by utilizing the difference in detected Doppler components.

A description is given below of exemplary setting of Doppler shift amounts.

### Setting Example 1

For example, when N_{DM}(1)≠N_{DM}(2) and the ratio of N_{DM}(1) to N_{DM}(2) does not match an integer multiple, then Δfd(1)=1/(Tᵣ×N_{colen}×N_{DM}(1)) and Δfd(2)=1/(Tᵣ×N_{colen}×N_{DM}(2)) may be set. In this case, the above-described setting conditions of the Doppler multiplexing intervals are satisfied.

In this case, the Doppler multiplexing interval can be maximized within the range of −1/(2Tᵣ×N_{colen})≤f_{d}<1/(2Tᵣ×N_{colen}) of Doppler frequencies f_{d} observed by Doppler analyzers 209. Therefore, for example, even in a case where the Doppler spectrum has a spread, such as a case where the moving speed of the target is not constant and has a component such as acceleration, the interference effect between the Doppler multiplexed signals can be reduced. For example, when the Doppler velocity observable by using the non-uniformity of the Doppler multiplexing intervals as disclosed in PTL 1 does not increase, the Doppler velocity is −1/(2Tᵣ×N_{colen}×N_{DM}(1))≤f_{d}<1/(2Tᵣ×N_{colen}×N_{DM}(1)) or −1/(2Tᵣ×N_{colen}×N_{DM}(2))≤f_{d}<1/(2Tᵣ×N_{colen}×N_{DM}(2)).

By way of example, FIG. 26 illustrates an example of Doppler shift setting of first radar section 10h (upper part of FIG. 26) and an example of Doppler shift setting of second radar section 10h (lower part of FIG. 26) in a case of N_{DM}(1)=Nt(1)=3 and N_{DM}(2)=Nt(2)=4. In FIG. 26, Δfd(1)=1/(3Tᵣ×N_{colen}) (e.g., δ₁=0) is set and Δfd(2)=1/(4Tᵣ×N_{colen}) (e.g., δ₂=0) is set. For example, in FIG. 26, Doppler shift amounts DOP₁(1) and DOP₁(2) assigned to the first Doppler multiplexed signals of each of first radar section 10h and second radar section 10h are set to values corresponding to Doppler frequency f_{d}=0. For example, in FIG. 26, at least one Doppler shift amount is identical between first radar section 10h and second radar section 10h.

By way of another example, FIG. 27 illustrates an example of Doppler shift setting of first radar section 10h (upper part of FIG. 27) and an example of Doppler shift setting of second radar section 10h (lower part of FIG. 27) in the case of N_{DM}(1)=Nt(1)=3 and N_{DM}(2)=Nt(2)=4. In FIG. 27 as in FIG. 26, Δfd(1)=1/(3Tᵣ×N_{colen}) (e.g., δ₁=0) is set, and Δfd(2)=1/(4Tᵣ×N_{colen}) (e.g., δ₂=0) is set. Further, in FIG. 27, Doppler shift amounts DOPₙ₁(1) and DOPₙ₂(2) of each of first radar section 10h and second radar section 10h are set so that the Doppler shift amounts do not match each other between first radar section 10h and second radar section 10h (for example, so as to satisfy Expression 39).

### Setting Example 2

For example, the above-described setting condition for Doppler multiplexing intervals are satisfied when N_{DM}(1) #N_{DM}(2) and the ratio of N_{DM}(1) and N_{DM}(2) matches an integer, when Δfd(1)=1/(Tᵣ×N_{colen}×(N_{DM}(1)+1)) and Δfd(2)=1/(Tᵣ×N_{colen}×(N_{DM}(2)+1)), when Δfd(1)=1/(Tᵣ×N_{colen}×N_{DM}(1)) and Δfd(2)=1/(Tᵣ×N_{colen}×(N_{DM}(2)+1)), or when Δfd(1)=1/(Tᵣ× N_{colen}×(N_{DM}(1)+1)) and Δfd(2)=1/(Tᵣ×N_{colen}×N_{DM}(2)).

In this case, the Doppler multiplexing interval can be maximized within the range of −1/(2Tᵣ×N_{colen})≤f_{d}<1/(2Tᵣ×N_{colen}) of Doppler frequencies f_{d} observed by Doppler analyzers 209. Therefore, even in a case where the Doppler spectrum has a spread, such as a case where the moving speed of the target is not constant and has a component such as acceleration, the interference effect between the Doppler multiplexed signals can be reduced. Further, for example, when the Doppler multiplexing intervals include a non-uniform part, the Doppler velocity observable by using the non-uniform Doppler intervals is −1/(2Tᵣ×N_{colen})≤f_{d}<1/(2Tᵣ×N_{colen}) as disclosed in PTL 1.

By way of example, FIG. 28 illustrates an example of Doppler shift setting of first radar section 10h (upper part of FIG. 28) and an example of Doppler shift setting of second radar section 10h (lower part of FIG. 28) in a case of N_{DM}(1)=2 and N_{DM}(2)=4. In FIG. 28, Δfd(1)=1/(3Tᵣ×N_{colen}) (e.g., δ₁=1) is set and Δfd(2)=1/(4Tᵣ×N_{colen}) (e.g., δ₂=0) is set. For example, in FIG. 28, Doppler shift amounts DOP₁(1) and DOP₁(2) assigned to the first Doppler multiplexed signals of each of first radar section 10h and second radar section 10h are set to values corresponding to Doppler frequency f_{d}=0. For example, in FIG. 28, at least one Doppler shift amounts match each other between first radar section 10h and second radar section 10h.

Further, for example, regarding the Doppler shifts set for first radar section 10 illustrated in FIG. 28, a Doppler shift for providing an interval of Δfd(1) is not assigned on the negative side and thus a non-uniform Doppler multiplexing interval portion is included. For example, the Doppler shift interval set in first radar section 10h is set to one of intervals obtained by unequally dividing the Doppler frequency range to be subjected to the Doppler analysis.

By way of another example, FIG. 29 illustrates an example of Doppler shift setting of first radar section 10h (upper part of FIG. 29) and an example of Doppler shift setting of second radar section 10h (lower part of FIG. 29) in the case of N_{DM}(1)=2 and N_{DM}(2)=4. In FIG. 29 as in FIG. 28, Δfd(1)=1/(3Tᵣ×N_{colen}) (e.g., δ₁=1) is set, and Δfd(2)=1/(4Tᵣ×N_{colen}) (e.g., δ₂=0) is set. Further, in FIG. 29, Doppler shift amounts DOPₙ₁(1) and DOPₙ₂(2) applied to respective transmission antennas 102 of first radar section 10h and second radar section 10h are set so that the Doppler shift amounts do not match each other between first radar section 10h and second radar section 10h (for example, so as to satisfy Expression 39).

Further, for example, regarding the Doppler shifts set for first radar section 10h illustrated in FIG. 29, a Doppler shift for providing an interval of Δfd(1) is not assigned on the negative side and thus a non-uniform Doppler multiplexing interval portion is included. For example, the Doppler shift interval set in first radar section 10h is set to one of intervals obtained by unequally dividing the Doppler frequency range to be subjected to the Doppler analysis.

In the Doppler frequency domain, the position where no Doppler shift is assigned is not limited to the negative-side region as illustrated in FIGS. 28 and 29, and may be a positive-side region.

### Setting Example 3

For example, in the case of N_{DM}(1)=N_{DM}(2), the above-described setting conditions for Doppler multiplexing intervals are satisfied when Δfd(1)=1/(Tᵣ×N_{colen}×N_{DM}(1)) and Δfd(2)=1/(Tᵣ× N_{colen}×(N_{DM}(2)+1)) are set, when Δfd(1)=1/(Tᵣ×N_{colen}×(N_{DM}(1)+1)) and Δfd(2)=1/(Tᵣ×N_{colen}×N_{DM}(2)) are set, or when Δfd(1)=1/(Tᵣ×N_{colen}×(N_{DM}(1)+1)) and Δfd(2)=1/(Tᵣ×N_{colen}×(N_{DM}(1)+2)) are set.

In this case, the Doppler multiplexing interval can be maximized within the range of −1/(2Tᵣ×N_{colen})≤f_{d}<1/(2Tᵣ×N_{colen}) of Doppler frequencies f_{d} observed by Doppler analyzers 209. Therefore, for example, even in a case where the Doppler spectrum has a spread, such as a case where the moving speed of the target is not constant and has a component such as acceleration, the interference effect between the Doppler multiplexed signals can be reduced. Further, for example, when the Doppler multiplexing intervals include a non-uniform part, the Doppler velocity observable by using the non-uniform Doppler intervals is −1/(2Tᵣ×N_{colen})≤f_{d}<1/(2Tᵣ×N_{colen}) as disclosed in PTL 1.

By way of example, FIG. 30 illustrates an example of Doppler shift setting of first radar section 10h (upper part of FIG. 30) and an example of Doppler shift setting of second radar section 10h (lower part of FIG. 30) in a case of N_{DM}(1)=2 and N_{DM}(2)=2. In FIG. 30, Δfd(1)=1/(3Tᵣ×N_{colen}) (e.g., δ₁=1) is set and Δfd(2)=1/(4Tᵣ×N_{colen}) (e.g., δ₂=2) is set. For example, in FIG. 30, Doppler shift amounts DOP₁(1) and DOP₁(2) assigned to the first Doppler multiplexed signals of first radar section 10h and second radar section 10h are set to values corresponding to Doppler frequency f_{d}=0. For example, in FIG. 30, at least one Doppler shift amounts match each other between first radar section 10h and second radar section 10h.

Further, for example, regarding the Doppler shifts set for first radar section 10h illustrated in FIG. 30, a Doppler shift for providing an interval of Δfd(1) is not assigned on the negative side and thus a non-uniform Doppler multiplexing interval portion is included. Further, for example, regarding the Doppler shifts set for second radar section 10h illustrated in FIG. 30, two Doppler shifts for providing an interval of Δfd(2) are not assigned on the negative side and thus a non-uniform Doppler multiplexing interval portion is included. For example, the Doppler shift interval set for each of first radar section 10h and second radar section 10h is set to one of intervals obtained by unequally dividing the Doppler frequency range to be subjected to the Doppler analysis.

By way of another example, FIG. 31 illustrates an example of Doppler shift setting of first radar section 10h (upper part of FIG. 31) and an example of Doppler shift setting of second radar section 10h (lower part of FIG. 31) in the case of N_{DM}(1)=2 and N_{DM}(2)=2. In FIG. 31 as in FIG. 30, Δfd(1)=1/(3Tᵣ×N_{colen}) (e.g., δ₁=1) is set and Δfd(2)=1/(4Tᵣ×N_{colen}) (e.g., 82-2) is set. Further, in FIG. 31, Doppler shift amounts DOPₙ₁(1) and DOPₙ₂(2) applied to respective transmission antennas 102 of first radar section 10h and second radar section 10h are set so that the Doppler shift amounts do not match each other between first radar section 10h and second radar section 10h (for example, so as to satisfy Expression 39).

Further, for example, regarding the Doppler shifts set for first radar section 10h illustrated in FIG. 31, a Doppler shift for providing an interval of Δfd(1) is not assigned on the negative side and thus a non-uniform Doppler multiplexing interval portion is included. Further, for example, regarding the Doppler shifts set for second radar section 10h illustrated in FIG. 31, two Doppler shifts for providing an interval of Δfd(2) are not assigned on the positive side and thus a non-uniform Doppler multiplexing interval portion is included. For example, the Doppler shift interval set for each of first radar section 10h and second radar section 10h is set to one of intervals obtained by unequally dividing the Doppler frequency range to be subjected to the Doppler analysis.

The example of setting the Doppler shift amounts have been described above.

For example, Doppler shifters 101 may set the Doppler shift amount using the Doppler multiplexing interval set as described above, and apply the phase rotation for applying the Doppler shift amount to the chirp signal at each chirp transmission period.

For example, phase rotations Φ_{n,q}(m) for applying Doppler shift amounts DOPₙ(q) for Doppler shift intervals Δfd(q) to N_{DM}(q) Doppler multiplexed signals are expressed by following Expression 40. Expression 41 represents Doppler shift amounts DOPₙ(q) for Doppler shift intervals Δfd(q).

$$\begin{matrix}( Expression 40 ) & \\ {ϕ}_{n , q} ( m ) = \{ 2 π {N}_{c o l e n} {T}_{r} \times {DOP}_{n} ( q ) + Δ {ϕ}_{0} \} floor [ \frac{( m - 1 )}{{N}_{colen}} ] + {ϕ}_{0} = \{ 2 π {N}_{colen} {T}_{r} \times Δ {f}_{d} ( q ) ( n - α ) + Δ {ϕ}_{0} \} floor [ \frac{( m - 1 )}{{N}_{colen}} ] + {ϕ}_{0} & ( 40 )\end{matrix}$$

$$\begin{matrix}( Expression 41 ) & \\ {DOP}_{n} ( q ) = Δ {f}_{d} ( q ) ( n - α ) & ( 41 )\end{matrix}$$

In the expression, Φ₀ is the initial phase and ΔΦ₀ is a reference Doppler shift phase. Note that α is a coefficient for offsetting the Doppler shift amount for each Doppler multiplexed signal and a real value may be used for the coefficient. For example, when α=1, the Doppler shift amount for the first Doppler multiplexed signal is zero. In addition, floor[x] represents the floor function outputting the minimum integer less than or equal to real number x. As illustrated in Expression 40, Doppler shifters 101 perform transmission by applying the same phase rotation within a period (e.g., a transmission period of N_{colen}×Tᵣ) of code length N_{colen} for code multiplexing.

The exemplary operation of Doppler shifters 101 has been described above.

### [Exemplary Operation of Code Multiplexing Controller 107]

Code multiplexing controller 107 presets number CodeDop(n) of code multiplexing for each of N_{DM}(q) Doppler multiplexed signals, and assigns codes such that the sum of the numbers of code multiplexing matches number Nt of transmission antennas 102 used for multiplexing transmission. Here, n is an integer of from 1 to N_{DM}(q). In addition, CodeDop(n) is set as an integer value within the range of 1≤CodeDop(n)≤N_{code}.

For example, CodeDop(1)=2 and CodeDop(2)=2 are set when the number of code multiplexing is 2 for each Doppler multiplexed signal for which number Nt of transmission antennas used for multiplexing transmission is 4, Ncode is 2, and N_{DM}(q) is 2. In this case, the sum of CodeDop(n) matches Nt of transmission antennas (=4) used for multiplexing transmission.

Further, CodeDop(1)=2, CodeDop(2)=2, and CodeDop(2)=1 are set, for example, when the number of code multiplexing is 2 for each Doppler multiplexed signal for which number Nt of transmission antennas used for multiplexing transmission is 5, N_{code} is 2, and N_{DM}(q) is 3. In this case, the sum of CodeDop(n) corresponds to number Nt of transmission antennas (=5) used for multiplexing transmission.

For example, code multiplexing controller 107 may use an orthogonal code sequence having code length N_{colen}.

In the following, the orthogonal code sequence with code length N_{colen} is denoted as Code_{ncm}={OC_{ncm}(1), OC_{ncm}(2), . . . , and OC_{ncm}(N_{colen})}. OC_{ncm}(noc) represents the nocth code element in ncmth orthogonal code sequence Code_{ncm}. Here, noc is the index of the code element and is an integer of noc=1 to N_{colen}. N_{cm} represents the number of orthogonal code sequences with code length N_{colen}, and the orthogonal codes are used such that N_{code}≤ N_{cm}. The orthogonal code sequences may be, for example, codes that are orthogonal (uncorrelated) to each other. For example, the orthogonal code sequences may be Walsh-Hadamard codes.

For example, when N_{code}=2, the Walsh-Hadamard codes with code length N_{colen}=2 may be used. In this instance, the orthogonal code sequences are Code₁={1, 1} and Code₂={1, −1}. Note that, when a code element constituting the orthogonal code sequences is 1, 1=exp(j0) holds true and, thus, the phase thereof is 0. In addition, when a code element constituting the orthogonal code sequences is −1, −1=exp(jπ) holds true and, thus, the phase thereof is π.

For example, when N_{code} is 4, the Walsh-Hadamard-codes with code length N_{colen}=4 may be used. In this case, the orthogonal code sequences are Code₁={1, 1, 1, 1}, Code₂={1−1, 1, −1}, Code₃={1, 1−1, −1} and Code₄={1−1−1, 1}. For example, when CodeDop(1)=2, code multiplexing controller 107 may assign Code to the first code and Code₂ to the second code, for example, to further perform code multiplexing on the Doppler multiplexed signals.

For example, code multiplexer 108 assigns a code to an output signal of nth Doppler shifter 101 under the control of code multiplexing controller 107. For example, code multiplexer 108 may apply the phase rotation illustrated in following Expression 42 to the output signal of nth Doppler shifter 101:

$$\begin{matrix}( Expression 42 ) & \\ {ψ}_{ndopcode ( n ) , n , q} ( m ) = angle [ {OC}_{ndopcode ( n )} ( OCindex ( m ) ) ] OCindex ( m ) = mod ( m - 1 , {N}_{colen} ) + 1. & ( 42 )\end{matrix}$$

Here, Ψ_{ndopcode(n),n,q}(m) represents phase rotations for applying code multiplexing to the output of nth Doppler shifter 101 in mth transmission period in qth radar section 10h. Here, ndopcode(n) is assigned to the output of nth Doppler shifter 101 under the control of code multiplexing controller 107 and represents the index of the code, and is an integer of ndopcode(n)=1 to CodeDop(n). For example, when ndopcode(n)=1, a phase rotation by using the code of Code may be applied.

Here, angle[x] is an operator outputting the radian phase of real number x, and for example, angle[1]=0, angle[−1]=π, angle[j]=π/2, and angle[−j]=π/2. In addition, floor[x] is an operator that outputs the largest integer that does not exceed real number x. The character “j” is an imaginary unit. Here, mod(x, y) denotes a modulo operator and is a function that outputs the remainder after x is divided by y. In addition, m is an integer from 1 to N_{c}. N_{c} is the number of transmission periods used for radar positioning.

For example, when N_{DM}(1)=N_{DM}(2)=3, ΔΦ₀=0, Φ₀=0, δ₁=1, and δ₂=2, it is possible to perform MIMO multiplexing transmission using five transmission antennas 102 in a case where N_{colen}=2, CodeDop(1)=1, CodeDop(2)=2, and CodeDop(3)=2 are set in both first radar section 10h and second radar section 10h. For example, the Doppler multiplexing intervals are set to Δfd(1)=1/(4TᵣN_{colen}) and Δfd(2)=1/(5TᵣN_{colen}). Further, for example, when α=1, Doppler shift amount DOPₙ(q) corresponding to nth transmission antenna 102 is expressed by following Expression 43:

$$\begin{matrix}( Expression 43 ) & \\ {DOP}_{n} ( q ) = Δ {f}_{d} ( q ) ( n - 1 ) . & ( 43 )\end{matrix}$$

Further, for example, phase rotations Φ_{n,q}(m) for applying, to input mth chirp signals, Doppler shift amounts DOPₙ(q) different for respective nth Doppler multiplexed signals (n=1, 2, or 3) and phase rotations Ψ_{ndopcode(n),n,q}(m) applied to the output signal of nth Doppler shifter 101 of qth radar section 10h are expressed by following Expression 44:

$$\begin{matrix}( Expression 44 ) & \\ {ϕ}_{1 , 1} ( m ) = 0 , {ϕ}_{2 , 1} ( m ) = \frac{π}{2} floor [ \frac{( m - 1 )}{{N}_{colen}} ] , {ϕ}_{3 , 1} ( m ) = π floor [ \frac{( m - 1 )}{{N}_{colen}} ] , & ( 44 )\end{matrix}$$

$${ϕ}_{1 , 2} ( m ) = 0 , {ϕ}_{2 , 2} ( m ) = \frac{2 π}{5} floor [ \frac{( m - 1 )}{{N}_{colen}} ] , {ϕ}_{3 , 2} ( m ) = \frac{4 π}{5} floor [ \frac{( m - 1 )}{{N}_{colen}} ]$$

$${ψ}_{1 , 1 , 1} ( m ) = angle [ {OC}_{1} ( OCindex ( m ) ) ]$$

$${ψ}_{1 , 2 , 1} ( m ) = angle [ {OC}_{1} ( OCindex ( m ) ) ]$$

$${ψ}_{2 , 2 , 1} ( m ) = angle [ {OC}_{2} ( OCindex ( m ) ) ]$$

$${ψ}_{1 , 3 , 1} ( m ) = angle [ {OC}_{1} ( OCindex ( m ) ) ]$$

$${ψ}_{2 , 3 , 1} ( m ) = angle [ {OC}_{2} ( {OC}_{index} ( m ) ) ] .$$

For example, when first radar section 10h performs transmission using Doppler multiplexing and code multiplexing using number Nt=5 of transmission antennas, first Doppler shifter 101 applies phase rotation Φ1,1(m) and first code multiplexer 108 applies phase rotation Ψ_{1,1,1}(m) to the chirp signal inputted from synchronization controller 20 at each transmission period in first radar section 10h as given in following Expression 45. The output of first code multiplexer 108 is output from, for example, first transmission antenna 102 (Tx #1). Here, cp(t) denotes the chirp signal for each transmission period.

$$\begin{matrix}( Expression 45 ) & \\ exp \{ j [ {ϕ}_{1 , 1} ( 1 ) + {ψ}_{1 , 1 , 1} ( 1 ) ] \} c p ( t ) , exp \{ [ j {ϕ}_{1 , 1} ( 2 ) + {ψ}_{1 , 1 , 1} ( 2 ) ] \} c p ( t ) , … , exp \{ [ j {ϕ}_{1 , 1} ( {N}_{c} ) + {ψ}_{1 , 1 , 1} ( {N}_{c} ) ] \} c p ( t ) & ( 45 )\end{matrix}$$

Further, for example, second Doppler shifter 101 applies phase rotation Φ_{2,1}(m) and first code multiplexer 108 applies phase rotation Ψ_{1,2,1}(m) to the chirp signal inputted from synchronization controller 20 at each transmission period in first radar section 10h as given by following Expression 46. The output of first code multiplexer 108 is output from second transmission antenna 102 (Tx #2).

$$\begin{matrix}( Expression 46 ) & \\ exp \{ j [ {ϕ}_{2 , 1} ( 1 ) + {ψ}_{1 , 2 , 1} ( 1 ) ] \} c p ( t ) , exp \{ [ j {ϕ}_{2 , 1} ( 2 ) + {ψ}_{1 , 2 , 1} ( 2 ) ] \} c p ( t ) , … , exp \{ [ j {ϕ}_{2 , 1} ( {N}_{c} ) + {ψ}_{1 , 2 , 1} ( {N}_{C} ) ] \} c p ( t ) & ( 46 )\end{matrix}$$

Further, for example, second Doppler shifter 101 applies phase rotation Φ_{2,1}(m) and second code multiplexer 108 applies phase rotation Ψ_{2,2,1}(m) to the chirp signal inputted from synchronization controller 20 in first radar section 10h for each transmission period as given by following Expression 47. The output of second code multiplexer 108 is output from third transmission antenna 102 (Tx #3).

$$\begin{matrix}( Expression 47 ) & \\ exp \{ j [ {ϕ}_{2 , 1} ( 1 ) + {ψ}_{2 , 2 , 1} ( 1 ) ] \} c p ( t ) , exp \{ [ j {ϕ}_{2 , 1} ( 2 ) + {ψ}_{2 , 2 , 1} ( 2 ) ] \} c p ( t ) , … , exp \{ [ j {ϕ}_{2 , 1} ( {N}_{c} ) + {ψ}_{2 , 2 , 1} ( {N}_{c} ) ] \} c p ( t ) & ( 47 )\end{matrix}$$

Further, for example, third Doppler shifter 101 applies phase rotation Φ_{3,1}(m) and first code multiplexer 108 applies phase rotation Ψ_{1,3,1}(m) to the chirp signal inputted from synchronization controller 20 at each transmission period in first radar section 10h as given by following Expression 48. The output of first code multiplexer 108 is output from fourth transmission antenna 102 (Tx #4).

$$\begin{matrix}( Expression 48 ) & \\ exp \{ j [ {ϕ}_{3 , 1} ( 1 ) + {ψ}_{1 , 3 , 1} ( 1 ) ] \} c p ( t ) , exp \{ [ j {ϕ}_{3 , 1} ( 2 ) + {ψ}_{1 , 3 , 1} ( 2 ) ] \} c p ( t ) , … , exp \{ [ j {ϕ}_{3 , 1} ( {N}_{c} ) + {ψ}_{1 , 3 , 1} ( {N}_{c} ) ] \} c p ( t ) & ( 48 )\end{matrix}$$

Further, for example, third Doppler shifter 101 applies phase rotation Φ_{3,1}(m) and second code multiplexer 108 applies phase rotation Ψ_{2,3,1}(m) to the chirp signal inputted from synchronization controller 20 at each transmission period in first radar section 10h as given by following Expression 49. The output of second code multiplexer 108 is output from fifth transmission antenna 102 (Tx #5).

$$\begin{matrix}( 49 ) & \\ exp \{ j [ {ϕ}_{3 , 1} ( 1 ) + {ψ}_{2 , 3 , 1} ( 1 ) ] \} cp ( t ) , exp \{ [ j {ϕ}_{3 , 1} ( 2 ) + {ψ}_{2 , 3 , 1} ( 2 ) ] \} cp ( t ) , … , exp \{ [ j {ϕ}_{3 , 1} ( {N}_{c} ) + {ψ}_{2 , 3 , 1} ( {N}_{c} ) ] \} cp ( t ) & ( Expression 49 )\end{matrix}$$

Further, for example, when second radar section 10h performs transmission using Doppler multiplexing and code multiplexing using number Nt=5 of transmission antennas, first Doppler shifter 101 applies phase rotation Φ_{1,2}(m) and first code multiplexer 108 applies phase rotation Ψ_{1,1,2}(m) to the chirp signal inputted from synchronization controller 20 at each transmission period in second radar section 10h as given in following Expression 50. The output of first code multiplexer 108 is output from, for example, first transmission antenna 102 (Tx #1). Here, cp(t) denotes the chirp signal for each transmission period.

$$\begin{matrix}( 50 ) & \\ exp \{ j [ {ϕ}_{1 , 2} ( 1 ) + {ψ}_{1 , 1 , 2} ( 1 ) ] \} cp ( t ) , exp \{ [ j {ϕ}_{1 , 2} ( 2 ) + {ψ}_{1 , 1 , 2} ( 2 ) ] \} cp ( t ) , … , exp \{ [ j {ϕ}_{1 , 2} ( {N}_{c} ) + {ψ}_{1 , 1 , 2} ( {N}_{c} ) ] \} cp ( t ) & ( Expression 50 )\end{matrix}$$

Further, for example, second Doppler shifter 101 applies phase rotation Φ_{2,2}(m) and first code multiplexer 108 applies phase rotation Ψ_{1,2,2}(m) to the chirp signal inputted from synchronization controller 20 at each transmission period in second radar section 10h as given by following Expression 51. The output of first code multiplexer 108 is output from second transmission antenna 102 (Tx #2).

$$\begin{matrix}( 51 ) & \\ exp \{ j [ {ϕ}_{2 , 2} ( 1 ) + {ψ}_{1 , 2 , 2} ( 1 ) ] \} cp ( t ) , exp \{ [ j {ϕ}_{2 , 2} ( 2 ) + {ψ}_{1 , 2 , 2} ( 2 ) ] \} cp ( t ) , … , exp \{ [ j {ϕ}_{2 , 2} ( {N}_{c} ) + {ψ}_{1 , 2 , 2} ( {N}_{c} ) ] \} cp ( t ) & ( Expression 51 )\end{matrix}$$

Further, for example, second Doppler shifter 101 applies phase rotation Φ_{2,2}(m) and second code multiplexer 108 applies phase rotation Ψ_{2,2,2}(m) to the chirp signal inputted from synchronization controller 20 at each transmission period in second radar section 10h as given by following Expression 52. The output of second code multiplexer 108 is output from third transmission antenna 102 (Tx #3).

$$\begin{matrix}( 52 ) & \\ exp \{ j [ {ϕ}_{2 , 2} ( 1 ) + {ψ}_{2 , 2 , 2} ( 1 ) ] \} cp ( t ) , exp \{ [ j {ϕ}_{2 , 2} ( 2 ) + {ψ}_{2 , 2 , 2} ( 2 ) ] \} cp ( t ) , … , exp \{ [ j {ϕ}_{2 , 2} ( {N}_{c} ) + {ψ}_{2 , 2 , 2} ( {N}_{c} ) ] \} cp ( t ) & ( Expression 52 )\end{matrix}$$

Further, for example, third Doppler shifter 101 applies phase rotation Φ_{3,2}(m) and first code multiplexer 108 applies phase rotation Ψ_{1,3,2}(m) to the chirp signal inputted from synchronization controller 20 at each transmission period in second radar section 10h as given by following Expression 53. The output of first code multiplexer 108 is output from fourth transmission antenna 102 (Tx #4).

$$\begin{matrix}( 53 ) & \\ exp \{ j [ {ϕ}_{3 , 2} ( 1 ) + {ψ}_{1 , 3 , 2} ( 1 ) ] \} cp ( t ) , exp \{ [ j {ϕ}_{3 , 2} ( 2 ) + {ψ}_{1 , 3 , 2} ( 2 ) ] \} cp ( t ) , … , exp \{ [ j {ϕ}_{3 , 2} ( {N}_{c} ) + {ψ}_{1 , 3 , 2} ( {N}_{c} ) ] \} cp ( t ) & ( Expression 53 )\end{matrix}$$

Further, for example, third Doppler shifter 101 applies phase rotation Φ_{3,2}(m) and second code multiplexer 108 applies phase rotation Ψ_{2,3,2}(m) to the chirp signal inputted from synchronization controller 20 at each transmission period in second radar section 10h as given by following Expression 54. The output of second code multiplexer 108 is output from fifth transmission antenna 102 (Tx #5).

$$\begin{matrix}( 54 ) & \\ exp \{ j [ {ϕ}_{3 , 2} ( 1 ) + {ψ}_{2 , 3 , 2} ( 1 ) ] \} cp ( t ) , exp \{ [ j {ϕ}_{3 , 2} ( 2 ) + {ψ}_{2 , 3 , 2} ( 2 ) ] \} cp ( t ) , … , exp \{ [ j {ϕ}_{3 , 2} ( {N}_{c} ) + {ψ}_{2 , 3 , 2} ( {N}_{c} ) ] \} cp ( t ) & ( Expression 54 )\end{matrix}$$

As described above, setting the Doppler multiplexing intervals and application of code multiplexing for each of first radar section 10h and second radar section 10h are performed such that the above-described setting conditions for Doppler multiplexing intervals are satisfied. It is thus possible for radar sections 10h to perform multiplexing transmission using a larger number of transmission antennas.

Further, since the number of Doppler multiplexing is less than the number of transmission antennas, the Doppler components corresponding to the reflected wave signals for the radar transmission signals from first radar section 10h and second radar section 10h are more likely to appear at different positions within the range of −1/(2Tᵣ×N_{colen})≤f_{d}<1/(2Tᵣ×N_{colen}) of Doppler frequencies f_{d} observed in Doppler analyzers 209. Thus, it becomes easier to separate the radar reflected waves (reception signals) corresponding to first radar section 10h and second radar section 10h from each other.

By way of example, FIG. 32 illustrates an example of a case where all the powers of outputs (for example, received Doppler frequencies) of first to N_{colen}th Doppler analyzers 209 are added in a case where the reflected wave signals for the radar transmission signals from first radar section 10h and second radar section 10h are received. In FIG. 32, the vertical axis represents the distance axis, and the horizontal axis represents the Doppler frequency axis. Further, in FIG. 32, Doppler components having high power are represented by arrows.

Doppler-multiplexed and code-multiplexed radar transmission signals are transmitted from a plurality of transmission antennas 102. Since different Doppler shifts are applied respectively to the radar transmission signals, the reception quality (e.g., Signal to Noise Ratio (SNR)) can be improved and the accuracy of distinguishing (or detecting) the Doppler multiplexing intervals Δfd(1) and Δfd(2) can be enhanced by adding all the powers of the outputs of first to N_{colen}th Doppler analyzers 209. Further, since the radar transmission signals are transmitted using different Doppler multiplexing intervals for each of first radar section 10h and second radar section 10h, radar apparatus 1h can distinguish, based on the Doppler multiplexing intervals, whether the reflected wave signals for the radar transmission signals are reflected wave signals for the radar transmission signals of first radar section 10h or of second radar section 10h.

When the Doppler components corresponding to the intervals of Δfd(1) (1/(3Tᵣ×N_{colen}) in the example of FIG. 32) or the Doppler components corresponding to an integer multiple of intervals Δfd(1) are observed at distance index fb1 or fb2 illustrated in FIG. 32, radar apparatus 1h can distinguish (or detect) that these Doppler components are reflected wave signals for the radar transmission signals transmitted from first radar section 10h.

Further, when the Doppler components corresponding to the intervals of Δfd(2) (1/(4Tᵣ×N_{colen}) in the example of FIG. 32) or the Doppler components corresponding to an integer multiple of intervals Δfd(2) are observed at distance index fb3 or fb4 illustrated in FIG. 32, radar apparatus 1h can distinguish that these Doppler components are reflected wave signals for the radar transmission signals transmitted from second radar section 10h.

Further, when a Doppler component that matches interval Δfd(1) (or an integer multiple of Δfd(1)) and a Doppler component that matches the interval of Δfd(2) (or an integer multiple of Δfd(2)) are observed in a mixed manner at distance index fb5 illustrated in FIG. 32, radar apparatus 1h can distinguish the reflected wave signals for the radar transmission signals transmitted from first radar section 10 and the reflected wave signals for the radar transmission signals transmitted from second radar section 10, for example, based on the intervals of the Doppler components.

As described above, radar apparatus 1h can distinguish whether the observed Doppler components are the reflected wave signals for the radar transmission signals transmitted from the radar section of first radar section 10h or from second radar section 10h, based on the difference between the Doppler multiplexing intervals of the Doppler multiplexing transmissions in first radar section 10h and the Doppler multiplexing intervals of the Doppler multiplexing transmissions in second radar section 10h.

The exemplary operation of Doppler shifters 101, code multiplexing controller 107, and code multiplexers 108 have been described above.

Next, an exemplary operation of first CFAR section 210, second CFAR section 210, first Doppler demultiplexer 211, and second Doppler demultiplexer 211 in qth radar section 10h corresponding to the operation of Doppler shifters 101 will be described.

### [Exemplary Operation of First CFAR Section 210]

For example, first first CFAR section 210 of qth radar section 10h may perform the following operations in order to receive radar reflected waves for radar transmission signals from radar transmitter 100h of qth radar section 10h.

For example, when δ₁ and δ₂ are set in Doppler shifters 101 to values that differ from positive integers, first CFAR section 210 may perform peak detection, for example, by searching for a power peak that matches the Doppler shift interval set for the radar transmission signals of qth radar section 10h, and by performing adaptive threshold processing (CFAR processing), the search being performed for each distance index on an output value obtained by adding all the powers of the outputs from first to N_{colen}th Doppler analyzers 209 of first to Na(q)th signal processors 206.

On the other hand, for example, when δ₁ and δ₂ are set to positive integers for Doppler shifters 101, an interval of Δfd(q) or an interval of an integer multiple of Δfd(q) is used as an interval of the Doppler shift amounts. In this case, q may be 1 or 2. Therefore, the reception quality (e.g., SNR) of the output value obtained by adding all the powers f the outputs of first to N_{colen}th Doppler analyzers 209 can be enhanced. Further, Doppler multiplexed signals can be detected as aliasing at an interval of Δfd(q) in the Doppler frequency domain of the outputs of Doppler analyzers 209. By using such characteristics, for example, the operation of first CFAR section 210 can be simplified as follows.

For example, first CFAR section 210 of qth radar section 10h detects a Doppler peak by applying a threshold to a power addition value obtained by adding together the reception powers of the reflected wave signals for respective ranges (for example, ranges of Δfd(q)) within the Doppler frequency range to be subjected to the CFAR processing in the output value obtained by performing power addition on all the outputs of first to N_{colen}th Doppler analyzers 209, the ranges corresponding to the intervals of the Doppler shift amounts applied respectively to the radar transmission signals.

For example, first CFAR section 210 performs the CFAR processing on the output obtained by power addition of all the outputs from first to N_{colen}th Doppler analyzers 209 of first to Na(q)th signal processors 206, by calculating power addition value PowerDDM_{q}(f_{b}, f_{sddm}) obtained by adding power values PowerFT_{q}(f_{b}, fₛ) at the intervals of Δfd(q) (for example, corresponding to NΔfd(q)) as illustrated in following Expressions 55 and 56:

$$\begin{matrix}( 55 ) & \\ {PowerDDM}_{q} ( {f}_{b} , {f}_{sddm} ) = {\sum }_{ndm = 1}^{{N}_{DM} ( q ) + {δ}_{q}} {PowerFT}_{q} ( {f}_{b} , {f}_{sddm} + ( ndm - 1 ) \times {N}_{Δ {f}_{d} ( q )} ) ; and & ( Expression 55 )\end{matrix}$$

$$\begin{matrix}( 56 ) & \\ {PowerFT}_{q} ( {f}_{b} , {f}_{s} ) = {\sum }_{n = 1}^{{N}_{colen}} {\sum }_{z = 1}^{{N}_{a}} {\vert {VFT}_{n , z , q} ( {f}_{b} , {f}_{s} ) \vert}^{2} . & ( Expression 56 )\end{matrix}$$

In the expressions, f_{sddm}=−Nₛ/2, . . . , and −Nₛ/2+N_{Δfd(q)}−1 holds true and N_{Δfd(q)}=round(Δfd(q)/(1/(TᵣNₛ) also holds true. In addition, round(x) is an operator that rounds off real number x and outputs an integer value.

The operation in the CFAR processing may be based on the operation disclosed in NPL 3, for example, and detailed explanation of the exemplary operation is omitted.

Accordingly, the range of the Doppler frequencies subjected to the CFAR processing in first CFAR section 210 can be set (for example, reduced) to 1/(N_{DM}(q)+δ_{q}) of the entire range (for example, the range of from −Nₛ/2 to Nₛ/2−1). It is thus possible to reduce the computational amount of the CFAR processing.

For example, first CFAR section 210 adaptively sets a threshold, and outputs, to first Doppler demultiplexer 211, distance indices f_{b_cfar}, Doppler frequency indices f_{sddm_cfar}, and the reception power information (PowerFT(f_{b_cfar}, f_{sddm_cfar}+(ndm−1)×NΔfd(q))) that provide reception power greater than the threshold. In the expression, ndm is an integer of from 1 to N_{DM}(q)+δ_{q}.

### [Exemplary Operation of First Doppler Demultiplexer 211]

First Doppler demultiplexer 211 performs the following operations, for example, based on distance indices f_{b_cfar}, Doppler frequency indices f_{sddm_cfar}, and the reception power information (PowerFT(f_{b_cfar}, f_{sddm_cfar}+(ndm−1)×NΔfd(q))) (ndm is an integer of from 1 to N_{DM}(q)+δ_{q})) inputted from first CFAR section 210.

<(1) Case of δ_{q}=0>

For example, assuming that the Doppler velocity of the target object is −1/(2Tᵣ×N_{colen}×N_{DM}(q))≤f_{d}<1/(2Tᵣ×N_{colen}×N_{DM}(q)), first Doppler demultiplexer 211 associates the Doppler shift amounts of the Doppler multiplexed signals to be transmitted with f_{sddm_cfar}+(ndm−1)×NΔfd(q), and outputs, to first code separator 215, the resulting demultiplexing index information (f_{demul#1}(q), . . . , and f_{demul_#NDM}(q)) of the Doppler multiplexed signals.

Here, f_{demul_#n(q)} indicates the Doppler frequency index of the reflected wave signal corresponding to the nth Doppler multiplexed signal of qth radar 10h.

By way of example, a Doppler shift setting example illustrated in FIG. 26 in which N_{DM}(1)=Nt(1)=3 and N_{DM}(2)=Nt(2)=4 will be described. In this case, Δfd(1)=1/(3Tᵣ×N_{colen}) and Δfd(2)=1/(4Tᵣ×N_{colen}).

Here, it may be assumed that the Doppler frequency of the reflected wave signal for the radar transmission signal transmitted from first radar section 10h, which is received by first radar section 10h, is −1/(2Tᵣ×N_{colen}×N_{DM}(1))≤f_{d}<1/(2Tᵣ×N_{colen}×N_{DM}(1)). Therefore, in FIG. 26, the demultiplexing index information (fdemul_#1(1), f_{demul_#2}(1), and f_{demul_#3}(1)) of the Doppler multiplexed signals for f_{sddm_cfar}+(ndm−1)×N_{Δfd(1)} has a correspondence relation of f_{demul_#3}(1)<f_{demul_#1}(1)<f_{demul#2}(1). First Doppler demultiplexer 211 may, for example, output each of f_{sddm_cfar}+(ndm−1)×N_{Δfd(1)} (ndm is an integer of from 1 to 3) as f_{demul_#3}(1), f_{demul_#1}(1), and f_{demul_#2}(1).

Similarly, it may be assumed that the Doppler frequency of the reflected wave signal for the radar transmission signal transmitted from second radar section 10h, which is received by second radar section 10h, is −1/(2Tᵣ×N_{colen}×N_{DM}(2))≤f_{d}<1/(2Tᵣ×N_{colen}×N_{DM}(2)). Therefore, the demultiplexing index information (f_{demul_#1}(2), f_{demul_#2}(2), f_{demul_#3}(2), and f_{demul_#4}(2)) of the Doppler multiplexed signals for f_{sddm_cfar}+(ndm−1)×N_{Δfd}(2) has a correspondence relation of f_{demul_#3}(2)<f_{demul_#4}(2)<f_{demul_#1}(2)<f_{demul_#2}(2) when 0≤f_{d}<1/(2Tᵣ×N_{colen}×N_{DM}(1)). When −1/(2Tᵣ×N_{colen}×N_{DM}(1))≤f_{d}<0), the correspondence relation of f_{demul_#4}(2)<f_{demul_#1}(2)<f_{demul_#2}(2)<f_{demul_#3}(2) is obtained. First Doppler demultiplexer 211 may, for example, output each of f_{sddm_cfar}+(ndm−1)×N_{Δfd(2)} (ndm is an integer of from 1 to 4) as f_{demul_#3}(2), f_{demul_#4}(2), fdemul_#1(2), and f_{demul_#2}(2).

When a difference between the powers for N_{DM}(q) Doppler frequency indices is larger than a predetermined value (for example, a threshold), first Doppler demultiplexer 211 may regard (or determine) that the components of the reception signal for the multistatic configuration are highly likely to be mixed, and may add an operation of removing a reception signal without outputting the reception signal to subsequent processing (for example, direction estimation processing).

<(2) Case of δ_{q}>0>

For example, it may be assumed that the Doppler velocity of the target object is −1/(2Tᵣ×N_{colen})≤f_{d}<1/(2Tᵣ×N_{colen}). Further, a large difference between, on one hand, the reception levels for top N_{DM}(q) Doppler frequency indices of reception power and, on the other hand, the reception levels for δ_{q} Doppler frequency indices different from the top N_{DM} Doppler frequency indices of reception power (for example, the difference being equal to or greater than the threshold) may be used. For example, first Doppler demultiplexer 211 compares the reception power information inputted from first CFAR section 210 and determines the Doppler frequency in the range of −1/(2Tᵣ×N_{colen})≤f_{d}<1/(2Tᵣ×N_{colen}). Note that an exemplary operation of first Doppler demultiplexer 211 is disclosed in, for example, PTL 1, and therefore description of the exemplary operation is omitted here.

For example, first Doppler demultiplexer 211 associates the Doppler shift amounts of the transmitted Doppler multiplexed signals with f_{sddm_cfar}+(ndm−1)×N_{Δfd(q)} based on the relation between δ_{q} Doppler frequency indices of a lower reception level and top N_{DM} Doppler frequency indices of a higher reception power, and performs an output to first code separator 215 as demultiplexing index information (f_{demul_#1}(q), . . . , and f_{demul_#NDM}(q)) of the Doppler multiplexed signals.

Here, f_{demul_#n(q)} represents the Doppler frequency index of the reflected wave signal corresponding to nth Doppler multiplexed signal of qth radar section 10h.

By way of example, FIG. 33 illustrates an example of an output (for example, a reception Doppler frequency) of Doppler analyzer 209 in a case where a reflected wave signal with respect to a radar transmission signal from first radar section 10h is received. In FIG. 33, the vertical axis represents the distance axis, and the horizontal axis represents the Doppler frequency axis.

For example, when the Doppler components corresponding to interval Δfd(1) or the Doppler components corresponding to an integer multiple of interval Δfd(1) are observed at distance index fb1 illustrated in FIG. 33, first Doppler demultiplexer 211 can distinguish (for example, detect) that these Doppler components are reflected wave signals for radar transmission signals transmitted from first radar section 10h.

Further, for example, in FIG. 33, δ_{q} (=1) Doppler frequency index for a lower reception level is indicated by mark “o,” and top N_{DM} (=2) Doppler frequency indices of reception power are indicated by marks “x” and “Δ.” For example, since the Doppler components (mark “o” in FIG. 33) that do not match the interval of Δfd(1) is uniquely determined in the range of −1/(2Tᵣ×N_{colen})≤f_{d}<1/(2Tᵣ×N_{colen}), first Doppler demultiplexer 211 can uniquely determine the Doppler velocity of the target object in the range of −1/(2Tᵣ×N_{colen})≤f_{d}<1/(2Tᵣ×N_{colen}).

Further, first Doppler demultiplexer 211 can determine the association between the Doppler frequencies and the Doppler multiplexed signals, for example, based on the magnitude relationship between the Doppler frequency indices (mark “o” in FIG. 33) that do not match the interval of Δfd(1) and other Doppler frequency indices (marks “x” and “Δ” in FIG. 33) that match the interval of Δfd(1).

By way of example, a description will be given in which at distance index fb1 of FIG. 33, N_{DM}(1)=2, the first Doppler multiplexed signal is assigned to the Doppler frequency (mark “x” in FIG. 33) higher by Δfd(1) than the detected Doppler frequency index (mark “o” in FIG. 33), and the second Doppler multiplexed signal is assigned to the Doppler frequency (mark “Δ” in FIG. 33) lower by Δfd(1) than the detected Doppler frequency index (mark “o” in FIG. 33).

In this case, at distance index fb1 of FIG. 33, first Doppler demultiplexer 211, for example, detects δ_{q} (=1) Doppler frequency index for a lower reception level (“o” in FIG. 33), and can thus determine that the Doppler frequency (mark “x” in FIG. 33) higher by Δfd(1) than the detected Doppler frequency corresponds to the first Doppler multiplexed signal and the Doppler frequency (mark “Δ” in FIG. 33) lower by Δfd(1) than the detected Doppler frequency corresponds to the second Doppler multiplexed signal.

Further, it is, for example, assumed that at distance index fb2 of FIG. 33, the same assignment of the Doppler multiplexed signals as at distance index fb1 is performed. In this case, for example, as is seen at distance index fb2 of FIG. 33, there may be a case where δ_{q} (=1) Doppler frequency index for a lower reception level (“o” in FIG. 33) is lower by Δfd(1) or 2Δfd(1) than top N_{DM} (=2) Doppler frequency indices of reception power. In this case, the Doppler frequency range that can be observed by Doppler analyzers 209 is a range of −1/(2Tᵣ×N_{colen})≤f_{d}<1/(2Tᵣ×N_{colen}), and the Doppler frequency (mark “Δ” in FIG. 33) that is lower by Δfd(1) than δ_{q} (=1) Doppler frequency index (mark “o” in FIG. 33) for a lower reception level can be observed with aliasing on the higher-frequency side. Since first Doppler demultiplexer 211 can assume the occurrence of such aliasing in advance, first Doppler demultiplexer 211 can, for example, detect δ_{q} (=1) Doppler frequency index (mark “o” in FIG. 33) for a lower reception level, and can thus determine that the Doppler frequency (mark “x” in FIG. 33) higher by Δfd(1) than the detected Doppler frequency for the lower reception level corresponds to the first Doppler multiplexed signal and the Doppler frequency (mark “\” in FIG. 33) even higher by Δfd(1) than the detected Doppler frequency for the lower reception level corresponds to the second Doppler multiplexed signal.

Likewise, it is, for example, assumed that also at distance index fb3 of FIG. 33, the same assignment of the Doppler multiplexed signals as at distance index fb1 is performed. In this case, for example, as is seen at distance index fb3 of FIG. 33, there may be a case where δ_{q} (=1) Doppler frequency index for a lower reception level (“o” in FIG. 33) is higher by Δfd(1) or 2Δfd(1) than top N_{DM} (=2) Doppler frequency indices of reception power. In this case, the Doppler frequency range that can be observed by Doppler analyzers 209 is a range of −1/(2Tᵣ×N_{colen})≤f_{d}<1/(2Tᵣ×N_{colen}), and the Doppler frequency (mark “x” in FIG. 33) that is higher by Δfd(1) than δ_{q} (=1) Doppler frequency index (mark “o” in FIG. 33) for the lower reception level can be observed with aliasing on the lower-frequency side. Since first Doppler demultiplexer 211 can assume the occurrence of such aliasing in advance, first Doppler demultiplexer 211 can, for example, determine that the Doppler frequency (mark “Δ” in FIG. 33) lower by Δfd(1) than δ_{q} (=1) Doppler frequency index (mark “o” in FIG. 33) for a lower reception level corresponds to the second Doppler multiplexed signal and the Doppler frequency (mark “x” in FIG. 33) even lower by Δfd(1) corresponds to the first Doppler multiplexed signal.

When the difference between the powers of N_{DM}(q) Doppler frequency indices for the higher reception powers is larger than a predetermined value (threshold), first Doppler demultiplexer 211 may regard (or determine) that signals of the reception signals of the multistatic configuration are highly likely to be mixed, and may add an operation of removing the reception signals without performing an output for subsequent processing (for example, direction estimation processing).

The exemplary operation of first Doppler demultiplexer 211 has been described above.

### [Exemplary Operation of First Code Separator 215]

First code separator 215 (also referred to as code separator 215-1) performs a process of separating codes multiplexed in code multiplexers 108 of radar transmitter 100h using, for example, the distance index information and the demultiplexing index information (f_{demul_#1}(q), . . . , and f_{demul_#NDM}(q)) of the Doppler multiplexed signal inputted from first Doppler demultiplexer 211.

For example, since qth radar section 10h knows the doppler indices of the first to N_{DM}(q)th Doppler multiplexed signals of qth radar section 10h, first code separator 215 calculates the Doppler frequencies based on the demultiplexing index information (f_{demul_#1}(q), . . . , and f_{demul_#NDM}(q)) of the Doppler multiplexed signals outputted from first Doppler demultiplexer 211. Further, first code separator 215 may demultiplex the signals code-multiplexed into the Doppler multiplexed signals, by performing code separation processing using calculated Doppler frequencies fdop as illustrated in following Expression 57:

$$\begin{matrix}( 57 ) & \\ {Y}_{z , q} ( {f}_{b\_cfar} , ncm , ndop ) = {\sum }_{ncl = 1}^{{N}_{colen}} {OC}_{ncm} ( ncl ) \times {VFT}_{ncl , z , q} ( {f}_{b\_cfar} , {f}_{demul \_ \# n ( q )} ) exp [ - \frac{j 2 π {f}_{dop}}{{N}_{colen} {N}_{s}} ( ncl - 1 ) ] . & ( Expression 57 )\end{matrix}$$

In the expression, Y_{z,q}(f_{b_cfar}, ncm, ndop) represents the reception signal multiplexed and transmitted from qth radar section 10h using the nemth code of the ndopth Doppler multiplexed signal at distance index f_{b_cfar} in zth signal processor 206h. Further, the number of Doppler multiplexing in qth radar section 10h is N_{DM}(q), and ndop represents the indices of the Doppler multiplexed signals and is an integer of ndop=1 to N_{DM}(q). In addition, the number of code multiplexing for the ndopth Doppler multiplexed signal is CodeDop(ndop), and ncm represents an index of a code, and is an integer of ncm=1 to CodeDop(ndop).

Since transmission antenna 102 used for multiplexing transmission using the ndopth code for the nemth Doppler multiplexed signal in qth radar section 10h is known, first code separator 215 can specify, for example, the reception signal from transmission antenna 102 of qth radar section 10h. Thus, for example, first code separator 215 in zth signal processor 206h may associate the code separated signal calculated using Expression 57 with the reception signal corresponding to the multiplexed signal from each of first to Nt(q)th transmission antennas 102. For example, first code separator 215 outputs, to first direction estimator 212, code separated signals YO_{z}=(Y_{z,Tx#1}, Y_{z,Tx#2}, . . . , and Y_{z,Tx#Nt(q)}) rearranged in the order of first to Nt(q)th transmission antennas 102.

Here, YO_{z} is an Nt(q)th-order vector, and is composed of reception signals (complex numbers) obtained by code separation in the order from first transmission antenna 102 (Tx #1) to Nt(q)th transmission antenna 102 (Tx #Nt(q)). In addition, z is an integer of from 1 to Na(q).

In Expression 57, the term

$$exp [ - \frac{j 2 π {f}_{dop}}{{N}_{colen} {N}_{s}} ( ncl - 1 ) ] \qquad ( 58 )$$

is a term that cancels out a phase variation caused by the Doppler frequency in the period (Tᵣ×N_{colen}) in which the code is transmitted.

### [Exemplary Operation of Second CFAR Section 210]

For example, second CFAR section 210 of qth radar section 10h may perform the following operations in order to receive the reflected wave signal for the radar transmission signal from radar transmitter 100h of radar section 10h that differs from qth radar section 10h.

For example, when δ₁ and δ₂ are set to values that differ from positive integers for Doppler shifters 101, second CFAR section 210 may perform peak detection by, for example, searching, in the power addition values outputted from Doppler analyzers 209 of first to Na(q)th signal processors 206h, for a power peak that matches the Doppler shift interval set for the radar transmission signal of radar section 10h different from qth radar section 10h for each distance index, and performing adaptive threshold processing (CFAR processing).

On the other hand, for example, when δ₁ and δ₂ are set to positive integers for Doppler shifters 101, an interval of Δfd(qe) or an interval of an integer multiple of Δfd(qe) is used as an interval of the Doppler shift amounts. Here, qe may be 1 or 2. Therefore, Doppler multiplexed signals can be detected as aliasing at an interval of Δfd(qe) in the Doppler frequency domain of the outputs of Doppler analyzers 209. By using such characteristics, for example, the operation of second CFAR section 210 can be simplified as follows.

For example, second CFAR section 210 of qth radar section 10h detects a Doppler peak by applying a threshold to a power addition value obtained by adding together the reception powers of the reflected wave signals for respective ranges (for example, ranges of Δfd(qe)) within the Doppler frequency range that is outputted from Doppler analyzers 209 and subjected to the CFAR processing, the ranges corresponding to the intervals of the Doppler shift amounts applied respectively to the radar transmission signals.

Here, “qe” represents a radar number of radar section 10h that differs from qth radar section 10h. For example, “qe” may be 2 in the case of first radar section 10h (q=1), or “qe” may be 1 in the case of second radar section 10h (q=2).

For example, second CFAR section 210 performs the CFAR processing on the output obtained by adding all the outputs from the first to N_{colen}th Doppler analyzers 209 of the first to Na(q)th signal processors 206, by calculating power addition value PowerDDM_{qe}(f_{b}, f_{sddm}) obtained by adding power values PowerFT_{q}(f_{b}, fₛ) at the intervals of Δfd(qe) (for example, corresponding to N_{Δfd(qe)}) as illustrated in following Expressions 58 and 59:

$$\begin{matrix}( 59 ) & \\ {PowerDDM}_{qe} ( {f}_{b} , {f}_{sddm} ) = {\sum }_{ndm = 1}^{{N}_{DM} ( qe ) + {δ}_{q}} {PowerFT}_{q} ( {f}_{b} , {f}_{sddm} + ( ndm - 1 ) \times {N}_{Δ {f}_{d} ( qe )} ) ; and & ( Expression 58 )\end{matrix}$$

$$\begin{matrix}( 60 ) & \\ {PowerFT}_{q} ( {f}_{b} , {f}_{s} ) = {\sum }_{n = 1}^{{N}_{colen}} {\sum }_{z = 1}^{{N}_{a}} {\vert {VFT}_{ncl , z , q} ( {f}_{b} , {f}_{s} ) \vert}^{2} . & ( Expression 59 )\end{matrix}$$

In the expressions, f_{sddm}=−Nₛ/2, . . . , and −Nₛ/2+N_{Δfd(qe)}−1 holds true and N_{Δfd(qe)}=round(Δfd(qe)/(1/(TᵣNₛ) holds true. In addition, round(x) is an operator that rounds off real number x and outputs an integer value.

The operation in the CFAR processing may be based on the operation disclosed in NPL 3, for example, and detailed explanation of the exemplary operation is omitted.

Thus, the Doppler frequency range on which the CFAR processing is performed in second CFAR section 210 can be set (e.g., reduced) to 1/(N_{DM}(qe)+δ_{qe}) of the entire range (e.g., the range of −Nₛ/2 to Nₛ/2−1), thereby reducing the computational amount of the CFAR processing.

For example, second CFAR section 210 adaptively sets a threshold, and outputs to second Doppler demultiplexer 211 distance indices f_{b_cfar}, Doppler frequency indices f_{sddm_cfar}, and the reception power information (PowerFT(f_{b_cfar}, f_{sddm_cfar}+(ndm−1)×N_{Δfd}(qe))) that provide reception power greater than the threshold. Here, ndm is an integer of from 1 to N_{DM}(qe)+δ_{qe}.

### [Exemplary Operation of Second Doppler Demultiplexer 211]

Second Doppler demultiplexer 211 performs the following operations based on, for example, distance indices f_{b_cfar}, Doppler frequency indices f_{sddm_cfar}, and the reception power information (PowerFT(f_{b_cfar}, f_{sddm_cfar}+(ndm−1)×N_{Δfd(qe)})) (ndm is an integer of from 1 to N_{DM}(qe)+δ_{qe})) inputted from second CFAR section 210.

<(1) Case of δ_{qe}=0>

For example, assuming that the Doppler velocity of the target object is −1/(2Tᵣ×N_{colen}×N_{DM}(qe))≤f_{d}<1/(2Tᵣ×N_{colen}×N_{DM}(qe)), second Doppler demultiplexer 211 associates the Doppler shift amounts of the Doppler multiplexed signals to be transmitted with f_{sddm_cfar}+(ndm−1)×N_{Δfd(qe)}, and outputs, to second code separator 215, the resulting demultiplexing index information (for example, f_{demul_Tx#1}(qe), . . . , and f_{demul_Tx#NDM}(qe)) of the Doppler multiplexed signals.

Here, f_{demul_Tx#n}(qe) represents the Doppler frequency index of the reflected wave signal corresponding to nth Doppler multiplexed signal of qeth radar section 10.

<(2) Case of δ_{qe}>0>

For example, it may be assumed that the Doppler velocity of the target object is −1/(2Tᵣ×N_{colen})≤f_{d}<1/(2Tᵣ×N_{colen}). Further, a large difference between, on one hand, the reception levels for top N_{DM}(qe) Doppler frequency indices of reception power and, on the other hand, the reception levels of δ_{qe} Doppler frequency indices different from the top N_{DM} Doppler frequency indices of reception power (for example, the difference being equal to or greater than the threshold) may be used. For example, second Doppler demultiplexer 211 compares the reception power information inputted from second CFAR section 210 and determines the Doppler frequency in the range of −1/(2Tᵣ×N_{colen})≤f_{d}<1/(2Tᵣ×N_{colen}). Note that an exemplary operation of second Doppler demultiplexer 211 is disclosed in, for example, PTL 1, and therefore description of the exemplary operation is omitted here.

When the difference between the powers of N_{DM}(qe) Doppler frequency indices for the higher reception powers is larger than a predetermined value (threshold), second Doppler demultiplexer 211 may regard (or determine) that components of the reception signals of the monostatic configuration are highly likely to be mixed, and may add an operation of removing the reception signals without performing an output for subsequent processing (for example, direction estimation processing).

The exemplary operation of second Doppler demultiplexer 211 has been described above.

### [Exemplary Operation of Second Code Separator 215]

Second code separator 215 (also referred to as code separator 215-2) performs a process of separating codes multiplexed in code multiplexers 108 of radar transmitter 100h using, for example, the distance index information and the demultiplexing index information (f_{demul_#1}(qe), . . . , and f_{demul_#NDM}(qe)) of the Doppler multiplexed signal inputted from second Doppler demultiplexer 211.

For example, since qth radar section 10h knows the doppler indices of the first to N_{DM}(qe)th Doppler multiplexed signals of qeth radar section 10h, second code separator 215 calculates the Doppler frequencies based on the demultiplexing index information (fdemul #1(qe), . . . , and fdemul_#N_{DM}(qe)) of the Doppler multiplexed signals outputted from second Doppler demultiplexer 211. Further, second code separator 215 may demultiplex the signals code-multiplexed into the Doppler multiplexed signals, by performing code separation processing using calculated Doppler frequencies f_{dop} as illustrated in following Expression 60:

$$\begin{matrix}( 61 ) & \\ {Y}_{z , qe} ( {f}_{b\_cfar} , ncm , ndop ) = {\sum }_{ncl = 1}^{{N}_{colen}} {OC}_{ncm} ( ncl ) \times {VFT}_{ncl , z , q} ( {f}_{b\_cfar} , {f}_{demul \_ \# n ( qe )} ) exp [ - \frac{j 2 π {f}_{dop}}{{N}_{colen} {N}_{s}} ( ncl - 1 ) ] ) & ( Expression 60 )\end{matrix}$$

In the expression, Y_{z}(f_{b_cfar}, ncm, ndop) represents the reception signal multiplexed and transmitted from qeth radar section 10h using the nemth code of the ndopth Doppler multiplexed signal at distance index f_{b_cfar} in zth signal processor 206h. Further, the number of Doppler multiplexing in qeth radar section 10h is N_{DM}(qe), and ndop represents the indices of the Doppler multiplexed signals and is an integer of ndop=1 to N_{DM}(qe). In addition, the number of code multiplexing for the ndopth Doppler multiplexed signal is CodeDop(ndop), and ncm represents an index of a code, and is an integer of ncm=1 to CodeDop(ndop).

Since transmission antenna 102 used for multiplexing transmission using the ndopth code for the ncmth Doppler multiplexed signal in qeth radar section 10h is known, second code separator 215 can specify, for example, the reception signal from transmission antenna 102 of qeth radar section 10h. Thus, for example, second code separator 215 in zth signal processor 206h may associate the code separated signal calculated using Expression 60 with the reception signal corresponding to the multiplexed signal from each of first to Nt(qe)th transmission antennas 102. For example, second code separator 215 outputs, to second direction estimator 212, code separated signals YO_{z}=(Y_{z,Tx#1}, Y_{z,Tx#2}, . . . , and Y_{z,Tx#Nt}(qe)) rearranged in the order of first to Nt(qe)th transmission antennas 102.

Here, YO_{z} is an Nt(qe)th-order vector, and is composed of reception signals (complex numbers) obtained by code separation in the order from first transmission antenna 102 (Tx #1) to Nt(qe)th transmission antenna 102 (Tx #Nt(qe)). In addition, z is an integer of from 1 to Nt(qe).

In Expression 60, the term

$$exp [ - \frac{j 2 π {f}_{dop}}{{N}_{colen} {N}_{s}} ( ncl - 1 ) ] \qquad ( 62 )$$

is a term that cancels out a phase variation caused by the Doppler frequency in the period (Tᵣ×N_{colen}) in which the code is transmitted.

The exemplary operation of second code separator 215 has been described above.

Next, an exemplary operation of first direction estimator 212 and second direction estimator 212 illustrated in FIG. 25 will be described.

### [Exemplary Operation of First Direction Estimator 212]

First direction estimator 212 of qth radar section 10h performs the direction estimation processing on the target object based on, for example, information (for example, distance indices f_{b_cfar} and code separated signals YO_{z}=(Y_{z,Tx#1}, Y_{z,Tx#2}, . . . , and Y_{z,Tx#Nt}(q) (z is an integer of from 1 to Nt(q))) inputted from first code separator 215. Since the operation of first direction estimator 212 according to the present embodiment may be the same as the operation of first direction estimator 212 according to Embodiment 1, the description thereof will be omitted.

First direction estimator 212 of qth radar section 10h may output, for example, as the positioning outputs, the direction-of-arrival estimation values for distance indices f_{b_cfar}(q) and the demultiplexing index information (f_{demul_Tx#1}(q), f_{demul_Tx#2}(q), . . . , and f_{demul_Tx#Nt}(q)) of the Doppler multiplexed signals. Further, first direction estimator 212 may further output distance indices f_{b_cfar}(q) and the demultiplexing index information (f_{demul_Tx#1}(q), f_{demul_Tx#2}(q), . . . , and f_{demul_Tx#Nt}(q)) of the Doppler multiplexed signal as the positioning outputs.

Further, distance index f_{b_cfar}(q) may be converted into distance information by using Expression 1 and outputted.

### [Exemplary Operation of Second Direction Estimator 212]

Second direction estimator 212 of qth radar section 10h performs the direction estimation processing on the target object based on, for example, information (for example, distance indices f_{b_cfar} and code separated signals YO_{z}=(Y_{z,Tx#1}, Y_{z,Tx#2}, . . . , and Y_{z,Tx,#Nt(qe)} (z is an integer of from 1 to Nt(qe))) inputted from second code separator 215. Since the operation of second direction estimator 212 according to the present embodiment may be the same as the operation of second direction estimator 212 according to Embodiment 1, the description thereof will be omitted.

Second direction estimator 212 of qth radar section 10h may output, for example, as the positioning output, the transmission azimuth direction estimation value and reception azimuth direction estimation value at distance index f_{b_cfar}(qe) and the demultiplexing index information (f_{demul_Tx#1}(qe), f_{demul_Tx#2}(qe), . . . , and f_{demul_Tx#Nt}(qe)) of the Doppler multiplexed signals. Further, second direction estimator 212 may further output distance indices f_{b_cfar}(qe) and the demultiplexing index information (f_{demul_Tx#1}(qe), f_{demul_Tx#2}(qe), . . . , and f_{demul_Tx#Nt}(qe)) of the Doppler multiplexed signal as the positioning outputs.

Further, distance index f_{b_cfar}(qe) may be converted into distance information by using Expression 2 and outputted.

The exemplary operations of first direction estimator 212 and second direction estimator 212 have been described above.

In FIG. 25, positioning output integrator 30 integrates the positioning outputs of first direction estimator 212 and second direction estimator 212 from first radar section 10h and the positioning outputs of first direction estimator 212 and second direction estimator 212 from second radar section 10h, and performs positioning of the target object. Note that, since the operation of positioning output integrator 30 according to the present embodiment may be the same as the operation of positioning output integrator 30 according to Embodiment 1, the description thereof will be omitted.

As described above, in the present embodiment, radar apparatus 1h includes first radar section 10h that transmits radar transmission signals from a plurality of transmission antennas 102, and second radar section 10h that transmits radar transmission signals from a plurality of transmission antennas 102. Here, the Doppler multiplexing interval between the Doppler shift amounts applied respectively to the radar transmission signals transmitted from the plurality of transmission antennas 102 of first radar section 10h is different from the Doppler multiplexing interval between the Doppler shift amounts applied respectively to the radar transmission signals transmitted from the plurality of transmission antennas 102 of second radar section 10h.

Accordingly, radar apparatus 1h can demultiplex the reflected wave signals corresponding to the radar transmission signals of radar sections 10h from the reception signals, for example, based on the Doppler multiplexing intervals set in radar sections 10h. Therefore, radar apparatus 1h can simultaneously perform radar positioning by the monostatic configuration of each of first radar section 10h and second radar section 10h using code multiplexing transmission, and radar positioning by the multistatic configuration from first radar section 10h to second radar section 10h and the multistatic configuration from second radar section 10h to first radar section 10h by using Doppler multiplexing transmission.

Therefore, according to the present embodiment, when code multiplexing is applied in the monostatic MIMO radar, the radar positioning time can be reduced as compared with the case where inter-multistatic time-division transmission is used, and the same advantages as those in Embodiment 1 can be obtained.

Further, for example, radar apparatus 1h can expand the observable Doppler range (for example, can set the observable Doppler range to +1/(2N_{colen} Tᵣ) by performing Doppler aliasing determination using unequal-interval Doppler multiplexing, and can suppress reduction of the maximum Doppler observable by the inter-multistatic multiplexing transmission.

Also in the present embodiment, for example, at least one of Variations 1 to 7 of Embodiment 1 may be applied, and the same effect can be obtained.

One exemplary embodiment of the present disclosure has been described above.

### Other Embodiments

Regarding Embodiment 1 (for example, FIG. 3) of the present embodiment, the configuration and operation for performing positioning by simultaneous multiplexing of the radar having the monostatic configuration and the radar having the multistatic configuration in radar apparatus 1 have been described. In such a case, the radar transmission signals transmitted from each of a plurality of transmission antennas 102 of first radar section 10 and the radar transmission signals transmitted from each of a plurality of transmission antennas 102 of second radar section 10 may be transmitted using transmission antennas which emit the same polarized wave. By using the plurality of transmission antennas 102 of first radar section 10 and the plurality of transmission antennas 102 of second radar section 10, polarized waves of radio waves being the radar transmission signals transmitted from each of the plurality of transmission antennas 102 of first radar section 10 and reflected by the target object and polarized waves of radio waves being the radar transmission signals transmitted from each of the plurality of transmission antennas 102 of second radar section 10 and reflected by the target object match each other as long as the target object is identical.

Accordingly, an advantage that the target-object reflected waves of the radar transmission signals transmitted from first radar section 10 having the multistatic configuration can be received by the monostatic configuration and also by second radar section 10. Similarly, an advantage that the target-object reflected waves of the radar transmission signals transmitted from second radar section 10 having the multistatic configuration can be received by the monostatic configuration and also by first radar section 10. As the transmission antennas for emitting the polarized waves, for example, a transmission antenna for emitting any one of a vertically polarized wave, horizontally polarized wave, obliquely 45-degree polarized wave, left-handed circularly polarized wave, and right-handed circularly polarized wave may be used.

In addition, regarding Variation 3 (for example, FIG. 17) of Embodiment 1 of the present disclosure, the configuration and operation for performing positioning by simultaneous multiplexing of a plurality of radars having the monostatic configuration in radar apparatus 1c have been described. In such a case, the radar transmission signals transmitted from each of a plurality of transmission antennas 102 of first radar section 10c and the radar transmission signals transmitted from each of a plurality of transmission antennas 102 of second radar section 10c may be transmitted using transmission antennas which emit different polarized waves. By using the plurality of transmission antennas 102 of first radar section 10c and the plurality of transmission antennas 102 of second radar section 10c, polarized waves of radio waves being the radar transmission signals transmitted from each of the plurality of transmission antennas 102 of first radar section 10c and reflected by the target object and polarized waves of radio waves being the radar transmission signals transmitted from each of the plurality of transmission antennas 102 of second radar section 10c and reflected by the target object are polarized waves different from each other as long as the target object is identical.

Thus, an advantage is obtained that the target-object reflected waves for the radar transmission signals transmitted from first radar section 10c brings about reception statuses different between reception in the monostatic configuration and reception in second radar section 10c. Here, for example, by using orthogonally related polarized waves as the different polarized waves, an advantage is obtained that the reception at second radar section 10c as compared with the reception at the monostatic configuration becomes less likely to be received with increasing cross-polarization discrimination degree between the orthogonal polarized waves.

Likewise, an advantage is obtained that the target-object reflected waves for the radar transmission signals transmitted from second radar section 10c brings about reception statuses different between reception in the monostatic configuration and reception in first radar section 10c. Here, for example, by using orthogonally related polarized waves as the different polarized waves, an advantage is obtained that the reception at first radar section 10c as compared with the reception at the monostatic configuration becomes less likely to be received with increasing cross-polarization discrimination degree between the orthogonal polarized waves.

By the transmission performed using the polarized waves related to each other as described above, it is possible to further enhance mutual interference cancellation effectiveness between the radar sections, which is more preferable, for example, when a plurality of radar sections 10c having the monostatic configuration using radar transmission waves (e.g., chirp signals) of the same frequency band are disposed close to each other. This enhancement is achieved by transmission performed using transmission antennas providing polarized waves different between the radar sections. For example, when the left-handed circularly polarized waves and right-handed circularly polarized waves are used as the orthogonal polarized waves, reflected waves (reflected waves of the same number of times of reflection) being radar transmission signals transmitted from each of the plurality of transmission antennas 102 of first radar section 10c and reflected by the target object are received as radio waves of polarized waves having a relation of cross polarization. It is thus possible to suppress the reflected wave reception level in the multistatic configuration as compared with the reflected wave reception level in the monostatic configuration, and it is possible to further enhance the interference cancellation effect between the radar sections. As a combination of the orthogonally related polarized waves, for example, a left-handed circularly polarized wave and a right-handed circularly polarized wave, a vertical polarized wave and a horizontal polarized wave, or a right-handed 45-degree polarized wave and a left-handed 45-degree polarized wave may be used.

Further, regarding the above-described embodiments, the configuration has been described in which the chirp signals are used as the radar transmission signals, but the radar transmission signals may be signals differing from the chirp signals. For example, the radar transmission signals may be a pulse compression wave, such as a coded pulse signal. When the coded pulse signal is used for the radar transmission signals, mixer 204 of reception radio 203 converts a high-frequency reception signal into a baseband signal, and a correlator (not illustrated) that correlates the high-frequency reception signal with the coded pulse signal transmitted is used instead of beat frequency analyzer 208. Accordingly, the subsequent processing can be performed in the same manner as the processing according to each of the above-described embodiments, and the same effects can be obtained.

In the radar apparatuses according to one exemplary embodiment of the present disclosure, the radar transmitter and the radar receiver may be individually arranged in physically separate locations from each other. In the radar receiver according to the exemplary embodiments of the present disclosure, the direction estimator and any other component may be individually arranged in physically separate locations from one another.

Further, in one exemplary embodiment of the present disclosure, the numerical values used for parameters such as the number of transmission antennas, the number of reception antennas, the number of Doppler multiplexing, the number of code multiplexing, the number of radar sections, the Doppler multiplexing interval, the parameter related to the Doppler multiplexing interval (for example, δ_{q}), and the number of code multiplexing are examples, and are not limited to these values.

A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program. However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Each constituent element of the above-mentioned embodiments may be combined optionally without departing from the spirit of the disclosure.

The expression “section” used in the above-described embodiments may be replaced with another expression such as “circuit (circuitry),” “device,” “unit,” or “module.”

The above embodiments have been described with an example of a configuration using hardware, but the present disclosure can be realized by software in cooperation with hardware.

Each functional block used in the description of each embodiment described above is typically realized by an LSI, which is an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit or a general-purpose processor and a memory. In addition, a Field Programmable Gate Array (FPGA) that can be programmed after the manufacture of the LSI or a reconfigurable processor in which the connections and the settings of circuit cells disposed inside the LSI can be reconfigured may be used.

If future integrated circuit technology replaces LSIs as a result of the advancement of semiconductor technology or other derivative technology, the functional blocks could be integrated using the future integrated circuit technology. Biotechnology can also be applied.

### Summary of Present Disclosure

A radar apparatus according to one non-limiting and exemplary embodiment of the present disclosure includes: first radar circuitry, which, in operation, transmits a first transmission signal from a plurality of first transmission antennas; and second radar circuitry, which, in operation, transmits a second transmission signal from a plurality of second transmission antennas, in which a first interval of each Doppler shift amount applied to the first transmission signal transmitted from each of the plurality of first transmission antennas is different from a second interval of each Doppler shift amount applied to the second transmission signal transmitted from each of the plurality of second transmission antennas.

In one non-limiting and exemplary embodiment of the present disclosure, a ratio of a greater one of the first interval and the second interval to a smaller one of the first interval and the second interval is different from an integer.

In one non-limiting and exemplary embodiment of the present disclosure, the Doppler shift amount applied to the first transmission signal and the Doppler shift amount applied to the second transmission signal are different from each other.

In one non-limiting and exemplary embodiment of the present disclosure, the first radar circuitry and the second radar circuitry demultiplex, from a reception signal, a first reflected wave signal corresponding to the first transmission signal and a second reflected wave signal corresponding to the second transmission signal based on the first interval and the second interval, and perform first direction estimation based on the first reflected wave signal and second direction estimation based on the second reflected wave signal, respectively.

In one non-limiting and exemplary embodiment of the present disclosure, one radar circuitry of the first radar circuitry and the second radar circuitry removes, based on the first interval and the second interval, a reflected wave signal corresponding to a transmission signal transmitted from an other radar circuitry of the first radar circuitry and the second radar circuitry, and performs direction estimation processing using a reflected wave signal corresponding to a transmission signal transmitted from the one radar circuitry.

In one non-limiting and exemplary embodiment of the present disclosure, the first radar circuitry performs time-division transmission of the first transmission signal to which the Doppler shift amount being a different Doppler shift amount is applied, from each of the plurality of first transmission antennas, and the second radar circuitry performs time-division transmission of the second transmission signal to which the Doppler shift amount being a different Doppler shift amount is applied, from each of the plurality of second transmission antennas.

In one non-limiting and exemplary embodiment of the present disclosure, the first radar circuitry transmits the first transmission signal using code multiplexing for each of the Doppler shift amounts, and the second radar circuitry transmits the second transmission signal using code multiplexing for each of the Doppler shift amounts.

in one non-limiting and exemplary embodiment of the present disclosure, control circuitry, which, in operation, outputs a reference signal to the first radar circuitry and the second radar circuitry is further included, and each of the first radar circuitry and the second radar circuitry generates a chirp signal using the reference signal.

In one non-limiting and exemplary embodiment of the present disclosure, the control circuitry is included in one of the first radar circuitry and the second radar circuitry.

In one non-limiting and exemplary embodiment of the present disclosure, a transmission timing of the first transmission signal for the first radar circuitry is different from a transmission timing of the second transmission signal for the second radar circuitry.

In one non-limiting and exemplary embodiment of the present disclosure, at least one of the first interval and the second interval is variably set.

In one non-limiting and exemplary embodiment of the present disclosure, the first radar circuitry and the second radar circuitry switch a multiplexing transmission method between a first multiplexing transmission based on the Doppler shift amount and a second multiplexing transmission different from the first multiplexing transmission.

In one non-limiting and exemplary embodiment of the present disclosure, at least one of the first radar circuitry and the second radar circuitry is configured such that radar transmission circuitry and radar reception circuitry are included in a same housing.

In one non-limiting and exemplary embodiment of the present disclosure, at least one of the first radar circuitry and the second radar circuitry is configured such that radar transmission circuitry and radar reception circuitry are included in different housings.

In one non-limiting and exemplary embodiment of the present disclosure, at least one of the first interval and the second interval is set to one of intervals obtained by unequally dividing a Doppler frequency range to be subjected to Doppler analysis.

A same polarized wave is used for a polarized wave for the plurality of first transmission antennas and a polarized wave for the plurality of second transmission antennas.

Polarized waves orthogonal to each other are used respectively for a polarized wave for the plurality of first transmission antennas and a polarized wave for the plurality of second transmission antennas.

The disclosure of Japanese Patent Application No. 2021-177893, filed on Oct. 29, 2021, including the specification, drawings and abstract, is incorporated herein by reference in its entirety.

### INDUSTRIAL APPLICABILITY

The present disclosure is suitable as a radar apparatus for wide-angle range sensing.

### REFERENCE SIGNS LIST

1, 1a, 1b, 1c, 1d, 1e, 1f, 1g, 1h Radar apparatus
10, 10a, 10b, 10c, 10d, 10e, 10f,10g, 10h Radar section
20, 20a, 103 Synchronization controller
30 Positioning output integrator
100, 100a, 100b, 100g, 100h Radar transmitter
101 Doppler shifter
102 Transmission antenna
104 Doppler multiplexing controller
105 Antenna switching controller
106 Switch
107 Code multiplexing controller
108 Code multiplexer
200, 200c, 200g, 200h Radar receiver
201 Antenna system processor
202 Reception antenna
203 Reception radio
204 Mixer
205 LPF
206, 206g, 206h Signal processor
207 A//D converter
208 Beat frequency analyzer
209 Doppler analyzer
210 CFAR section
211 Doppler demultiplexer
212 Direction estimator
213, 214 Output switcher
215 Code separator
301 Radar transmission signal generator
302 Modulation signal generator
303 VCO
304, 502 Signal controller
401 Reference signal generator

1. A radar apparatus, comprising:
first radar circuitry, which, in operation, transmits a first transmission signal from a plurality of first transmission antennas; and
second radar circuitry, which, in operation, transmits a second transmission signal from a plurality of second transmission antennas, wherein
a first interval of each Doppler shift amount applied to the first transmission signal transmitted from each of the plurality of first transmission antennas is different from a second interval of each Doppler shift amount applied to the second transmission signal transmitted from each of the plurality of second transmission antennas.

2. The radar apparatus according to claim 1, wherein
a ratio of a greater one of the first interval and the second interval to a smaller one of the first interval and the second interval is different from an integer.

3. The radar apparatus according to claim 1, wherein
the Doppler shift amount applied to the first transmission signal and the Doppler shift amount applied to the second transmission signal are different from each other.

4. The radar apparatus according to claim 1, wherein
the first radar circuitry and the second radar circuitry demultiplex, from a reception signal, a first reflected wave signal corresponding to the first transmission signal and a second reflected wave signal corresponding to the second transmission signal based on the first interval and the second interval, and perform first direction estimation based on the first reflected wave signal and second direction estimation based on the second reflected wave signal, respectively.

5. The radar apparatus according to claim 1, wherein
one radar circuitry of the first radar circuitry and the second radar circuitry removes, based on the first interval and the second interval, a reflected wave signal corresponding to a transmission signal transmitted from an other radar circuitry of the first radar circuitry and the second radar circuitry, and performs direction estimation processing using a reflected wave signal corresponding to a transmission signal transmitted from the one radar circuitry.

6. The radar apparatus according to claim 1, wherein:
the first radar circuitry performs time-division transmission of the first transmission signal to which the Doppler shift amount being a different Doppler shift amount is applied, from each of the plurality of first transmission antennas, and
the second radar circuitry performs time-division transmission of the second transmission signal to which the Doppler shift amount being a different Doppler shift amount is applied, from each of the plurality of second transmission antennas.

7. The radar apparatus according to claim 1, wherein:
the first radar circuitry transmits the first transmission signal using code multiplexing for each of the Doppler shift amounts, and
the second radar circuitry transmits the second transmission signal using code multiplexing for each of the Doppler shift amounts.

8. The radar apparatus according to claim 1, further comprising:
control circuitry, which, in operation, outputs a reference signal to the first radar circuitry and the second radar circuitry, wherein
each of the first radar circuitry and the second radar circuitry generates a chirp signal using the reference signal.

9. The radar apparatus according to claim 8, wherein
the control circuitry is included in one of the first radar circuitry and the second radar circuitry.

10. The radar apparatus according to claim 1, wherein
a transmission timing of the first transmission signal for the first radar circuitry is different from a transmission timing of the second transmission signal for the second radar circuitry.

11. The radar apparatus according to claim 1, wherein
at least one of the first interval and the second interval is variably set.

12. The radar apparatus according to claim 1, wherein
the first radar circuitry and the second radar circuitry switch a multiplexing transmission method between a first multiplexing transmission based on the Doppler shift amount and a second multiplexing transmission different from the first multiplexing transmission.

13. The radar apparatus according to claim 1, wherein
at least one of the first radar circuitry and the second radar circuitry is configured such that radar transmission circuitry and radar reception circuitry are included in a same housing.

14. The radar apparatus according to claim 1, wherein
at least one of the first radar circuitry and the second radar circuitry is configured such that radar transmission circuitry and radar reception circuitry are included in different housings.

15. The radar apparatus according to claim 1, wherein
at least one of the first interval and the second interval is set to one of intervals obtained by unequally dividing a Doppler frequency range to be subjected to Doppler analysis.

16. The radar apparatus according to claim 1, wherein
a same polarized wave is used for a polarized wave for the plurality of first transmission antennas and a polarized wave for the plurality of second transmission antennas.

17. The radar apparatus according to claim 1, wherein
polarized waves orthogonal to each other are used respectively for a polarized wave for the plurality of first transmission antennas and a polarized wave for the plurality of second transmission antennas.

18. A transmission method for transmitting a radar signal, comprising:
applying a Doppler shift amount of a first interval to each first transmission signal,
applying a Doppler shift amount of a second interval to each second transmission signal,
transmitting the first transmission signals to which the Doppler shift amount of the first interval is applied, from a plurality of first transmission antennas, respectively, and
transmitting the second transmission signals to which the Doppler shift amount of the second interval is applied, from a plurality of second transmission antennas, respectively, wherein
the first interval is different from the second interval.

19. The transmission method for transmitting a radar signal according to claim 18, wherein
a ratio of a greater one of the first interval and the second interval to a smaller one of the first interval and the second interval is different from an integer.

20. The transmission method for transmitting a radar signal according to claim 18, wherein
the Doppler shift amount applied to the first transmission signal and the Doppler shift amount applied to the second transmission signal are different from each other.
